(19) United States
(12) Patent Application Publication
(10) Pub. No.: US 2018/0046944 A1
(43) Pub. Date: Feb. 15, 2018

(54) Travel Management System

(71) Applicant: Libera, Inc., Jamestown, NY (US)

(72) Inventors: Girolamo Barbera, Messina (IT); Michael Scott Dearman, Lakewood, NY (US); Stephanie Jane Hobson, Spring Creek, PA (US)

(21) Appl. No.: 15/235,612

(22) Filed: Aug. 12, 2016

(51) Int. Cl. G06Q 10/02; G06F 3/0484; G06Q 50/14; G06F 3/0482

(52) U.S. Cl. CPC G06Q 10/02; G06F 3/0482; G06F 3/04842; G06Q 50/14

(57) ABSTRACT

The example systems described herein provide innovations and improvements to travel management and booking systems.

### BACKGROUND

This application relates to an online system and platform for booking and managing travel services such as transfers and excursions.

The Internet is populated with many websites that provide online booking of airline tickets, hotel reservations, car rentals, cruises, vacation packages and various attractions and services. However, even with the thicket of such travel websites, it appears that no product has been published on the Internet that simply and accurately provides and manages services for travelers. Also, with the crowd of travel websites, no product has been shown to effectively provide and manage transfers and excursions, specifically. Filling such a void, may be very useful to hotels and other affiliated travel services. Especially, smaller boutique hotels and related services that do not have their own enterprise information systems.

Uber Technologies Inc. has emerged as a leader in providing software for facilitating transfers by drivers who own their own automobile. It appears that Uber has received much success in its niche. However, travelers and their hosts may benefit more from a system that provides the choice of transfers by private drivers, public transportation, a car rental service, or a combination thereof. Also, Uber and its competitors fail to provide a survey of transfer options from perspectives of monetary and opportunity costs. Also, Uber is limited in that it does not provide a greater system to allow for bookings of excursions, which can have a close relation to transfers.

To fill the aforementioned void in systems for travel services management and booking, resolutions to a plethora of engineering problems may be used. Also, it is pertinent to consider the competitive landscape of fresh online content and experiences for consumers and business users. The resolution of these technical issues can benefit excursion and transfer providers, consumers, hosts of consumers (such as hotels), and related organizations that have an interest in obtaining streamlined booking services for transfers and excursions. Even restaurant and event planners can benefit from such a system, by linking their booking needs to the system. The novel technologies described herein set out to provide new solutions for travel services management and solve a set of technical problems within online travel and transfer booking systems. Given the landscape and exponential value to the travel industry, there is much room for improvement and growth.

### SUMMARY

The following summary is provided to introduce a selection of features that are further described below in the Detailed Description. The following summary is not intended to be limiting on the scope of what is claimed.

Disclosed herein is an example method implemented by a travel management system (TMS). An exemplary embodiment of the method includes aggregating a set of providers of travel services and aggregating travel services into sets of services per provider. The method also includes communicating a travel management webpage to a requesting web browser, wherein the webpage includes separate sections that can display provider information, services information, billing information, or any combination thereof. The provider information can include at least part of the set of providers. The services information can include at least one of the sets of services. The method also includes displaying a menu within the webpage, wherein the menu includes menu items that are selectable to display a respective section within the webpage. The method also includes displaying inner-sectional links within the sections and external to the menu, wherein an inner-sectional link can be selectable within a given section to navigate from a first subsection to a second subsection within the given section. The method also includes receiving, by the webpage, user input related to the provider information, the services information, or the billing information, and processing and storing the user input by backend circuitry of the system. Further, the method includes querying the stored user input according to an initiation of a query by the webpage.

The method can further include aggregating the set of providers according to geolocation results within a certain distance from a selected point. It can also include aggregating a set of hosts. The webpage can include a separate section displaying host information, and the host information can include at least part of the set of hosts. The method can also include receiving, by the webpage, user input related to the host information, and processing and storing the user input related to the host information by the backend circuitry. The method can further include aggregating the set of hosts according to geolocation results within a certain distance from a selected point.

In some examples, the services include transfers, and in such examples, the method can include aggregating transfers into sets of transfers per provider. Also, the webpage can include separate sections displaying transfer information, wherein the transfer information includes at least part of the set of transfers. The method can also include receiving, by the webpage, user input related to the transfer information, and processing and storing the user input related to the transfer information by the backend circuitry.

In some example, alternatively or additionally, the services include excursions. In such examples, the method can include aggregating excursions into sets of excursions per provider. The webpage can include separate sections displaying excursion information. The excursion information can include at least part of the set of excursions. Such a method can also include receiving, by the webpage, user input related to the excursion information, and processing and storing the user input related to the excursion information by the backend circuitry.

Also, disclosed herein are examples of the TMS. The TMS can include at least one webpage, front-end circuitry, and back-end circuitry. The webpage can include aggregations of provider information, services information, billing information, or a combination thereof. The front-end circuitry can be configured to: communicate, to a requesting web browser, the webpage; receive user input via a field of the webpage; and initiate a query for information stored by the system according to user input on the webpage. The back-end circuitry can be configured to: process user input received by the front-end circuitry; store user input received by the front-end circuitry; store the processed user input; and query stored user input and stored processed user input according to an initiation of a query by the front-end circuitry.

The system can also include sections within the webpage. The sections may be different from each other and include at least part of the provider information, the services information, the billing information, or a combination thereof. The system can also include a menu within the webpage, the menu including menu items selectable to render a respective section of the sections to the foreground of a requesting web browser. The system can also include inner-sectional links within the sections and external to the menu. An inner-sectional link can be selectable within a section to render a different sub-section of that section to the foreground of a requesting web browser.

In some examples, the system can include a geolocation device configured to aggregate a set of providers according to geolocation results within a certain distance from a selected point. Also, the system can include a geolocation device configured to aggregate a set of hosts according to geolocation results within a certain distance from the selected point.

In some examples, the webpage can include aggregations of host information. The sections within the webpage can include at least part of the host information.

In some examples, a transition from one section to another section, caused by a selection of one of the menu items, can include a first visual effect. Also, a transition from a first sub-section to a second sub-section within one of the sections, caused by a selection of one of the inner-sectional links, can include a second visual effect. In some of these examples, the second visual effect includes: the first sub-section sliding over the second sub-section and out of the screen, or the second sub-section sliding over the first sub-section and into the screen. Also, the second visual effect can be different from the first visual effect.

Additionally, for example, disclosed herein are examples of a non-transitory computer readable medium of the TMS including various executable instructions to perform the aforementioned operations and provide the aforementioned features. Also, the medium may include instructions such as instructions executable by a processor to aggregate a set of hosts and a set of providers and instructions executable by a processor to aggregate services into sets of services per provider and per host. The medium may also include instructions executable by a processor to communicate a travel management webpage to a requesting web browser. The webpage can include separate sections that display host information, provider information, services information, billing information, or a combination thereof. The host information can include at least part of the set of hosts. The provider information can include at least part of the set of providers. The services information can include at least one of the sets of services.

With such instructions, the webpage may be configured to display a menu that includes the menu items that are selectable to display a respective section within the webpage. The webpage may also be configured to display inner-sectional links within the sections and external to the menu, and an inner-sectional link may be selectable within a given section to navigate from a first subsection to a second subsection within the given section.

The medium may also include instructions executable by a processor to control a predetermined sequence of tool tips of the system, wherein the tool tips can be positioned at least at certain links and menu items of the webpage. In such instances, the webpage may further be configured to display the menu such that it includes the menu items that are selectable to display a respective tooltip. Also, the webpage may be configured to display the inner-sectional links such that an inner-sectional link is selectable within a given section to provide a respective tool tip. It may also include instructions executable by a processor to aggregate the set of providers or hosts according to geolocation results within a certain distance from a selected point. Also, in such examples, the services may include transfers and excursions as well.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example computer network including an exemplary embodiment of the TMS.

FIG. 2 illustrates a block diagram of an example device of the TMS of FIG. 1.

FIG. 3 illustrates a block diagram of another example device of the TMS of FIG. 1.

FIG. 4A illustrates an example registration button to initiate registration of a host.

FIG. 4B illustrates an example registration button to initiate registration of a travel service provider.

FIGS. 5 and 6 illustrate exemplary operations related to registration of a host, using at least some of the devices illustrated in FIGS. 1-3.

FIG. 7 illustrates exemplary operations related to registration of a service provider, using at least one of the devices illustrated in FIGS. 1-3.

FIG. 8 illustrates exemplary operations related to transfer management, using at least one of the devices illustrated in FIGS. 1-3.

FIG. 9 illustrates exemplary operations related to destination matching for a service, using least one of the devices illustrated in FIGS. 1-3.

FIG. 10 illustrates an example entity diagram of example data structures for an excursion. The data structures can be stored in any one or more of the databases illustrated in FIG. 1. Similar data structures can exist in the system for transfers and other travel services as well.

FIGS. 11-15 illustrate exemplary operations related to billing and payment processes, using least some of the devices illustrated in FIGS. 1-3.

FIG. 16 illustrates exemplary operations related to reconciliation processes, using least some of the devices illustrated in FIGS. 1-3.

FIG. 17 illustrates exemplary operations related to billing and payment processes for hosts, using least some of the devices illustrated in FIGS. 1-3.

FIGS. 18-23 illustrate additional exemplary operations related to booking and managing travel services, using at least some of the devices illustrated in FIGS. 1-3. For instance, FIGS. 18 and 19 illustrate exemplary operations performed by aspects of the TMS related to management and booking of excursions. FIG. 20 illustrates exemplary operations performed by aspects of the TMS related to advertising of available seats for a transfer or excursion. FIG. 21 illustrates exemplary operations performed by aspects of the TMS related to itinerary production by a host. FIG. 22 illustrates exemplary operations performed by aspects of the TMS related to event planning by a provider. FIG. 23 illustrates exemplary operations performed by aspects of the TMS related to merging of host and provider systems with the TMS.

FIG. 24 illustrates additional or alternative exemplary operations performed by aspects of the TMS, including aggregation and presentation of the information managed by the TMS.

FIG. 25 illustrates exemplary operations performed by aspects of the TMS related to pricing of services.

FIGS. 26-29 depict example GUI elements of the TMS related to setting prices for travel services.

FIGS. 30A-30D depict example GUI elements of the TMS related to searching and listing of travel services such as excursions.

FIGS. 31 and 32 depict example lists of excursions displayed by respective example GUIs of the TMS (which happen to be webpages in the illustrated examples).

FIGS. 33A and 33B depict two respective parts of an example excursion details page of the TMS, which have fields depicted without input.

FIG. 34 depicts an example excursion booking page of the TMS.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is not intended to be limiting on the scope of what is claimed.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “including,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

Aspects of systems and operations, described herein, labeled as “first”, “second”, and so on, should not necessarily be interpreted to have chronological associations with each other. In other words, such labels are used to merely distinguish aspects of the systems and operations described herein, unless the context of their use implies or expresses chronological associations.

### Detailed Description—Overview

The example systems described herein provide innovations and improvements to travel management and booking systems. One of the goals of the technologies described herein is to satisfy online users' needs for streamlined and intuitive processes and interfaces.

The systems described herein include exemplary embodiments of the TMS. The TMS is flexible and compatible across various platforms. The TMS was designed to solve, for example, the point-to-point transportation problems that any traveler may encounter. TMS includes tools for computerizing work processes previously performed in conventional ways, such as using Excel spreadsheets or even less efficient paper management, without any feedback from the hotel management or the service provider and, above all, without any benefit to the hosting entity (e.g., hotel).

The idea for the TMS at least partially grew from the need to assist those who have a constant and professional need to organize travel services such as excursions and transfers of people. The TMS is beneficial to hotels, resorts, guest houses, B&Bs, travel agencies, tour operators, event and conference organizing agencies, etc. The TMS includes an online based business support tool targeting licensed passenger service providers such as bus companies, and NCC chauffeur-driven rental cars, and other services who are active in the region and may not normally be equipped with information systems enabling them to promote their services among potential clients. In this sense, TMS includes management software, and serves as a regional information platform.

For example, a traveler after booking a hotel and a flight, remains confronted with unknown factors. How will he or she get to the hotel from the airport or schedule excursions on vacation, for example. With respect to transfers, the options usually available to the traveler include public transport, renting a car, using a private transfer service, such as a chauffeur service or a taxicab. The TMS can provide a user interface so that a customer or a host of the customer, such as a hotel, can seamlessly determine whether to use public transport, a rental car, or a private transfer, and which specific service may be used. For example, trip lengths, scheduling, and pricing of services can be provided to the end user in a seamless fashion through the TMS, so the end user can plan or book transport with each item, such as simply from a mobile device.

Also, the TMS improves booking services online in that it can group together transfer requests from hosting entities located in the same geographic area, thus actively implementing economies of scale. In this way, a service request by a few individual users can be converted into a group service.

In an exemplary embodiment, the TMS provides a travel services platform for exchange of services for an online community. The services can encompass any travel-related service, although services such as transfer services and excursion services are used as examples to describe the TMS herein. The services exchanged and promoted over the TMS can include any type of reservation or booking service, such as for dining or entertainment, food and goods delivery service that cater to travelers, any type of transfer service, excursions (such as daily excursions), host services (such as accommodations, activities, and event planning services), and much more.

For example, the TMS can manage booking ancillary services of a partner business, such as spa booking while staying at a hotel, dinner reservations while at a hotel, event management which can include transport between accommodations and an event, and ride sharing in a vehicle booked for a transfer, but not at capacity. Also, for instance, the TMS can provide advertising availability of services, with or without discounts. Also, the TMS can publish or privately communicate unscheduled time or free time in travelers' itineraries to others such as service providers (e.g., which can help with day of or last minute bookings). TMS can also provide available services down to an available vehicle for a transfer or rental, empty return trip transfers, and even advertise available seats for dining or entertainment.

Also, although business-to-business model examples are described herein in detail, examples of the TMS described herein can be implemented for a business-to-consumer model, a consumer-to-consumer model, a customer-to-customer model, a consumer-to-business model, or any combination thereof. In the business-to-business model, the online community includes features for building relationships between the businesses who provide services to consumers, so that mutual services or value-added offerings can be shared, coordinated, executed and billed in an automated fashion. In other words, the TMS includes a service coordination system for multiple providers instead for just one or a few partnered with a single business. This is a clear distinction from known travel booking platforms, such as TRAVELOCITY, EXPEDIA, ORBITZ, PRICELINE, and UBER.

In most exemplary embodiments, the TMS includes transportation coordination between entities in markets such as tourism and business. In some of these embodiments, the highest-level entities in the system include hosts and transportation providers. The hosts can include Hotels, small lodging establishments such as bed and breakfasts, villas, apartments, tourism villages, travel agents, tour operators, businesses, state agencies, business associates and the like. The transportation providers provide transportation using various vehicle types such as cars, vans, shuttles, buses, boats, planes, helicopters, and the like. In an example, hotel associations or other travel-related associations can use the TMS to help its members provide more comprehensive services. This is especially useful for a cooperative or group of small businesses that usually find it difficult to coordinate services themselves and with each other.

The TMS may be connected to or combined with an accommodations or transportation management system that manages the internals of running a travel services business (such as booking hotel rooms, route or fuel optimization, fleet (or vehicle) management, and the like). Alternatively, the TMS may be completely separate from such systems.

One of the focuses of the TMS is in coordinating businesses, customers, or consumers that may otherwise have rudimentary electronic systems like merely e-mail or spreadsheets, or even paper or phone communications only. Or, no coordination or cooperation, which is the situation in some localities where there are businesses that are islands in a community.

In an exemplary embodiment, the TMS can base publication of services and booking services on distances and time of travel between a customer or host and a service provider. The TMS, in such an embodiment, can use geolocation techniques, provide web and mobile applications, and those applications can use geolocation techniques as a basis for filtering services presented through the apps. Also, businesses can offer additional services and coordination with other businesses or third parties using geolocation techniques.

The TMS may also include functionality complementary to online booking services. The TMS may include a search engine or navigation directory to search out possible services (such as transfers and excursions) by keywords, categories, and sub-categories.

The systems may also include options to create groups and private services (such as private excursions). In some examples, services may be designated private by the creator and only members of the group associated with a service can access its details. Also, such group features may be accompanied with chatting functionality.

The systems may also provide statistics on booking trends, which may be monetized.

The systems also may include notification features. Notification features are beneficial when users are not engaged with respective webpages of the systems, but may benefit. Notifications of possible transfers or excursions may occur via email, Short Message Service (SMS) text messaging, or other messaging services. The notifications may also include the current status of services and promotional materials, as well as discounts. Such information provided by notifications services may also be tailored according to user preferences configured by a user or obtained by tracking and logging user behavior.

The system may also provide front ends for system administrators, admins of providers and hosts, and even customers.

Also, with the use of the systems described herein, there is an opportunity to provide interested parties with statistical data logged by the systems. Such logged data can be used for market analysis. Further, the logged data can be monetized such that it can be used for targeted advertising. Monetization can be used to provide advertising through the system, which can compensate for losses from free or price-reduced versions.

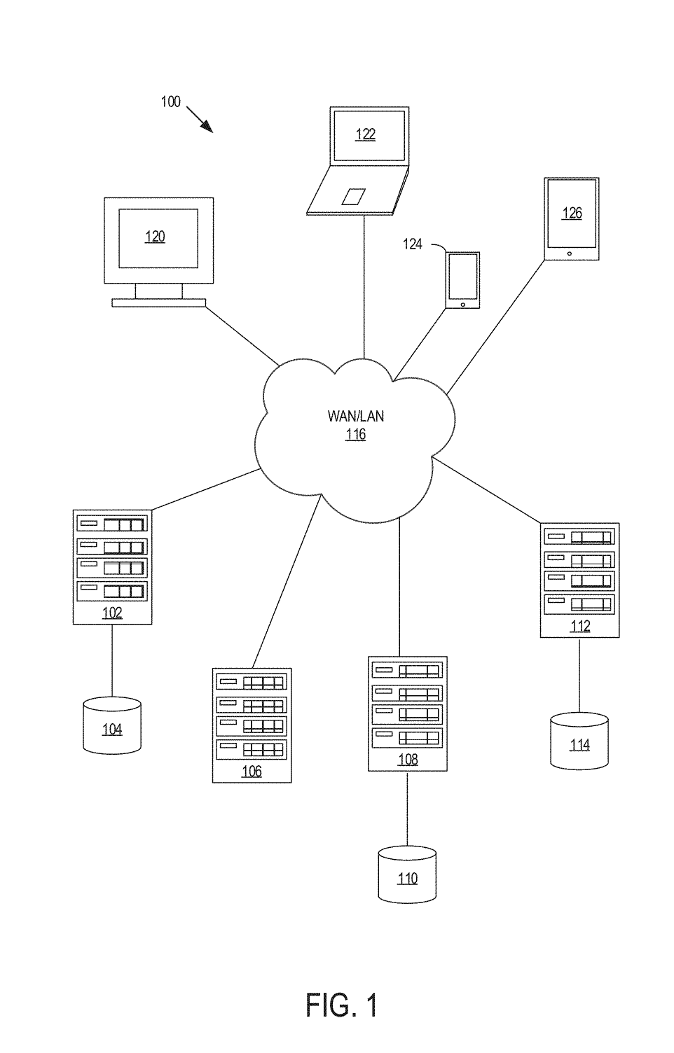

### Detailed Description—System Overview and Description of FIGS. 1-3

FIG. 1 illustrates a block diagram of example computer network 100, which includes an exemplary embodiment of the TMS. The computer network 100 in the example of FIG. 1 includes an account server 102, an account database 104, a search engine server 106, a travel management server 108, a travel management database 110, a payment service provider (PSP) server 112, and a PSP database 114. The aforementioned servers and databases can be communicatively coupled over a WAN/LAN 116 (which can include at least one of a wide area network and a local area network). The aforementioned servers and databases may each be implemented by one or more computers and computer peripherals (such as storage devices).

The computer network 100 may be accessible over the WAN/LAN 116 by user devices, which may include desktop computers (such as device 120), laptop computers (such as device 122), smartphones (such as device 124), and tablet computers (such as device 126). A user device can be a user device that presents web pages provided by the travel management server 108. In various examples of such an online information system, users may search for and obtain various travel services provided by the travel management server 108 over the WAN/LAN 116, via instructions of the search engine server 106.

The account server 102 stores account information of users, including account information of providers, customers, and hosts. The account server 102 is in data communication with the account database 104. Account information may include database records associated with respective users. Suitable information may be stored, maintained, updated and read from the account database 104 by the account server 102. Examples include user identification information, user security information, such as passwords and other security credentials, account balance information, preferences, and contact and background information. The TMS, the account server 102 and the other servers described herein have respective security models to support application-level authentication and user-level authentication.

The account information may also include demographic or psychographic information associated with the user or group of the account. The account information may be analyzed for marketing purposes and such analysis may provide for monetization of the account information.

The account server 102 or any server described herein may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide a front end to simplify the process of accessing the account information. The front end may be a program, application, or software routine that forms a graphical user interface. In an example, the front end is accessible as a webpage. The webpage can provide fields for selecting preferences and user information. Details regarding such frontends are provided below with greater detail. User configurable information may be changed and viewed when the user is logged on to the system. User preferences and other configuration information may be saved to the account database 104.

The search engine server 106 may be one or more servers. Alternatively, the search engine server 106 may be a computer program, instructions, or software code stored on a computer-readable storage medium that runs on one or more processors of one or more servers. The search engine server 106 may be accessed by user devices over the WAN/LAN 116. A user device may communicate a user query to the search engine server 106. For example, a query entered into a query entry box can be communicated to the search engine server 106. The search engine server 106 locates matching information using a suitable protocol or algorithm and returns information to the user device, such as in the form of content items or content related to travel services, providers, hosts, or even customers. Content items of or related to the system, such as items related to travel services, may be served from any one of the servers of the computer network 100, or a dedicated server not depicted in FIG. 1.

The search engine server 106 may also be designed to help users and potential audience members find information located on the Internet, besides information provided by the account server 102 and the travel management server 110. For example, the search engine server 106 can direct a user to additional travel related information. In an example, the search engine server 106 may also provide to the user device over the WAN/LAN 116 an electronic property or link to an electronic property, such as a webpage or news article related to a travel service, such as a review of the service. The travel management server 110 may also use reviews from outside the system to rank services and determine trust levels of providers and hosts. The information related to searching and account information may be logged, such as by the search engine server 106, and such logs may be analyzed by an analytics and then further monetized (such as by an analytics engine and database).

The search engine server 106 may enable a device, such as a user device, to search for files of interest using a search query. Typically, the search engine server 106 may be accessed by a client device (such as the devices 120-126) via one of the servers of FIG. 1 or directly over the WAN/LAN 116. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The content items, such as content items associated with travel services data, may be displayed on webpages of the system and other pages provided by links of the system's webpages and a user-defined searches. Also, the content items may be further selected for presentation according to a demographic or psychographic of the user or user device executing the search. A variety of techniques have been developed to determine audience groups and to subsequently target relevant content to members of such groups. Group data and individual user's interests and intentions along with targeting data may be logged in data logs. As mentioned, one approach to presenting targeted content items includes employing demographic characteristics (such as age, income, sex, occupation, etc.) for predicting user behavior, such as by group. Content items may be presented to users in a targeted audience based, at least in part, upon predicted user behavior.

Another approach includes profile-type content item targeting. In this approach, user profiles specific to a user may be generated to model user behavior, for example, by tracking a user's path through a website or network of sites (such as through a website of an emotions providing and tracking system), and compiling a profile based, at least in part, on pages or content items ultimately delivered. A correlation may be identified, such as for user interactions with the webpages provided by the travel management server 108. Similarly, the aforementioned profile-type targeting data may be logged in data logs.

The travel management server 108 and other servers described herein can include logic and data operative to format a content item or any one of the user interfaces described herein for communication to a user device, which may be any of the devices 120-126. The travel management server 108 is in data communication with the travel management database 110. The travel management database 110 or any other database described herein may store information, including data defining content items, to be served to user devices.

The content items may include data defining creatives included with descriptions of services and may be directed by user interactions with the items and creatives. The data described herein may be formatted to an audio or visual content item that may be included in a listing of content items provided to a user device. The formatted items can be specified by appearance, size, shape, text formatting, graphics formatting and included information, which may be standardized to provide a consistent look for items in listings described herein. The aforementioned data as well as any other information described herein may be logged in data logs.

Further, the travel management server 108 is in data communication with the WAN/LAN 116. The travel management server 108 can communicate content item data and other information to devices over the WAN/LAN 116.

Travel services data and information, such as services, provider and host information, is described in more detail in following sections.

The travel management server 108 provides user interface to simplify the process of accessing data. In most exemplary embodiments, the user interfaces are mostly webpages but may also include other forms of electronic content distribution methods, such as electronic messaging and email distribution methods. The front ends may be a program, application or software routine that forms a graphical user interface. The user may view and interact with electronic properties of the system using the front ends. After viewing and interacting with such content, associated viewing and interaction data may then be saved to the travel management database 110 for processing by the server 108 and subsequent communications back to the user device. In viewing and interacting with electronic properties, adjustments to the travel information for example can be used as input for the various operations and aspects of an analytics and monetization system. The front ends may be a client-side application which runs at least partially on a user device or entirely on the user device. A script or applet may implement the front ends at least partially or may manage the retrieval of data for the front ends.

The content data, such as data associated with travel services data, respective categories, and related articles, may be formatted as a content item that may be included in a graphically consistent listing of content items provided to a user device. The formatted content items can be specified by consistent sound effects, appearance, size, shape, text formatting, graphics formatting, which may be standardized to provide a consistent look and feel for content items in the listing. The formatting of content data and other information and data outputted by the travel management server 108 may be logged in data logs. Such data logs may be a basis for ranking or positioning the content items in the listing presented to a user device. Also, such data logs may be the basis for analytics and monetization.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include a central processing unit and memory. A server may also include a mass storage device, a power supply, wired and wireless network interfaces, input/output interfaces, or an operating system, such as Windows Server, Mac OS X, UNIX, Linux, FreeBSD, or the like.

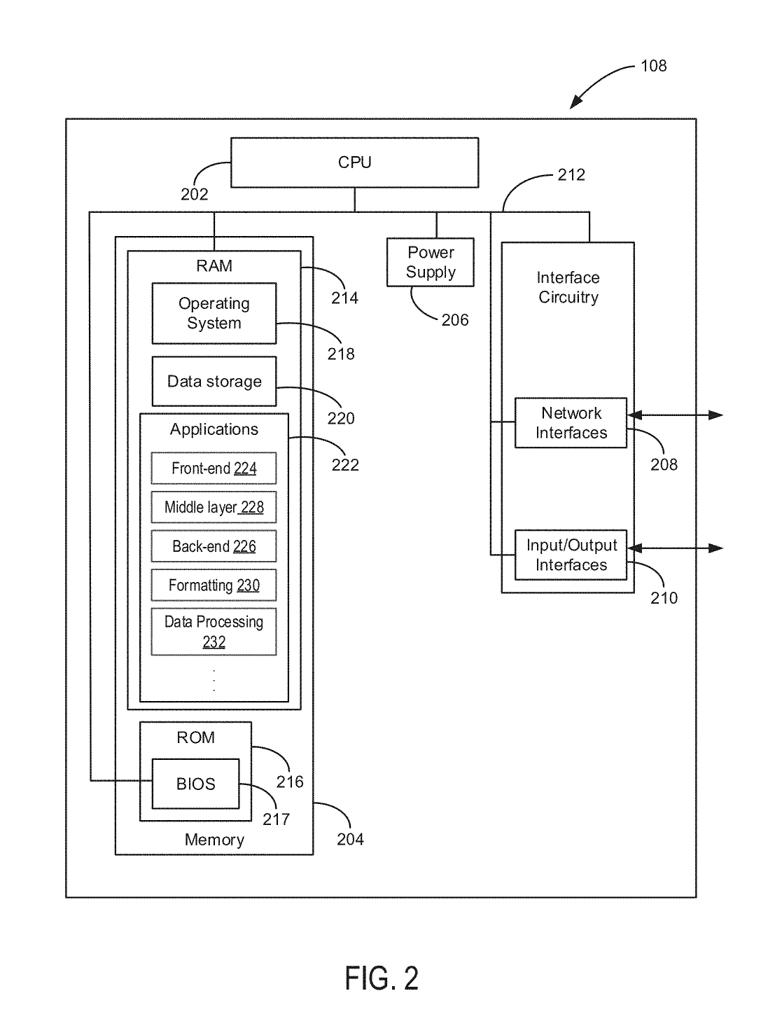

FIG. 2 illustrates a block diagram of the travel management server 108 of the TMS of FIG. 1, which may be implemented by one or more computer for example. FIG. 2 includes an illustration of the travel management server 108, which includes any of the aforementioned features in some examples. The illustration of the travel management server 108 includes a block diagram of an example electronic device that can implement aspects of and related to example systems that can provide and manage the travel services information and booking systems discussed herein, the front ends, webpages, and notifications described herein, and at least part of associated data logging and processing described herein.

The travel management server 108 includes a CPU 202, memory 204, a power supply 206, and input/output components, such as network interfaces 208 and input/output interfaces 210, and a communication bus 212 that connects the aforementioned elements of the electronic device. The network interfaces 208 can include a receiver and a transmitter (or a transceiver), and an antenna for wireless communications. The network interfaces 208 or the input/output interfaces 210 can include at least part of API circuitry. The API circuitry can provide an interface for merging various features, functions, and information of the system with other applications, such as other social media applications and other travel management systems. The CPU 202 can be any type of data processing device, such as a central processing unit (CPU). Also, for example, the CPU 202 can include central processing logic.

The memory 204, which can include random access memory (RAM) 214 or read-only memory (ROM) 216, can be enabled by memory devices. The RAM 214 can store data and instructions defining an operating system 218, data storage 220, and applications 222, such as applications implemented through hardware or software including front-end circuitry 224, back-end circuitry 226, middle layer circuitry 228, front-end formatting circuitry 230, and travel data processing circuitry 232. The applications 222 may include hardware (such as microprocessors), firmware, software, or any combination thereof. Also, the memory 204 may include a non-transitory medium including instructions corresponding to the circuitries 224-232. These instructions and any instructions described herein may be executable by the CPU 202 or another type of processing device. The ROM 216 can include basic input/output system (BIOS) 217 of the electronic device implementing the travel management server 108.

In an exemplary embodiment of the memory 204 with a non-transitory computer readable medium, the medium may include instructions executable by a processor (such as CPU 202) to aggregate a set of hosts and a set of providers. The medium may also include instructions executable by a processor to aggregate services into sets of services per provider and per host. The medium may also include instructions executable by a processor to communicate a travel management webpage to a requesting web browser, wherein the webpage includes separate sections for displaying host information, provider information, services information, billing information, or a combination thereof. In such embodiments, the host information can include at least part of the set of hosts, the provider information can include at least part of the set of providers, the services information can include at least one of the sets of services, and the webpage can be configured to display a menu that includes the menu items that are selectable to display a respective section within the webpage. The webpage can also be configured to display inner-sectional links within the sections and external to the menu. Also, an inner-sectional link may be selectable within a given section to navigate from a first subsection to a second subsection within the given section.

The medium may also include instructions executable by a processor to control a predetermined sequence of tool tips of the system. Such tool tips can be positioned at least at certain links and menu items of the webpage. Also, the webpage can be further configured to display the menu such that it includes the menu items that are selectable to display a respective tooltip. Further, the webpage can be configured to display the inner-sectional links such that an inner-sectional link is selectable within a given section to provide a respective tool tip.

The medium may also include instructions executable by a processor to aggregate the set of providers or hosts according to geolocation results within a certain distance from a selected point. As mentioned herein, the services may include transfers or excursions, or the like. Also, any the aforementioned instructions may be a part of the circuitries 224-232.

The power supply 206 contains power components, and facilitates supply and management of power to the electronic device implementing the travel management server 108. The input/output components can include at least part of the API circuitry which can improve communications between any components of the electronic device and components of external devices (such as components of other devices of the computer network 100, other online server systems, and end user devices). Also, such components can include a network card that is an integration of a receiver, a transmitter, and I/O interfaces, such as input/output interfaces 210. The I/O components, such as I/O interfaces 210, can include user interfaces such as monitors, keyboards, touchscreens, microphones, and speakers. Further, some of the I/O components, such as I/O interfaces 210, and the communication bus 212 can facilitate communication between components of the electronic device, and can ease processing performed by the CPU 202.

The electronic device implementing the travel management server 108 can send and receive signals, such as via a wired or wireless network, or may be capable of processing or storing signals, such as in memory as physical memory states, and may, therefore, operate as a server. The device can include a server, dedicated rack-mounted servers, desktop computers, laptop computers, set top boxes, integrated devices combining various features, such as two or more features of the foregoing devices, or the like. Also, electronic devices with similar general hardware parts in comparison to the device implementing the travel management server 108 can implement the other servers described herein.

Further, the aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include FLICKER, TWITTER, FACEBOOK, LINKEDIN, or a personal user site (such as a blog, vlog, online dating site, etc.). An online server system may also host a variety of other sites, including business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The WAN/LAN 116 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks may employ differing architectures or may be compliant or compatible with differing protocols, may interoperate within a larger network, including the WAN/LAN 116.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

A user device, which may be any one of the devices 120-126, includes a data processing device that may access the computer network 100 over the WAN/LAN 116. A user device can be operative to interact over the WAN/LAN 116 with any of the servers or databases described herein. The user device may implement a client-side application for rendering front end graphical user interfaces, such as the webpages described herein. Through such front ends, electronic properties (including webpages) may be viewed and corresponding requests may be received and submitted to the travel management server 108 and any other server or database of FIG. 1. A user device may communicate data to the computer network 100, including data defining electronic properties and interactions with the electronic properties described herein. A user device may receive communications from the computer network 100, including data defining electronic creatives. The aforementioned interactions, such as bookings and queries, and search results may be logged in data logs, and such logs may be analyzed and monetized.

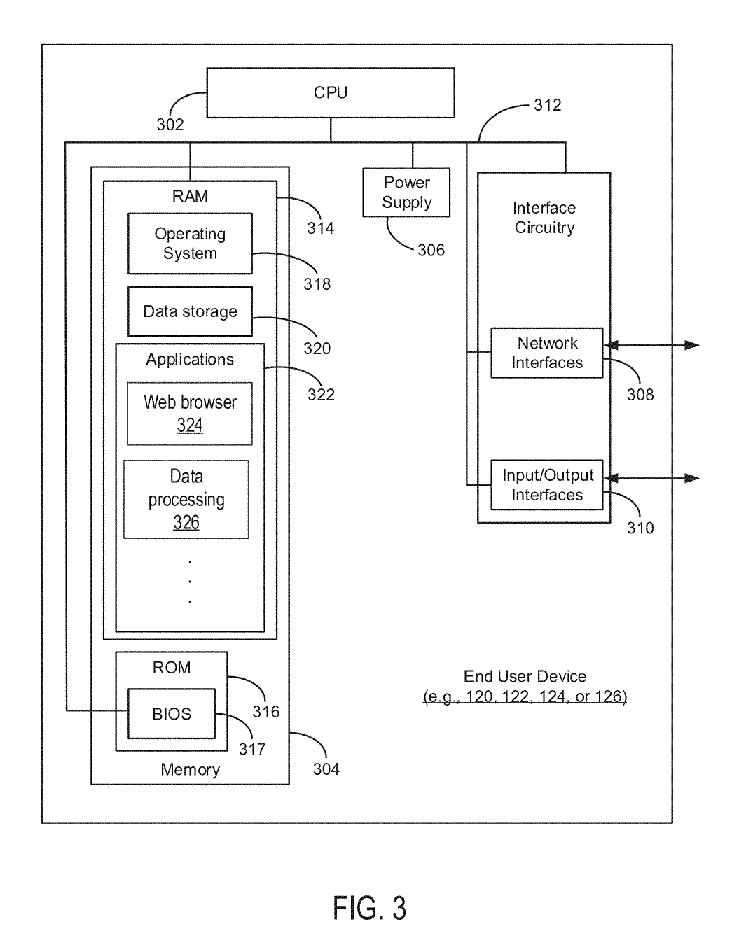

FIG. 3 illustrates a block diagram of any one of the end user devices 120-126 of the TMS of FIG. 1. Any one of the end user devices includes a CPU 302, memory 304, a power supply 306, and input/output components, such as network interfaces 308 and input/output interfaces 310, and a communication bus 312 that connects the aforementioned elements of the electronic device. The network interfaces 308 can include a receiver and a transmitter (or a transceiver), and an antenna for wireless communications. The CPU 302 can be any type of data processing device, such as a central processing unit (CPU). Also, for example, the CPU 302 can include central processing logic.

The memory 304, which can include random access memory (RAM) 314 or read-only memory (ROM) 316, can be enabled by memory devices. The RAM 314 can store data and instructions defining an operating system 318, data storage 320, and applications 322, such as applications implemented through hardware or software including a web browser 324. The applications 324 may include hardware (such as microprocessors), firmware, software, or any combination thereof. Also, the memory 304 may include a non-transitory medium including instructions such that the device can communicate with circuitries 224-232 of the travel management server 108. These instructions and any instructions described herein may be executable by the CPU 302 or another type of processing device. The ROM 316 can include basic input/output system (BIOS) 317 of the electronic device implementing the client side of the TMS.

The power supply 306 contains power components, and facilitates supply and management of power to the electronic device. The input/output components can include API circuitry or virtual machines for facilitating communications between any components of the electronic device and components of external devices (such as components of other devices of the computer network 100, other online server systems, and end user devices). Also, such components can include a network card that is an integration of a receiver, a transmitter, and I/O interfaces, such as input/output interfaces 310. The I/O components, such as I/O interfaces 310, can include user interfaces such as monitors, keyboards, touchscreens, microphones, and speakers. Further, some of the I/O components, such as I/O interfaces 310, and the communication bus 312 can facilitate communication between components of the electronic device, and can ease processing performed by the CPU 302.

The device, which may be any of the devices 120-126, may also include a data processing circuitry 326 that may access the computer network 100 over the WAN/LAN 116. A user device can be operative to interact over the WAN/LAN 116 with the account server 102, the search engine server 106, and the travel management server 108. A user device may implement a client-side application for viewing electronic content and submitting user requests. A user operating the device may enter a search request and communicate the search request to the computer network 100. The search request is processed by the search engine. Then the search engine can provide search results accordingly, such as results including travel services. The results are returned to the user device. In other examples, a user of a user device may request data, such as a page of information from the computer network 100. The data may be provided in another environment, such as a native mobile application, TV application, or an audio application. The computer network 100 may provide the data or re-direct the browser to another source of the data. In addition, the travel management server 108 may select content items from the travel management database 110 and include data defining the content items in the provided data to the user device. The aforementioned interactions and information may be logged, and then analyzed and monetized.

As described in so many words, an end-user device (such as devices 120-126) may operate as a client device (such as a thin client) when accessing information on the computer network 100. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A client device may vary in terms of capabilities or features.

Claimed subject matter is intended to cover a wide range of potential variations. For example, a cell phone may include a numeric keypad or a display of limited functionality, such as a monochrome liquid crystal display (LCD) for displaying text. In another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

A client device may include or may execute a variety of possible applications, such as a client software application enabling communication with other devices, such as communicating messages, such as via email, short message service (SMS), or multimedia message service (MMS), including via a network, such as a social network, including, for example, FACEBOOK, LINKEDIN, TWITTER, FLICKR, or GOOGLE+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or games.

The foregoing is provided to illustrate that claimed subject matter is intended to include a wide range of possible features or capabilities. At least some of the features, capabilities, and interactions with the aforementioned may be logged in data logs, and then analyzed and monetized.

Also, the disclosed methods, systems, and devices may be implemented at least partially in a cloud-computing environment, at least partially in a server, at least partially in a client device, or in any combination thereof.

In most exemplary embodiments, the travel management server 108 can provide a webpage of the TMS to a web browser such as web browser 324. The web page can include aggregations of provider information, services information, billing information, or a combination thereof. In such embodiments, the front-end circuitry 224 can communicate, to a requesting web browser (such as browser 324), the webpage.

The front-end circuitry 224 can also receive user input via a field of the webpage, and initiate a query for information stored by the system according to user input on the webpage. In such examples the queried information can include information stored temporarily in the middle layer circuitry 228 (e.g., in a cache) or stored and organized by a database such as at least one of the databases 104, 110, and 114.

In some examples, the back-end circuitry 226 can include a database such as at least one of databases 104, 110, and 114. In such embodiments, the back-end circuitry 226 can also process user input received by the front-end circuitry, store user input received by the front-end circuitry, and store the processed user input.

The back-end circuitry 226 as well as the middle layer circuitry 228, alternatively or additionally, can query stored user input and stored processed user input according to an initiation of a query by the front-end circuitry 224. Such queries can be initiated by automated processes of any one or more of the servers or devices illustrated in FIG. 1. Also, a user through the webpage or the web browser 324 can initiate a query.

Also, in such exemplary embodiments, the webpage may include sections, and each section is different from each other and includes at least part of the provider information, the services information, the billing information, or a combination thereof. Also, the webpage can include a menu within the webpage. The menu can include menu items, the items being selectable to render a respective section of the sections to the foreground of a requesting web browser (such as browser 324). The webpage can also include inner-sectional links within the sections and external to the menu. An inner-sectional link can be selectable within a section to render a different sub-section of that section to the foreground of a requesting web browser. Also, in such examples of the TMS, the webpage further includes aggregations of host information, wherein the sections within the webpage include at least part of the host information.

Not depicted in the FIGS. 1-3, any one or more of the servers or devices illustrated in FIG. 1 can include a geolocation device configured to aggregate a set of providers according to geolocation results within a certain distance from a selected point. Also, any one of these servers and devices can include a geolocation device configured to aggregate a set of hosts according to geolocation results within a certain distance from a selected point.

Further, the TMS can be pre-populated with locations, such as destinations from existing data warehouses (e.g., location data sources like GEONAMES. The TMS can run address imports prior to launch of an implementation of the TMS and as a routine maintenance feature. The TMS can use batch processing for such features, even when the TMS implementation is in production. Such destinations cannot be modified by users in most embodiments. In such embodiments, an administrator of the TMS can delete or update the locations. Editing or formatting of location data can also be done through batch processes of the TMS.

Regarding transitions with the webpage of these embodiments, a transition from one section to another section, caused by a selection of one of the menu items, can include a first visual effect. When a transition is from a first sub-section to a second sub-section within one of the sections, caused by a selection of one of the inner-sectional links, the transition can include a second visual effect. The second visual effect or the first visual effect (depending on the implementation) can include the first sub-section sliding over the second sub-section and out of the screen, or the second sub-section sliding over the first sub-section and into the screen. Also, in most implementations, the second visual effect is different from the first visual effect.

### Detailed Description—Definitions for Embodiments Described Herein

TMS: Travel Management System. The TMS administrator can have complete read, write, and execution access to the features of the TMS. Depending on the configuration of the TMS, some features are permanent and cannot be modified by the administrator. Such features can be permanently set prior to deployment of the TMS.
Guest: A host's customer (e.g., a hotel guest or a travel agency guest).
Host: A provider of accommodations or an agency that provides or books accommodations. A host can be a hotel, travel agency, tour operator, or event company, for example. Through GUIs of the TMS, a host user can create, update, and delete transfers, excursions, and other travel services. A host administrator can update host profile, manage payment methods, create, update, and delete users and travel services associated with the host, and perform any functions of a host user.
Provider: An individual or organization that provides a travel-related service, such as transfer service provider, excursions provider, restaurant, event venue, food delivery service, entertainment service, and the like. A provider user including transfer provider users can view, accept, and reject services proposed by hosts. A provider administrator can perform any functions of a provider user and update the provider profile and create, update, and delete users and services of the provider.
Transfer Provider: Is a transportation company or a public transportation entity (e.g., taxicab company, bus service, ferry service, private driver agency such as Uber, etc.).
Excursion: An excursion is a journey, trip, or activity. An excursion may include multiple pickups (location and time) and multiple drop-offs (same location, different time), a description of the excursion and available seats which can be booked. Usually, a provider of an excursion picks up multiple guests and drops off multiple guests within a locality or drivable geographic region.
Excursion Owner: Creator of an excursion (host, provider, travel agents etc.) is considered an excursion owner.
Excursion Booking Host: Host that books one or more guests into an excursion.
PSP: Payment Service Provider, which is an online service for accepting electronic payments by a variety of payment methods. In the context of the TMS, the PSP can also perform payment processing via a payment processor.
Bill: “Bill” is used herein synonymously to mean “invoice”. Bills and invoices can be different from reports in the TMS in many ways, including that they are created on a scheduled basis (such as with batch processing).
Report: A report in the context of TMS is a manually selectable document that can be selected on demand. Reports can be scheduled, but herein such reports are designated as scheduled or referenced to as bills or invoices.
Location: A location herein is a geographic location specifiable by a coordinate system and locatable via at least an electronic map of a GPS. Locations are used for booking services involving any sort of transfer of a customer or product used by a customer. Locations can include pick-up and drop-off locations of a transfer or an excursion. The coordinate system can identify a location by a single pair of longitude and latitude coordinates on the map in some embodiments. Other coordinate systems may be used as well by the TMS.
Destination: A destination may include a location and is used by the TMS for defining provider prices. Destinations can be places with a single set of coordinates, with boundaries (a certain geographic area), or a set of zip codes (such as when destination is a city or a part of a metro area). Also, herein, a destination may include an origin of round trip excursion or transfer.
Place ID: A place ID uniquely identifies a place in the TMS, some external databases that interact with the TMS, and some external GPS and map systems that interact with the TMS.
Place: A place can include a location or a destination. A place has a unique place ID in the TMS. Places are considered identical if they have the same place ID. For example, if a destination has the same coordinates as a location it can also have the same place ID and may be considered identical from a location-destination matching function of the TMS. However, the different contexts of locations and destinations may be noted and apparent herein. For example, in most exemplary embodiments, locations are used by the services modules and destinations are used by the pricing modules.
EPS: An external payment system or company that processes payments for the TMS.
Customer: A customer is a host or an individual or group that is a customer of a host, depending of the context of the use of “customer” herein. With respect to an EPS, the customer can have one or more payment methods.
Payment Method: A payment method represents payment information and processes to complete a payment such as credit card details to complete a payment. Payment methods of the TMS belong to a customer, can be securely stored by an EPS, and include a token attribute that can be stored by the TMS to be used to create transactions within the TMS.
Transaction: A transaction is an exchange of information or funds between parties of the TMS can be used to create a new customer payment methods or payments.
Merchant ID: A unique identifier for a party's merchant or gateway account.
Merchant Account ID: A unique identifier for a party's specific merchant account. Within a gateway of an EPS, multiple merchant accounts to process transactions for different businesses or currencies are used by some embodiments of the TMS.
Client Token: A token to authenticate the client (e.g., web browser) when submitting the payment information to the EPS server. The token is created by the TMS through a call to the EPS server using credentials such as the merchant ID and public/private API key information.
Nonce: A nonce is a string representing an encoded payment method. In an exemplary embodiment, to avoid Payment Card Industry (PCI) compliancy requirements for TMS, a nonce is used instead of a payment method.
Host Administrator: A host admin can update any information about hosts.
Host Power User: A host power user can create, modify, or delete any transfers and manage locations. In most embodiments, such a user is an administrator of the TMS not one of the providers, hosts, or customers using the TMS.
Provider Administrator: A provider admin can view transfers and manage locations.
Provider User: A provider user can view transfers.
TMS administrator: A TMS administrator is an admin with back-end administration functionality

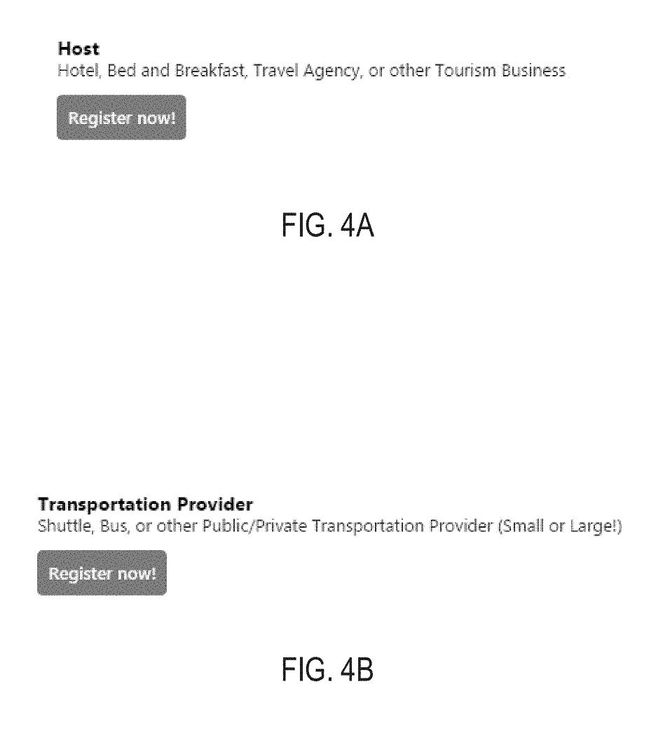

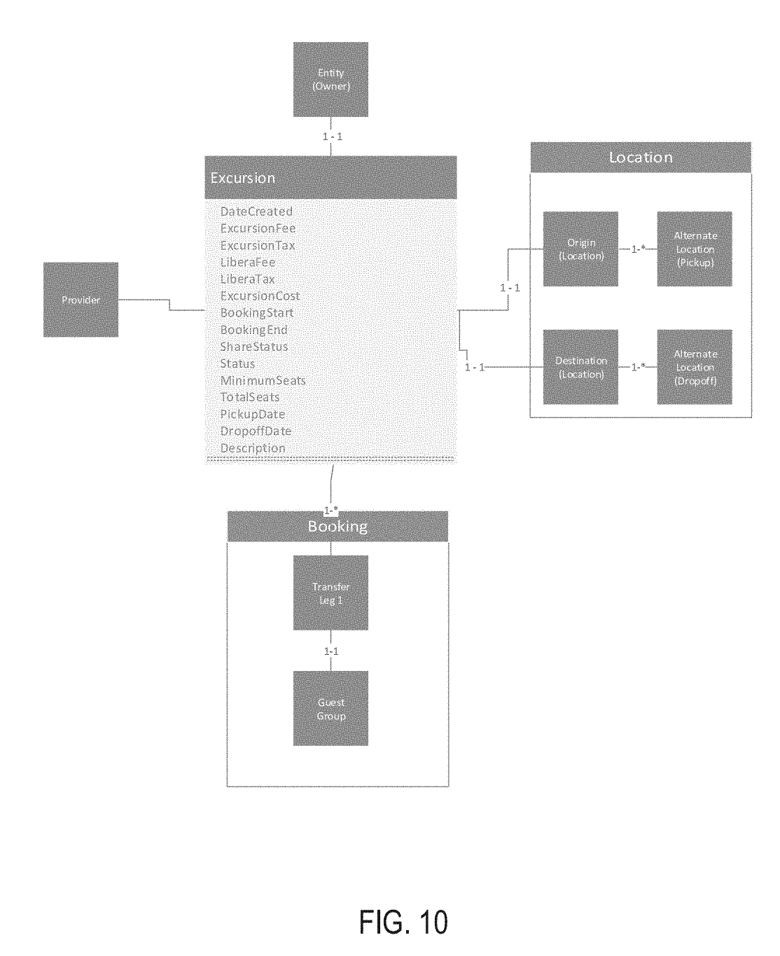

### Detailed Description—Description of Exemplary Embodiments and FIGS. 4A-17

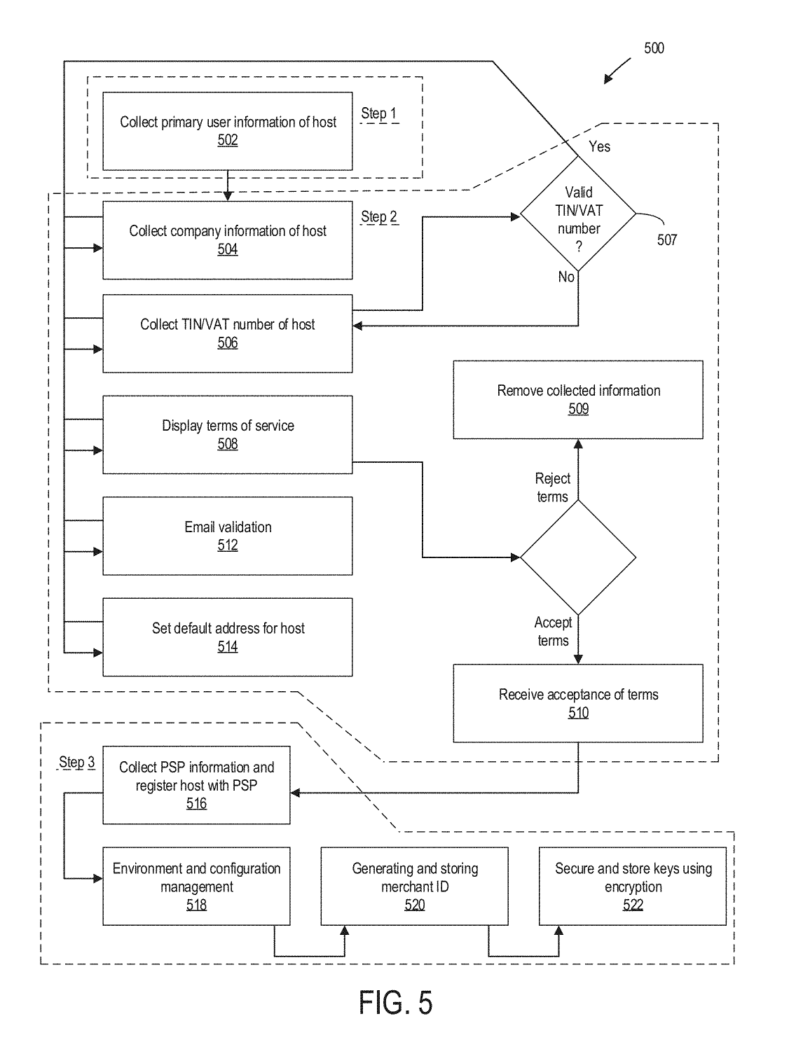

FIG. 5 illustrates exemplary operations 500 performed by an aspect of the TMS related to transfers, excursions, and other related travel services. Specifically, the operations 500 relate to registration of a host. Such operations can be initiated by a seamless mechanism such as a graphical button on a web page labeled to indicate initiation of the registration. See FIG. 4A. Registration of a host can include a multi-state self-registration. In an exemplary embodiment, the self-registration can be split up into three different screens: a contact information screen (which includes fields associated with a primary user and a CAPTCHA), a company information screen (which includes fields associated with company name, VAT, street address, billing information, and agreements with the TMS and in some examples other parties), and a PSP registration screen.

The first step of the self-registration includes step 502 that includes collecting information to create primary user account for the host. Fields include First Name, Last Name, Email Address (which can also be used as a username), Password, and Confirm password. Also, the administrator role can be assigned to the primary user automatically. These aforementioned fields can be mandatory. Also, the first step includes CAPTCHA validation. The CAPTCHA validation includes displaying a CAPTCHA to validate self-registration by a person, and prevent scripted self-registration or registration by an Internet bot. CAPTCHA validation can analyze the user interaction with the host registration webpage to determine whether the user is a real person or a bot. Depending on the implementation, a real person clicking on the CAPTCHA checkbox might be sufficient. If the CAPTCHA cannot tell for sure if the user is a real person, a list of images is presented and the user chooses those that match certain criteria.

The second step of the self-registration includes step 504 that includes collecting company information of the host. Alternatively, the company information may be group information of multiple users assigned to a group. Company information may include the following fields: Name, VAT or TIN Number, Language (in some embodiments the field may not be shown and defaults to English), Currency (in some embodiments the field may not be shown and defaults to Euro or Dollar depending on the implementation), Description, Street Address, Email, Phone Number, Billing Address (which can have a check box for designating it to be the same as the Street Address). When the check box for designating the Billing Address to be the same as the Street Address is checked, the field for the Billing Address becomes immutable in some embodiments. When immutable, to change the Billing Address, the check box can be unchecked by reselection of the box. This further prevents typographical errors in the billing address. This is especially useful since some payment methods require that the billing address be precise.

The second step of the self-registration also includes step 506 that includes collecting the TIN or VAT number of the host. The second step also include step 507 that includes validation of the uniqueness of the TIN or VAT number. The TIN or VAT uniqueness can be validated according to the country selected for the company (e.g., if the country is Italy then the system checks for a valid Italian VAT number).

The second step of the self-registration also includes step 508 that includes displaying terms of service for use of the TMS for review and approval. Also, included is step 510 that includes receiving the approval of the terms when an agreement selection is made, such as clicking on an “Agree and Register” button. If ultimately the terms are rejected, the system removes the host information collected at step 509.

The second step of the self-registration also includes step 512 that includes email validation. Email validation includes checking for appropriate syntax in the email address and uniqueness of the email address. In some embodiments, the existence of the email address is validated by the TMS, in others it is not. Also, in some embodiments the existence of the domain server or the top level domain of the address can be validated. Additionally, in some embodiments, the street address is validated for uniqueness. Also, the billing address can be validated for uniqueness.

The second step of the self-registration also includes step 514 that makes the company address or one of the other registered addresses the default location of the host, depending on the implementation of the TMS.

The third step of the self-registration includes step 516 that includes the PSP registration for the host. Step 516 includes registration of a payment method for the host, such as PAYPAL, bank account, or credit card information. Alternatively, in some other embodiments, instead of requiring payment information at time of registration, the TMS can wait until a first system use that accesses billing like creating a transfer or excursion.

The third step of the self-registration includes step 518 that includes environment and configuration management, which occurs on the back-end of the TMS. Step 520 includes generating and storing the merchant ID which can include or be associate with the public and the private API key of the host. This can be done according to the environment of the TMS. For example, the computer operating system used by the TMS. These items are configured as part of the build process of the host in the TMS. At step 522, the keys are securely stored, such as by using encryption. The encryption may include a two-way encryption with password protection. In some embodiments, the keys can be used to charge host according to payment method.

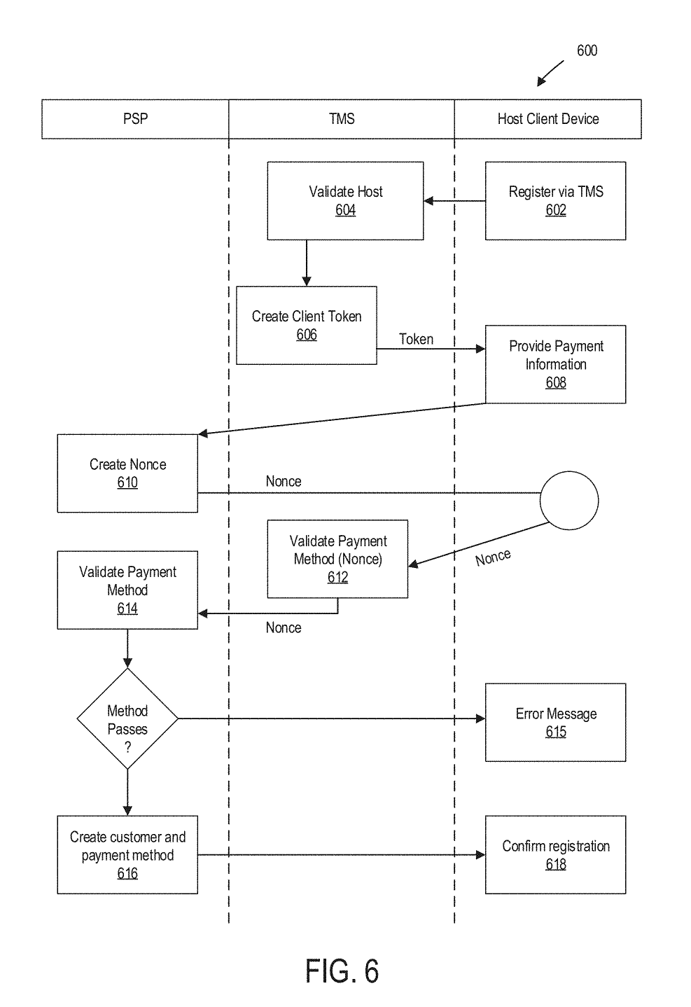

FIG. 6 shows an exemplary embodiment of operations associate with self-registration of hosts with focus on the registration with the PSP. Any parts and instances of the PSP described herein may be served from the PSP server 112, and PSP information described herein may be stored in the PSP database 114. Any parts and instance of the TMS described herein may be served from the travel management server 108, and information related to the operations of the TMS and registrations described herein may be stored in the travel management database 110. The host client device shown in the FIG. 6 may include any of the devices 120-126.

Depicted are operations 600, which may begin with the host registering itself through registration pages of the TMS at 602. This can occur from a client device of the host (such as a pre-authorized client device of the host). At 604, the TMS can validate the host. At 606, the TMS can create a client token, and pass the token back to the client device to certify a secure link. At 608, the client device can provide payment information of the host to the PSP. At 610, the PSP can create a nonce according to the payment information of the host send from the client device. At 612, the payment method can be validated by the TMS according to the nonce, which can be communicated to the TMS through the host's client device. Alternatively, the nonce can be communicated from the PSP to the TMS directly. Once validated by the TMS, the nonce can be sent to the PSP and used to validate the payment method of the host at the PSP at 614. If the payment method is validated at the PSP at 614, the PSP generates its own interaction of the payment method along with a new customer account associated with the host at 616. Confirmation of the new customer account and the valid payment method is then sent to the host's client device directly or via the TMS, and at 618 the host as an opportunity to confirm the registration with the TMS and PSP.

In addition to self-registration for a host, the information of the registration can be updated by the admin user of the host.

Not depicted, a provider can view a list of hosts. In some embodiments, the list of hosts is filtered by proximity to the provider. The provider can view any of the host information from the list view as well, such as Name, Phone number, Email, Description, Address, and Billing Address. The search and search results can be filtered, so that only trusted hosts are shown in some examples. Or the provider can select to search and list hosts whether or not they are trusted.

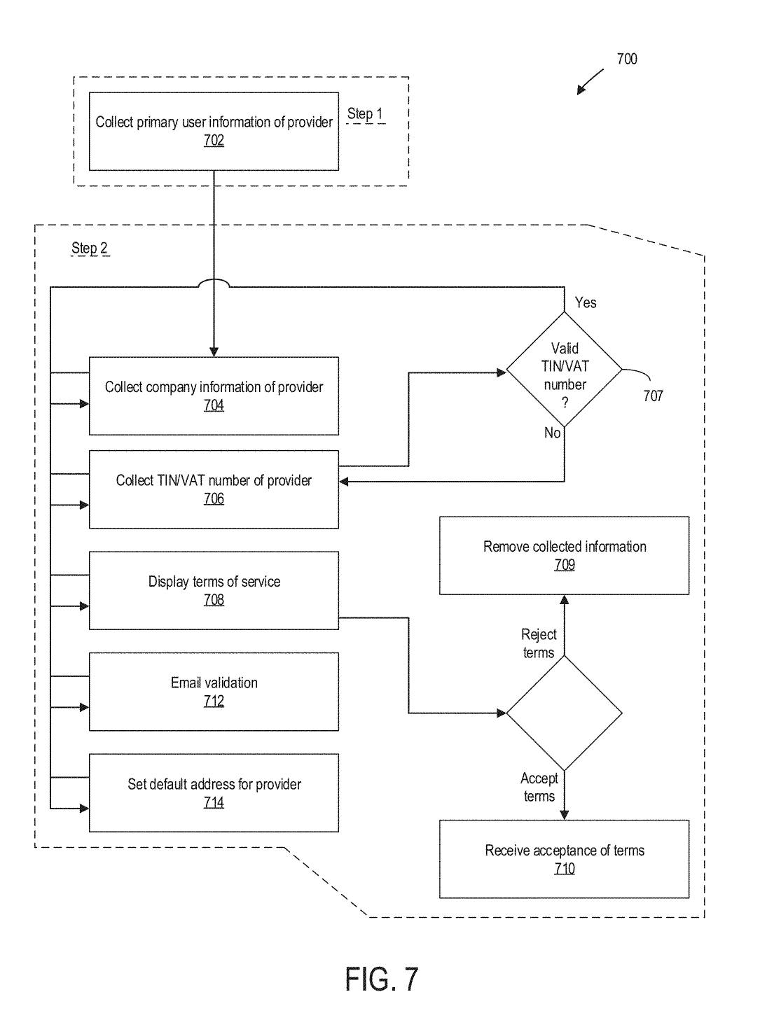

FIG. 7 illustrates exemplary operations 700 performed by an aspect of the TMS related to transfers, excursions, and other related travel services. Specifically, the operations 700 relate to registration of a provider. Exemplary operations 700 performed by an aspect of the TMS related to transfers, excursions, and other related travel services. Specifically, the operations 700 relate to registration of a provider. Such operations can be initiated by a seamless mechanism such as a graphical button on a web page labeled to indicate initiation of the registration. See FIG. 4B. Registration of a host can include a multi-state self-registration. In an exemplary embodiment, the self-registration can be split up into two different screens: a contact information screen (which includes fields associated with a primary user and a CAPTCHA), and a company information screen (which includes fields associated with company name, VAT, street address, billing information, and agreements with TMS and in some examples other parties). In some embodiments, the account is created after the user passes the first screen but it is may not be activated until completing the second screen (e.g., account created but the user cannot login).

The first step of the self-registration includes step 702 and it includes steps similar to those in step 502 of FIG. 5. The second step of the self-registration includes steps 704-714 and the second step is similar to the second step of the host self-registration, except for the provider can select one or more types of services they support. For example, the provide can select whether they support transfer services, food or dining services, excursion services, entertainment services, and the like. In instances where transfer services are selected, the type of vehicles available can be provided, such whether touring buses, cars, shuttles, or vans are available. Other functions and validations that apply to the second step of host registration may also apply to the provider registration.

In addition to self-registration for a provider, the information of the registration can be updated by the admin user of the provider.

Not depicted, a host can view a list of providers. In some embodiments, the list of providers is filtered by proximity to the host. The host can view the provider information from the list view as well, such as Name, Phone number, Email, Description, Address, Billing Address, and transportation types if the provider is a transfer provider. The search and search results can be filtered, so that only trusted providers are shown. Or the host can select to search and list providers whether or not they are trusted.

In list views of providers or hosts icons showing that a provider or host is trusted can be located to the side of the name of the provider or host. For example, provider and host lists can show a “trusted” icon to indicate whether they are trusted or not (e.g., the icon is a handshake graphic). The handshake graphic can be toggled (add or remove providers or hosts from their respective lists of trusted providers or hosts)

Subsequent to registration, a user can login to their respective account via a login page of the TMS. The login page can use basic authentication (user name, password) for users. The login page can have multiple sections, including a section for new users or users that have already registered. For new users the login section can have a link to user registration. For registered users, the login section can include fields for authentication, such as username and password fields.

Once registered, users of hosts or providers can add, edit, or cancel users to their profiles from their user-end devices, including mobile devices. In some examples, the TMS can provide mobile specific applications and GUIs for registering providers or hosts, and adding, updating, and canceling users. In some exemplary embodiments, only administrator users have the permission of the TMS to add, update, or cancel users. Also, users can accept or reject transfer requests after receiving notification that such requests are pending. For example, the provider can accept or reject the hosts request.

A provider can view and search a list of upcoming scheduled transfer events and take action to accept or reject enrollment through an end-user device. Specifically, with implementations using web-based applications, upon creation of a transfer or service, a push notification (e.g., success, waitlist, or does not meet prerequisites) can be generated from the TMS and is displayed in a corresponding application.

With examples of the applications of the TMS that are made for mobile use, the applications can integrate with commonly found applications usually installed on mobile devices. For example, the TMS may integrate with phone, GPS, email, text, chat, contacts, and scheduling applications of a mobile device. These mobile device applications may integrate with the TMS to show transfer by date, enhance or provide search or filters for viewing lists of the TMS. The filters may filter transfers and other types of services by hosts, guests, pickup, drop-off, and transportation. Also, through mobile integrated aspects of the TMS, existing browser based circuitry of the TMS can be adapted to direct a provider to access the complete list, search, filter, and display a host details through mobile apps. Also, a mobile app includes the ability to reach a host using other services such as services that are native to the mobile device (e.g., email, GPS phone, etc.). Pricing may also be managed through mobile applications integrated with the TMS. For example, mobile GUIs are included in some embodiments that can display a full Price List, search and upon selecting a pricing tier, view price tiers, cancel pricing, and edit pricing. Such mobile applications can include the ability to change origin, destination, prices and seats, etc. In general, the application level features described herein may be implemented via mobile applications and GUIs, and mobile platforms in general. Also, the TMS may seamlessly integrate with features commonly found on mobile devices.

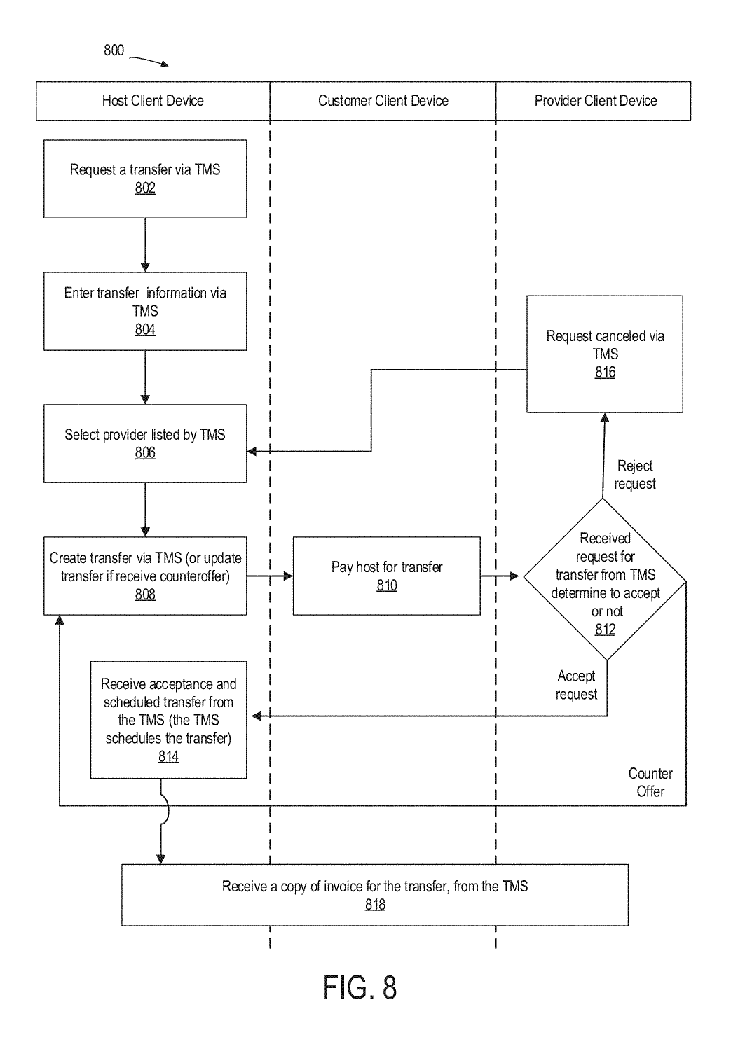

FIG. 8 illustrates exemplary operations 800 performed by aspects of the TMS related to customer transfers. The host client device, the customer client device, and the provider client device shown in FIG. 8 may include any of the devices 120-126. The TMS can provide user interfaces and circuitry to facilitate bookings of transfers of customers from a first location to a second location (such as from a hotel to an airport). A customer of a host at a first location (such as a customer of a hotel, travel agency, cruise ship, or other tourism business) can request a transfer to travel to a second location (such as an airport, entertainment or dining location, shopping location, car rental location, location of an excursion, or medical office), at 802. When the host is a cruise liner, a guest may request to make a transfer to an excursion start point while at port.

At 804, the host can enter transfer information into the TMS via one or more transfer information forms in the transfers section of the TMS webpage. A customer can include a primary guest and one or more additional guests. The fields for the primary guest can be First Name, Last Name, Phone Number, Email, ID-Type: Driver License, ID-Card, or Passport, ID Number, Number of baggage with a number drop down menu, Number of adults and number of children, wherein the total of adults and children is at least one.

In some examples, the guest information needs to be filled in before the user picks a provider to be able to show the prices for the transfer. The prices can be based on pick-up or drop-off locations and number of guests, for example.

At 806, the host can select a provider to transport the customer. The selection can be from a list of trusted providers relevant to the transport. The list can be a filtered list or a list that is a result of an online search function of the TMS.

At 808, the host can create a transfer using the selected provider and transfer information using create transfer forms. Any host user can create a transfer. Drop-off and pick-up locations can be geocoded using a maps application. TMS can automatically find providers based on their price list by matching pick-up or drop-off locations to the origin or destinations used in the price list.

Pick-up and Drop-off forms for creation of a transfer can include fields such as Pickup Date or Time, which can include date and time drop down menus. Pick-up and drop-off locations can be picked on-the-fly using an autocomplete. TMS shows the auto-complete box and also the map underneath. In some embodiments, locations cannot be picked from the map directly. In others, locations can be select off a map view.

Once the user selects a location, TMS receives the place information provided by the map application and creates a location if it does not exist. The place ID can be used as the key for the location. If it exists and is different, a new one can be created and the old one is disabled. In most exemplary embodiments, locations are specific points on the map with an address or with precise coordinates. TMS can validate the user selected a location with a valid street address or at least coordinates. In the case of using coordinates, the TMS may determine whether the location is reachable by a transfer vehicle selected. In some embodiments, a valid address is required even if the coordinates are reachable by the mode of transit.

In creation of a transfer, if the user selects a roundtrip (such as via a roundtrip checkbox), the user also has to enter the return date and time. This is analogous to the pickup date and time of an excursion for example. For round trips, in some embodiments the transfer price displayed represents the entire round trip. In some instances, the prices are automatically computed by doubling a one-way trip price. Also, more complex algorithms may price the round trip. Also, a provider may manually offer a price for a round trip or a one-way trip. In some embodiments, the option roundtrip can only be selected when the transfer is created but not once the transfer is saved.

Transfer information includes several fields. The information includes Transportation Provider, Price, and transit type, for example. After the user has selected a pick-up and a drop-off location and has entered the number of guests, the system matches the trip to the price items and populates the provider list with providers and prices. Providers with a matching price item can be shown in the providers list sorted by price (lowest first, provider name and price showing in the drop-down). Providers without matching price items can be shown below (such as with a drop-down menu) sorted by provider name.

In some examples, only trusted providers are visible.

If the user picks a provider with a price item, the system fills in the provider price (and in some examples cannot be modified) and calculates the fees and taxes and the total transfer price (which is the price for the customer). If the user picks a provider without a price item, the system shows a link to the price list the provider has uploaded (if applicable). The user then fills in the provider price manually and TMS computes the fees, taxes and the total transfer price. Only the provider price and the total transfer price is shown in some examples.

Transportation Type field includes an interface for the user to communicate a preferable type of vehicle for the transfer. The user can also select and even require a vehicle type.

A checkbox for flight and accompanying fields direct the user to enter flight information, so that the transfer can be scheduled around the flight. Flight information can include fields such as Earliest Flight Departure Time, Airline, Terminal, and Flight (Number).

Finally, saving a transfer stores the prices including for example, provider price, the fees and taxes and the total transfer price. When saving the transfer, a confirmation dialog shows the total transfer cost which is also the amount the host communicates to the guest. Also, prior to saving in a Miscellaneous field, special requests can be entered.

At 810, the customer, using a customer payment form of the TMS or not, pays the host for creating the transfer without going through the PSP. Alternatively, the customer, using a customer payment form of the TMS can pays the host for creating the transfer via the PSP.

At 812, the selected provider receives a notification from the TMS to accept or reject the transfer. A rejection may include a counter offer in some embodiments. At 812, the provider can view the notification and respond accordingly through a provider view of a proposed transfer. In some embodiments, the response of a rejection or acceptance may be automated or done manually depending on setting of the implementation of the TMS. At 814, the host receives a notification via the TMS from the provider, once a response is received by the TMS from the provider. Prior to 814, if accepted, the transfer is scheduled in the TMS according to the information entered on creation of the transfer. At 816, if not accepted, the transfer is left as un-scheduled until canceled or an agreement is reached between the host and the provider.

The TMS records and sends a copy of the invoice for the transfer to the provider, host, or the guest, and it is received at 818. The invoice can be sent from the TMS periodically, such as monthly, with other transfer invoices or other services invoices in general. The TMS can bill the host manually or automatically for the transfer fee, and the processing of the payment for the bill can be manual or automated as well depending on the settings of the implementation of the TMS.

The TMS can send the following notifications: guest confirmation of transfer booking, modification or cancellation. Guest reminder about transfer via email n days before the transfer date. In case the reminder is sent to the guest but the transfer has not been accepted by a provider, a notification email (alert) can be sent to the host (one alert for the upcoming transfer). The TMS can send one email per transfer request to ask the provider to accept or reject. The system can send one email per provider per day (not per host) with the following information: transfers scheduled for that day (accepted transfers); and transfers scheduled within the next n days, which is host or provider configurable (default: six days after today minus one week). Any modification or cancellations of transfers can be highlighted by the system in respect notifications. The system may send reminder emails for transfer requests awaiting acceptance or rejection to providers and hosts every n hours. If a roundtrip transfer is selected, the system can send an email notification to the provider of upcoming transfers starting seven days prior to arrival day, including on the arrival day.

The provider can receive an email when a transfer enters the Open or Pending status.

The email can contain basic transfer information including: Locations, Pickup or drop-off time, Number of people, Number of luggage, and Name of primary contact. The email can also contain an Accept and Reject hyperlink which directs the user to the TMS system to perform the corresponding action. The hyperlinks can include certain security measures to reduce risks. The link can expire within n hours (default: twelve hours). The link may be encrypted with Transfer ID, Notification Date, and User ID from the notification.

When the TMS system receives an accept or reject response from the email, it can accept the response without user authentication. The Accept Response page can simply confirm the acceptance. The confirmation message may contain the pickup time and primary guest name to provide distinguishing which transfer was accepted, but not provide so much information that it causes a security issue. The database can be updated accordingly after an acceptance.

The rejection message may contain the pickup time and primary guest name to provide distinguishing which transfer is being rejected, but not provide so much information that it causes a security issue. In such examples, a rejection reason field in the message can be made a mandatory comment field. Upon submission of a rejection, the database can be updated accordingly.

If a transfer is not in a valid status to receive an accept or reject operation, the system can respond accordingly.

Reminders for pending transfer requests are provided in most exemplary embodiments of the TMS. Every n hours, providers can receive an email with a listing pending transfers that demand a response. In most embodiments, the email is only sent if there are pending requests. An accept and reject hyperlink may be output for a transfer. A date can be output for a transfer listing so the provider knows when the transfer can be auto-rejected. Scheduled time periods can be generated for sending reminders. For example, a first time period can provide that at a first range of hours (e.g., at least 72 hours before a transfer starts (>=72 hours)), an email is sent every first selected number of hours (e.g., every 12 hours). A second time period can provide that at a second range of hours (e.g., less than 72 hours and greater or equal to twenty-four hours (<72 and >=twenty-four hours)), an email reminder is sent every second selected number of hours (e.g., every 6 hours). If there are no pending requests the email can be sent to create a request every selected period of time as well. A third time period can provide that at a third range of hours (e.g., less than twenty-four hours (<twenty-four hours)), an email reminder is sent every third selected number of hours (e.g., every 1 or 2 hours depending on the host's or provider's preferences).

In an exemplary embodiment, a transfer has four statuses, open, accepted, rejected, and canceled. When a service is created and requested by a host it is open in the system. When the service is accepted in the system, it has been accepted by a provider of the service. When the status is rejected for a service, it has been rejected by a provider or auto-rejected by the TMS. To the end-user they may be no different between these two types of rejections. However, the TMS can track the type of the rejection, and use the information for various purposes including upgrading the system. A created service can also be cancelled. When, cancelled, it is no longer available for rejection or acceptance.

In an example embodiment, a provider has to accept or reject a request actively. When a provider rejects a transfer, a popup appears to fill in the rejection reason (which may be mandatory comment field in some embodiments). The host can see the rejection reason in the notification email.

In most examples, transfers that are not accepted or rejected within n hours can be automatically rejected by the TMS and the host receives a notification. A corresponding schedule can be selected by an admin user of the TMS. Time periods can be set up for the automated rejections. For example, a first time period can provide that for a first selected number of hours (e.g., at least at 72 hours before a transfer starts (>=72 hours)), the auto-reject function waits for a first selected number of hours prior to execution (e.g., twenty-four hours prior to execution). A second time period can provide that for a second selected number of hours (e.g., between 24 and 72 hours before a transfer starts (<72 and >=twenty-four hours)), the auto-reject function waits for a second selected number of hours prior to execution (e.g., waits for 12 hours prior to execution). A third time period can provide that for a third selected number of hours (e.g., less than twenty-four hours before a transfer starts (<twenty-four hours)), the auto-reject function is turned off for the service.

TMS can create a transfer ID, which is a unique identifier for communication between customers and the TMS (e.g., for support purposes) that is visible in a transfer details page. In an exemplary embodiment, the transfer ID can include several fields. For example, the transfer ID can include at least one of the following fields: type code (TR), char country code (123, or ITA), 2 char year code (“15” for 2015), Char day of year (365 usually or 366 in a leap year), 2 char alpha (sequential, wrap-around), char numeric (sequential, wrap-around). For example, the following text may be an ID: TR_ITA_15_365_AA9999. Alternatively, there may not be spacers between fields of the ID, such as TRITA15365AA9999. Also, the transfer ID may be visible in the details page of a transfer but not the transfer list.

Transfer prices can be selected automatically by the TMS, if a provider has entered a matching price for a selected transfer. Alternatively, a transfer price can be entered by the host.

Location matching circuitry in TMS can find destinations that match a certain location. The match result can return multiple matching destinations. The match can have an order. A first order is an exact match, for example. A second order can be a regional match based on zip codes. A third order can be a regional match based on boundaries. If there are multiple matches of the same order, the system can automatically, for example, use the one with the smallest destination area (less zip codes, smaller boundaries). Also, other criteria may be used to rank destinations for selection.

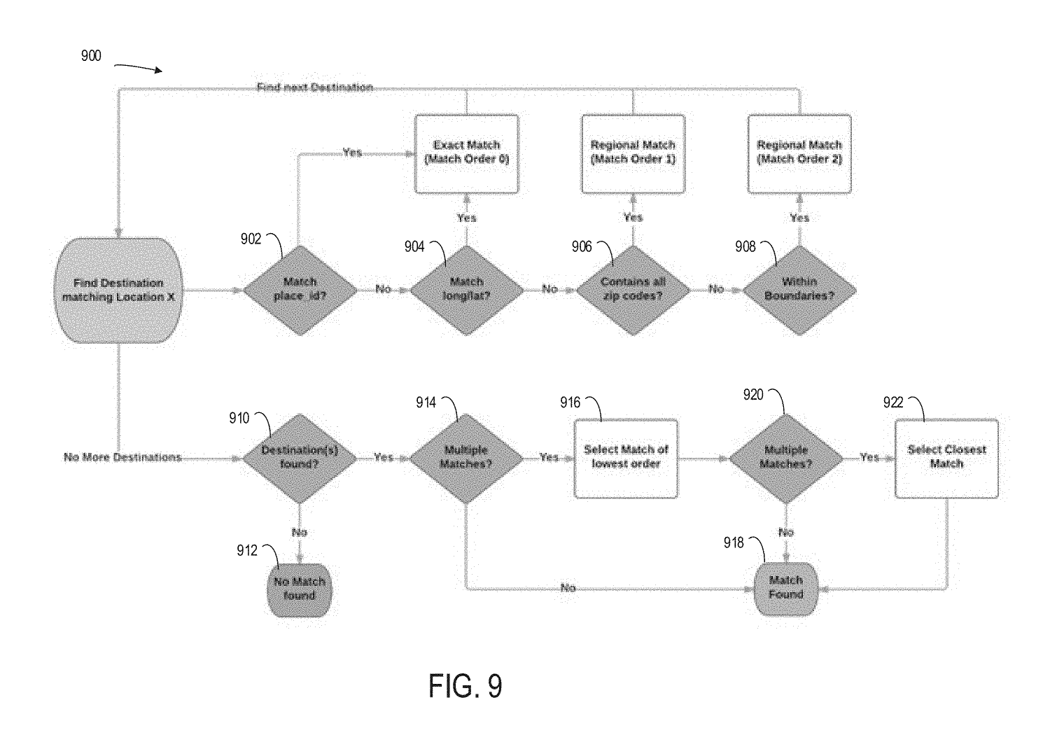

FIG. 9 illustrates exemplary operations 900 performed by aspects of the TMS related to destination matching for a service. To find a destination matching a location “X”, operations 900 begin by comparing place ID of location X to stored place IDs of or associated with the TMS, at 902. If there is a match at 902, then it is an exact match (e.g., the first order match), and the operations move to finding another destination. At 904, operations can continue with comparing coordinates (such as longitude and latitude) of location X to stored places with listed coordinates in the TMS. If there is a match at 904, then it is an exact match (e.g., the first order match) as well, and the operations move to finding another destination. At 906, operations can continue with comparing the zip code of location X to stored zip codes in the TMS. If there is a match at 906, then it is a regional match (e.g., the second order match), and the operations move to finding another destination. At 908, operations can continue with comparing a certain boundary to destinations with in predetermined boundaries stored in the TMS. If there is a match at 908, then it is a second type of regional match (e.g., the third order match), and the operations move to finding another destination. Operations 902-908 can be repeated if there are multiple destinations to consider (depending on the specifics of the service requested by a customer or host). At 910, it is determined whether there are multiple destinations to consider or rank. If no destinations are needed, the operations 900 end at 912. Otherwise, it is determined if there are multiple destinations to consider, at 914. If there are multiple destinations, the TMS selects the lowest order, at 916. Alternatively, the TMS can use a different criterion to base the selection of the destination. For example, it may use a different criterion that prioritizes the orders differently. If there are not multiple matches at 914 the match is found and completed, at 918. At 920, it is determined if there are multiple destinations identified at the lowest order. If not, the match is found and completed, at 918. If there are multiple destinations identified at the lowest order, then a secondary criterion is used by the TMS to complete the match. For example, the closest location to the customer or the host may be a factor, at 922. Also, demographics or psychographics of the customer or users of the host in general may be a factor.

In an exemplary embodiment, if the TMS finds destinations for the pick-up and the drop-off locations, it can search for price items. A price item matches the search if the pick-up location matches the origin and the drop-off location matches one of the destinations in the price item. In some embodiments, price items may not be matched from drop-off to price item origin or pick-up to pricing item destinations.

In such an embodiment and in others, the price can be calculated based on at least one the following components: provider fee (which can include provider price (excluding VAT) and the provider VAT (percentage)), Host Fee (percentage), Host Tax or VAT (percentage) (which can include a TMS Fee (minimum amount and percentage) and TMS Tax or VAT. A fee or tax can add on top of the previous amounts.

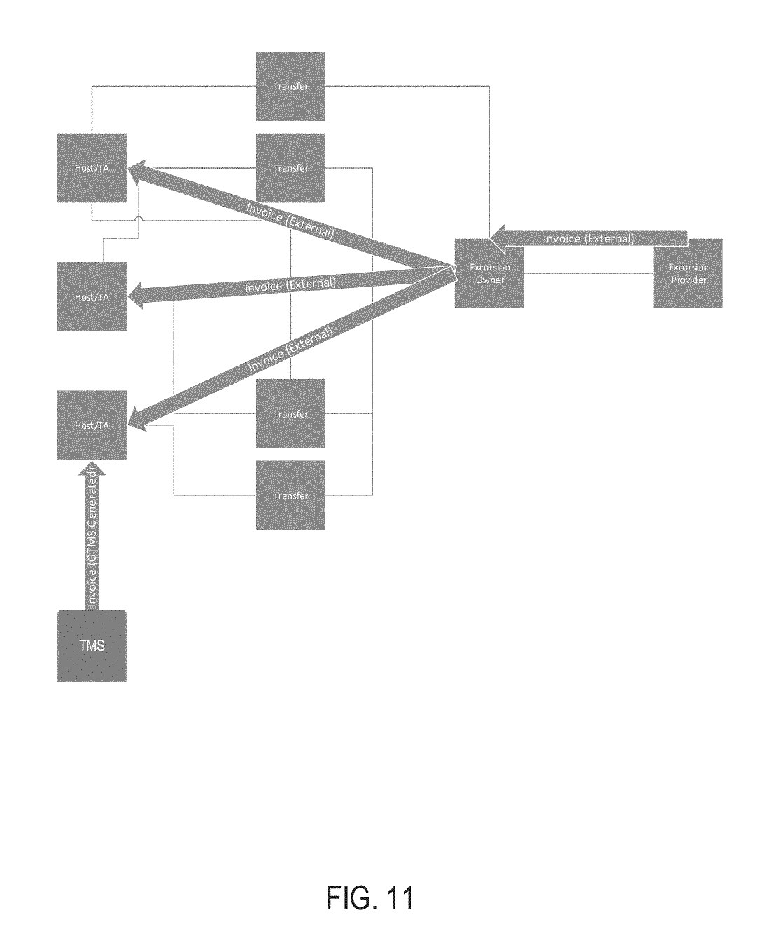

FIG. 11 illustrates an example flow chart depicting an example flow of invoices governed by the TMS. As shown, in such a flow, an excursion provider, via the TMS, can send an invoice to the owner of an excursion (such as a travel agent). The excursion owner, via the TMS, can send invoices to hosts partnered with the owner for the excursion. These last invoices include costs for respective transfers of the partnered hosts. The TMS can also send a separate invoice for its commission to a host using the TMS.

In an embodiment, the host only sees the provider fee and the total guest cost, the provider only sees the provider fee, and the customer only sees the total customer cost.

In an exemplary embodiment, through one or more webpages of the TMS, a user can see existing transfers for a selected day (e.g., default being the day of the query). The user can modify the dates to list the transfers for a date range. If the resulting list is longer than a predetermined number (e.g., twenty) then the user can get next and previous buttons (paging). The user can filter or search transfers that match a full-text search term. The transfer list shows a link to a maps application. When clicked a maps application can open in a separate window or tab to show the route for that transfer.

In an exemplary embodiment, the host user can modify or cancel an existing transfer (subject to X hours cancellation policy for accepted transfers). Rejected transfers show a “Try Again” button that opens the transfer details to re-assign it to another provider. Hosts see the guest price and the provider in the transfer list (next to the regular fields like status, pickup, drop-off etc.).

In an exemplary embodiment, providers only see transfers assigned to themselves. Providers see the provider price, the transportation type and the assigning host in the transfer list (next to the regular fields like status, pickup, drop-off etc.).

In an exemplary embodiment, only open or rejected transfers can be modified by hosts. Also, accepted transfers cannot be modified in such an embodiment. A host can modify any field except the round trip option. An open or rejected transfer can be cancelled at any time, even within the cancellation policy timeframe. An accepted transfer can only be cancelled outside the cancellation or modification policy timeframe in most examples. The host can re-assign rejected transfers but not cancelled ones.

In some exemplary embodiments, billing is the act or instance of preparing or sending out a bill or invoice. The TMS, provider, or host can send out a bill through the TMS to any billed party.

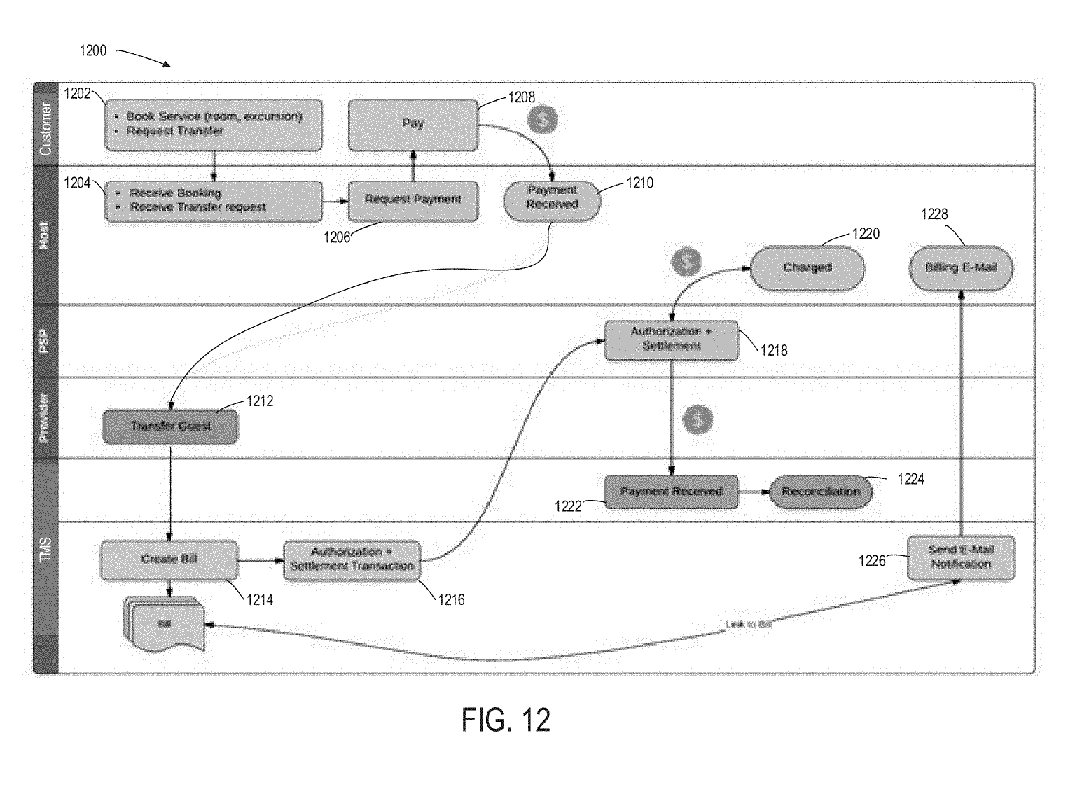

FIG. 12 illustrates operations 1200, which are examples of billing and payment processes provided by the TMS. The functions of the customer, host, and provider shown in FIG. 12 may be implemented by any of the devices 120-126 of FIG. 1. As mentioned herein, parts and instances of the PSP described herein may be served from the PSP server 112, and PSP information described herein may be stored in the PSP database 114. Parts and instance of the TMS described herein may be served from the travel management server 108, and information related to the operations of the TMS and registrations described herein may be stored in the travel management database 110.

The operations 1200 can begin with a customer of the host (e.g., a guest at a hotel where the hotel is the host) requesting a booking for a service (which may include an accommodation or an excursion, for example), and with that booking requesting a transfer as well, at 1202. Through a user interface of the host, the requests of operation 1202 can be received, at 1204. After receiving the requests from the host at operation 1204, the host through a user interface or a message can request a payment from the customer, at 1206. At 1208, the customer can pay the host according the request communicated by the host at operation 1206. At 1210, the host receives the payment from the customer electronically or manually.

After payment by the customer to the host, a service provider (e.g., a transfer provider) can provide a requested service to the customer, at 1212. After the service is provided to the customer by the provider, the TMS can generate a bill, such that the provider can bill the host for the service provided to the host's customer, at 1214. At 1216, the TMS can conform the bill to a PSP for authorization and settlement of the transaction (for example, through a middle layer of the TMS that interfaces a similar layer of the PSP). At 1218, the PSP receives the bill from the TMS and can further conform the bill to its own authorization and settlement processes. At 1220, the PSP requests payment from the host according to the processed bill. Also, at 1222, the PSP can pay the commission of the TMS according to the processed bill. Also, at 1224, after receiving the commission, the TMS can perform a reconciliation process (which is further explained herein). At 1226, the TMS can send a notification of the aforementioned payments and transactions (such as via email) to the host. At 1228, the host receives the notification sent at operation 1226.

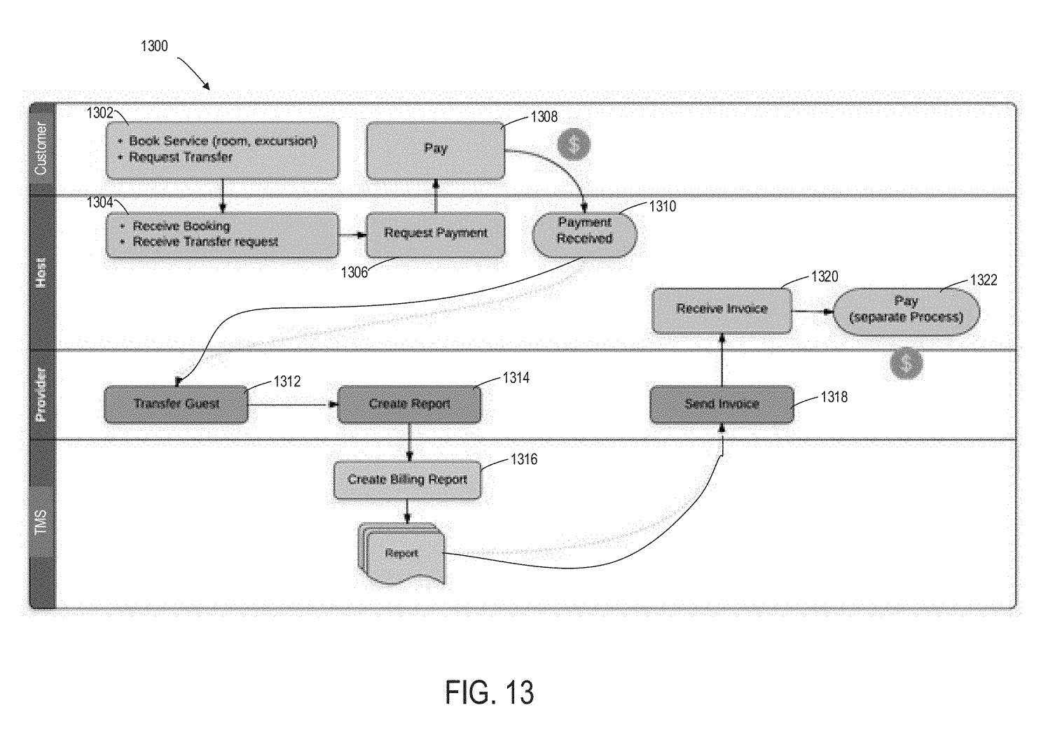

FIG. 13 illustrates operations 1300, which is an example of simplified billing and payment processes through the TMS, which excludes the PSP from the payment process. The functions of the customer, host, and provider shown in FIG. 13 may be implemented by any of the devices 120-126 of FIG. 1. Similarly, the operations 1300 can begin with a customer of the host (e.g., a guest at a hotel where the hotel is the host) requesting a booking for a service (which may include an accommodation or an excursion, for example), and with that booking requesting a transfer as well, at 1302. Through a user interface of the host, the requests of operation 1302 can be received, at 1304. After receiving the requests from the host at operation 1304, the host through a user interface or a message can request a payment from the customer, at 1306. At 1308, the customer can pay the host according the request communicated by the host at operation 1206. At 1310, the host receives the payment from the customer electronically or manually.

After payment by the customer to the host, a service provider (e.g., a transfer provider) can provide a requested service to the customer, at 1312. After the service is provided to the customer by the provider, the provider can generate a billing report to send to the TMS at 1314. At 1316, the TMS can generate its own billing report accordingly. At 1318, based on the report generated by the TMS, the provider can communicate an invoice to the host. At 1320, the host can receive the invoice, and at 1322, the host can pay according to a separate payment process.

In some exemplary embodiments, bills can have multiple statuses. For example, the statuses can include an open status when the bill is created. A non-billed status occurs when the bill is below a minimum amount. An incorrect bill status, when a bill that was marked as incorrect (manually or automatically according to predetermined criteria). A declined status, when the payment was declined. A re-billed status is logged when a re-billed bill is unpaid and the balance flows over to a new bill in the next billing cycle. A paid status, such as when the bill has been paid (also such as when the payment is settled), which can be considered a final status in some examples. A cancelled status, when there may be a dispute, a bill can be cancelled. This can also be considered a final status in some examples.

In some exemplary embodiments, the bill has a flag marking it as sent (or not), once it is sent by email. Sent may not be a separate status though because it can be set for open and non-billed bills.

In some exemplary embodiments, a bill status follows at least one of the following four paths. The first path: open, then non-billed, then re-billed or cancelled. The second path: open, then determine incorrect, then re-bill. The third path: open, then declined, then re-billed or cancelled. The four path: open, then paid or cancelled.

In some exemplary embodiments, payment can have multiple statuses. An open status, when the payment has not been submitted but is ready to be processed. A submitted status, when the payment has been submitted to the PSP for authorization and settlement. A settled status, when the payment has been settled, the money is about to be transferred to the TMS account. The settled status may be considered a final status by the TMS. A declined status, when the payment has been declined during authorization or settlement. Once a payment is declined, the status cannot be changed. When the payment process runs the next time, it can create a new payment if the bill is still open. Thus, the declined status is considered a final status by the TMS.

In some exemplary embodiments, a payment status follows at least one of the following two paths. The first path: open, then submitted, and then settled. The second path: open, then submitted, and then declined.

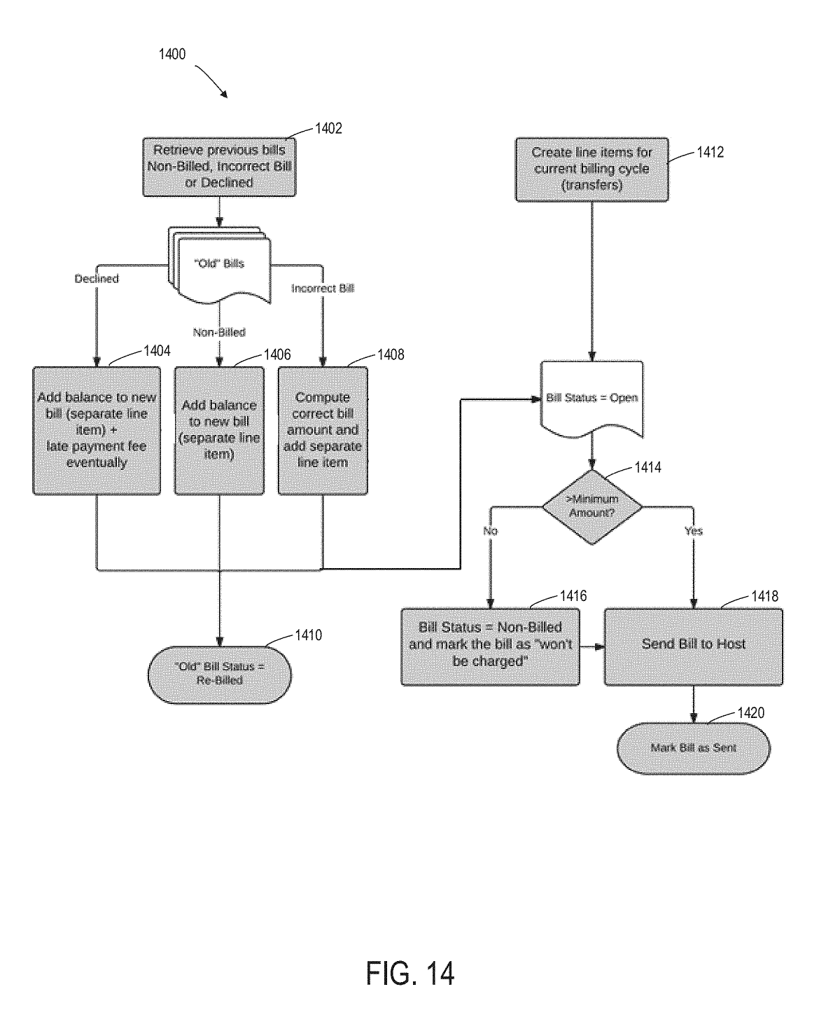

In some exemplary embodiments, the billing process can create bills for a billing period and send them out to the hosts by the TMS. FIG. 14 illustrates operations 1400, which is an example of simplified billing and payment processes of the TMS. The operations 1400, can begin with the TMS retrieving previous bills (including non-billed line items, incorrectly billed line items, or declined line items), at 1402. If previously declined bills, the TMS can add the balance of the declined items to a new bill, at 1404. The addition at operation 1404, can include adding a previously line item to the new bill along with a late payment fee. If previously an item was non-billed, the TMS can add the balance of the non-billed item to a new bill, at 1406. If previously an item was incorrectly billed, the TMS can add the balance of the incorrectly billed item to a new bill, at 1408. At 1410, via a user interface sent out by the TMS, hosts, providers, and even customers can be notified of the updates from operations 1404-1408. In an example, the notifications of operation 1410, include a line item status of “Re-Billed”. In such an example, the previous line item may be shown as well in a notification.

At 1412, line items for a current billing cycle are generated by the TMS, which includes the additions from operations 1404-1408. The previous items and the new items of the current billing cycle can be tagged as having an open status. At 1414, the items of the current billing cycle are compared against a threshold to determine whether the items combine exceed a minimum amount needed to send a bill to a host. If the threshold is not exceeded, then the bill status can be marked as non-billed by the TMS and the bill may not be sent to the host, at 1416. If the threshold is exceeded, then the bill is sent by the TMS to the respective host at 1418, and marked as sent to the host at 1420.

In some exemplary embodiments, the TMS creates bills and sends them to hosts according a configured schedule, such as on a monthly basis. In such embodiments, the invoices can be created automatically. Where it is on a monthly basis, the bill can be created the first of a month for the previous month. The bills can be created in HTML for presentation and PDF-A for legal and convenience purposes (such as by selecting a download and print button on a TMS webpage). The bill might go through a review process before it sent to the host. The review process can be a manual or an automatic process or a combination of the two. A flag “Reviewed” can mark the bill ready to be sent to the host at the moment TMS automatically sets that flag to true. Once the billing process terminates it starts the payment process (or work with a time delay to make sure one terminates before the next starts).

In some exemplary embodiments, the pricing model can include a fixed percentage of each transfer amount. There is a minimum charge per transfer in such examples. TMS can charge whatever amount is higher. In such example, the default percentage can be 5% and identical for hosts. For example, the minimum amount can be 1 Euro and identical for hosts. Also, in some embodiments, the model can use a calculation method where it is a fixed fee per guest or seat instead of a percentage of the transfer cost. The percentage and the minimum amount can be configured by a TMS administrator (such as by the back-end circuitry). In one example, the TMS may include different tiers for different hosts—with respect to the pricing model. Also, in an example, the billing module is restricted from performing price calculations for individual transfers since the transfer already stores the different price components in such an example.

Bills can be notified to the host by email. For example, a bill created with link to the bill on the TMS webpage, and auto-deduct can occur in the next few days. In such examples, the bill is marked as sent (flag) once the SMTP server acknowledges the mail. Emails can be sent one by one to each sender to limit being identified as spam.

The billing process can also be triggered manually. It may create bills if there is no open or sent bill for the current billing cycle. It may be re-sent with status open. In such an example, the manually triggered billing process can be restricted from starting the payment process when it terminates.

The TMS can also maintain a status history for each bill. If there is a dispute about a bill (e.g., wrong billing amount), it can be cancelled if its status is: Open, Non-Billed, or Declined. Cancelling a bill may be done by that the backend circuitry. Most calculated values and statuses that are presented are at least partially determined in some cases by the front-end circuitry of the TMS. Whereas, calculations or status that are in the background, or not viewed ultimately by a user of the TMS, can be executed by the back-end circuitry of the TMS.

With respect to the front-end circuitry, hosts can have top-level navigation items and one of those items can include billing. In some embodiments, the billing screen shows the bills for a certain time period and are ordered in a predetermined manner, such as the past twelve plus one months (to have a full year) categorized by month in descending order (current month first). The billing list can at least one of the following fields: Invoice number, Invoice date, and bill status. The bill status can occur if the status is “Re-Billed”. This can occur when the TMS shows the previous status additionally. This can be beneficial in explaining the re-billed status (such as Re-Billed (Non-Billed), Re-Billed (Incorrect Bill), or Re-Billed (Declined)). Bills with status “Incorrect Bill” and “Re-Billed (Incorrect Bill)” are not shown to the host in most examples.

The bill can be opened to show the HTML or the PDF bill with the details. The invoice number has to be an auto-incrementing number (across hosts). There can be no duplicates. Bills can have a summary page to show the number of transfers per provider, the transfer costs per provider and the amount the host owes TMS. Detail pages may show transfers per provider with at least one of: amount of transfers per provider numbered 1 . . . n, Transfer ID, Pickup, Drop-Off, Step (1 or 2 for return trip when it is a roundtrip), Transfer cost (this is the summation of the provider fee, host fee, and host VAT, for example), rate (which is the TMS markup—either the minimum amount or a percentage of the transfer cost), VAT (the TMS VAT), and TMS charge (summation of the TMS markup and the TMS VAT).

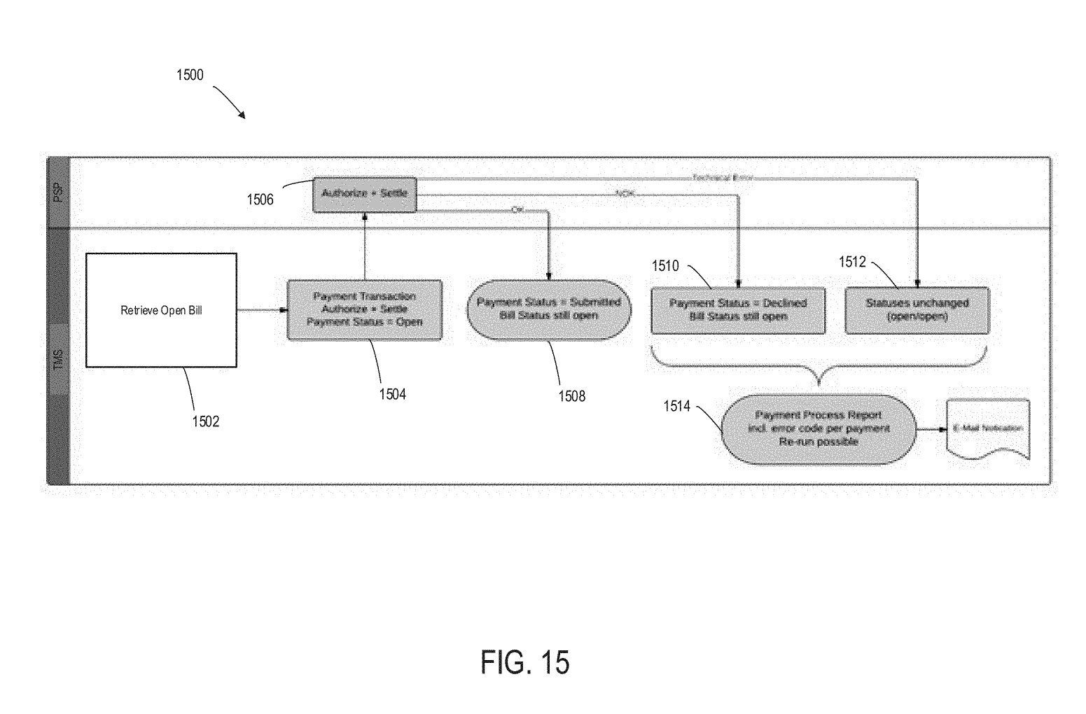

In some exemplary embodiments, the payment process creates payments for open bills and authorizes and sends them to the PSP for settlement as shown in FIG. 15. FIG. 15 illustrates operations 1500, which is an example of payment management between the TMS and the PSP. Operations 1500 can begin with the TMS retrieving an open bill at 1502. For example, the bill includes no items with a payment submitted or settled. Also, for example, there is no item with a status of an open or declined payment. At 1504, the TMS authorizes and settles the payment, and the payment status becomes open. In an example, if there is an open payment item it is reused; otherwise, a new open payment is created. At 1506, the PSP authorizes and settles the payment. At 1506, it is determined whether the payment is valid or invalid, and if there is any technical error in the submission. If there is a valid payment, then the payment status becomes submitted and the bill status is still open at 1508. If there is an invalid payment, the payment status becomes declined and the bill status is still open at 1510. If a technical error is found in the payment submission, the statuses remain unchanged in that the payment status remain open and the bill status remains open at 1512. At 1514, when the payment is invalid or there was a technical error, the TMS sends out a notification (such as by email) to at least one of the parties reporting the status or the bill and payments.

As illustrated, the TMS can manage the payment authorization and submit the payment for settlement. The payment process can be started by the billing process. Alternatively, the payment process can be time-delayed or triggered by a message from a part of TMS or an external system other than the billing process. Also, the payment process can be manually triggered by a user of the TMS. In some embodiments, the payment process can be delayed until a threshold amount to be paid occurs.

TMS can connect to the PSP to deduct the billing amount. This can occur within a predetermined time period (such as the same day the bill for the host is created). The transaction can be submitted for authorization and settlement in one communication. The submission can be managed by middle layer circuitry of the TMS. The middle layer circuitry of the TMS can also prevent the host from being charged more than once per a preselected duration, such as per billing cycle.

The TMS can store a status history for each payment, such as by using the travel management database 110. The PSP can track status as well, and the status recording by the TMS is not necessarily the same as the status recorded by the PSP.

At the end of the payment process an error report can be compiled, listing bills and payments with authorization failures or technical issues. The report can be sent by email to a configurable list of recipients. Technical errors can include known potential technical issues within the TMS. Some errors are associated with an error code and an error description that directs the TMS to correct the error and re-run the payment process.

Declines of payment can have variations in the TMS. For example, with a soft decline, the payment process can be retried. Soft declines usually occur as a result of a temporary issue and may be successful avoided with a subsequent attempt. With a hard decline, the payment process may not be retried. Hard declines usually occur when the refusal is not temporary and subsequent attempts may likely not be successful. Declines to technical failures occur often because of back-end processing errors or network communication errors. These are usually not a problem with the payment process and may be avoided with a subsequent attempt.

The error report can capture an EPS error code and a categorization hard or soft declines and technical failures. Handling of declines and errors may be automated.

An authorization or the settlement can also fail because the payment method needs to be updated (e.g. credit card has expired). A host or a customer can update the payment information in their respective profile (which can be similar to the self-registration process). In some embodiments the TMS does not store the payment method; thus it cannot be changed. In such instances, a new payment method can be provided upon initiation of a new payment.

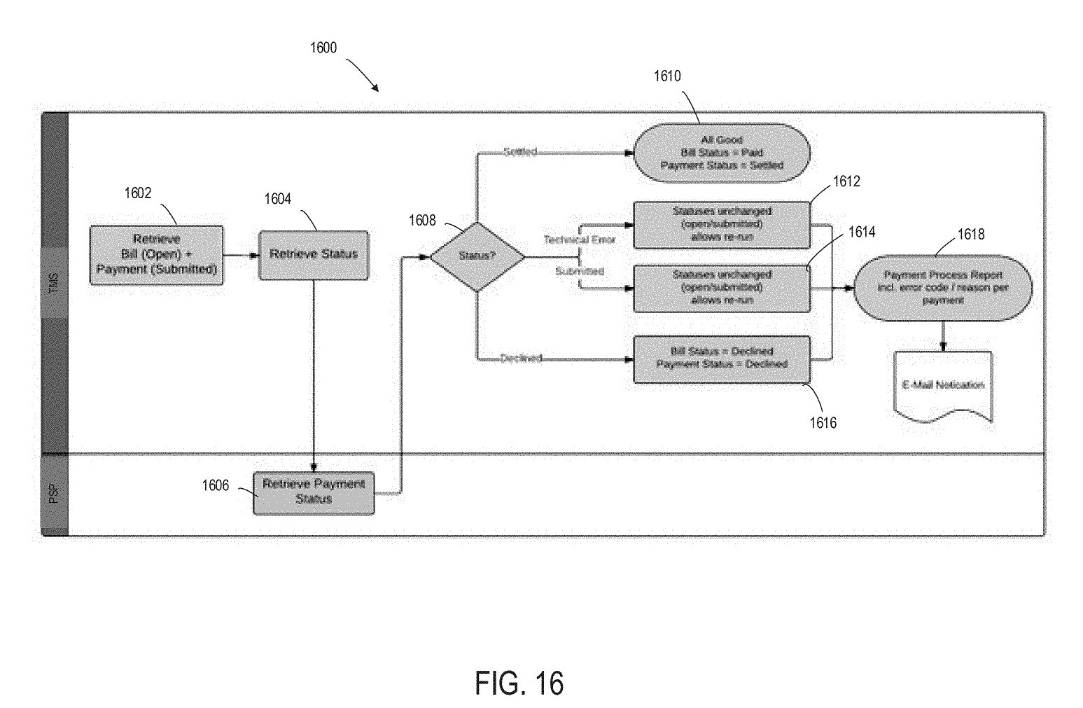

In some embodiments, the payment operations include a reconciliation process. FIG. 16 illustrates operations 1600, which is an example reconciliation process between the TMS and the PSP. The reconciliation process retrieves the status of submitted payments from the PSP, updates the TMS statuses accordingly and takes action if necessary. The operations can begin with the TMS retrieving an open bill and a corresponding submitted payment, at 1602. At 1604, the TMS can retrieve the status of the bill. At 1606, the PSP can retrieve the payment status of at least one item on the bill. At 1608, the TMS can determine the payment status according to the status retrieved by the PSP. If the payment status is settled, then at 1610 the TMS marks the bill status as paid and the payment status is maintained as settle. If the payment status includes a technical error, then at 1612 the TMS leaves the statuses unchanged (e.g., bill status open, and payment status settled). If the payment status is considered submitted alone, then at 1614 the TMS leaves the statuses unchanged as well. If the payment status is declined, then at 1616 the TMS changes the bill status to declined and the payment status remains as declined. At 1618, the TMS communicates a report to any one of the parties regarding the statuses of the payments and the bill. As shown, no report is sent out if the payment status is settled. However, in some embodiments, reports are sent out for statuses. In most exemplary embodiments, an email notification is sent by the TMS.

In reconciliation, the TMS can retrieve payments statuses from the PSP and take action if needed. The reconciliation process can start at a predetermined time (such as on the fifth day of each month), but can also be triggered manually. The TMS can check the previous month's charges and payments by retrieving the payment status from the PSP. For example, this can occur with a billing status open and payments with status submitted. If a payment has been settled the payment can be marked as settled. If a payment has been declined or is still not settled, the status can be updated accordingly and a notification is created.

When payments have been processed, non-settled payments (from a previous billing cycle) can be reported by email. The report can list the host including contact information (e.g., email and phone number) and the outstanding payment, as well as an error message showing the reason why the payment was not settled (if available). Depending on the reasons, the TMS may contact the PSP or the host to settle the payment.

The billing, payment, and reconciliation processes can be designed to run on chunks or a subset of hosts. These processed can operate with a nomination process that controls the chunk or subset of bills or payments the processes run on at a selected time. The nomination process passes in the different chunks to the process to execute billing, payment, or reconciliation. The design increases the scalability of the system by using multiple threads on one machine or multiple machines. The multiple threads can be managed by a process controller process that controls the execution of the different sub-processes of billing, payments, and reconciliation.

Also, the TMS can generate reports based on the chunks or subsets.

The reports can also be created based on a selected date range. Fields of the reports can include current month, previous month, custom start and end date. The billing reports can show per host, the following fields: date, bill number, host name, number of transfers, transfer costs and total cost of transfers, TMS commission, and bill status (e.g., opened or paid). If a host has outstanding payments, they can be marked as such on the report. Outstanding means that the bill has a status of open and either the payment authorization failed (current billing cycle) or the settlement did not occur (such as in the last billing cycle). In either case, the bill has a payment with status declined.

Provider reports can also be created based on a date range selection, and can include the following fields: current month, previous month, and custom start and end date. The provider reports can provide the following fields per provider: provider name, number of transfers, number of accepted and rejected transfers, and transfer costs (and total cost of transfers). The TMS can create reports for providers on-demand.

Transfer reports can also be created based on a date range selection, and can include the following fields: current month, previous month, and custom start and end date. The transfer reports can show the following fields per transfer: date, host name, pick-up location, drop-off location, transportation type, one-way or roundtrip, number of guests, and transfer cost. The overall report totals can show: total guests transported, and the total costs for transfers

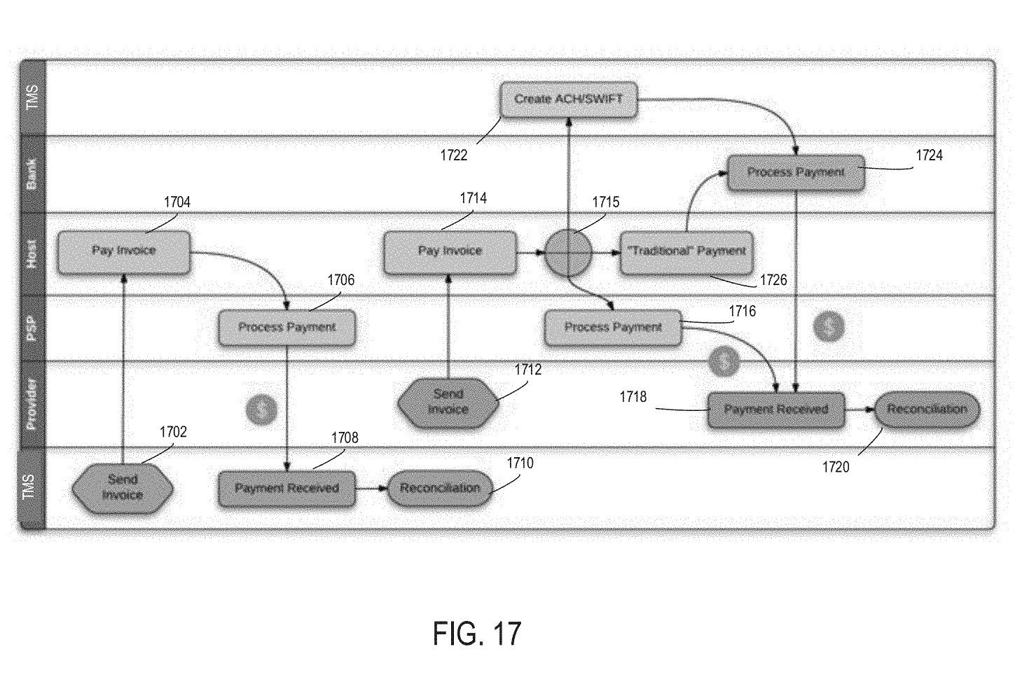

FIG. 17 illustrates operations 1700, which is an example overview of payment processes between the TMS, providers, the PSP, hosts, and a bank, with a focus on hosts paying bills. The operations include two payment process methods for hosts.

The first method includes the TMS sending an invoice to the host electronically at 1702. At 1704, the host initiates payment the bill via a form of the TMS. At 1706, the PSP offers different payment methods (credit cards, PAYPAL, wire transfer etc.) to complete the payment. Some PSPs offer over fifty different payment methods. At 1708, the TMS receives the payment from the PSP, and afterwards at 1710, a reconciliation process, such as any of the reconciliation processes described herein, can occur via the TMS.

The second method includes the provider sending an invoice to the host electronically at 1712. At 1714, the host initiates payment of the bill via a form of the TMS. At 1715, the system offers three different payment vehicles. At 1716, the PSP offers different payment methods (credit cards, PAYPAL, wire transfer etc.) to complete the payment. At 1718, the provider receives the payment from the PSP, and afterwards at 1720, a reconciliation process, such as any of the reconciliation processes described herein can occur through the provider via the TMS. At 1722 the TMS can offer and create an ACH or SWIFT export for a host to send payment instructions to its bank for automated payment processing by the bank at 1724. At 1722, the TMS can be configure to charge transaction fees, percentages or both per host. Also, providers can enter their account information in their profiles and the hosts can pay them via known channels such as a bank transfer or by check at 1726. Then a bank can process the payment at 1724. Subsequent to the bank processing of a payment at 1724, the provider receives the payment from the bank at 1718, and afterwards at 1720 a reconciliation process can occur.

In such examples, providers sign up as a merchant to be able to get paid through the PSP. TMS can also store some of the merchant information to interface with the PSP. Providers can also store their payment information in TMS to get paid by ACH or SWIFT. Other options may include directly debiting the account of the host, or using the stored hotel's credit card information and automatically charging the hotel. In some examples with storing credit card information, the TMS can configured to be PCI compliant.

The pricing for the TMS services can include at least one of a minimal charge if a percentage is charged, a maximum charge if a percentage is charged, use of different percentages depending on the price of a transfer, use of different percentages depending on the total amount charged to a hotel in one billing period (such as a volume discount), and use of different prices depending on the amount of transfers.

With respect to the operations 1706 and 1716, for example, in the billing of a list of services, the host can pay a single bill per item or select an option to pay all open bills at once. In such examples, the TMS redirects the payments to the PSP and the host pays. Also, the PSP charges a service fee and credits the payment to a TMS account.

With respect to the operation 1722, for example, in the billing of a list of services, the host can pay a single bill or select “pay all” to pay all open bills at once. The TMS can create a batch file to be downloaded by the host in such instances, and the hosts sends it to the bank to process the payments. In some embodiments, such functionality is only supported if the user's profile is configured with the bank information.

For bank transfers at 1724, the TMS can use profiles of the provider that include bank information. From retrieval of the profile, the provider can show the bank coordinates on the bill. Also, as mentioned, at operation 1726, the hosts can pay through a known channel of their choice (e.g., bank transfer, e-banking, cash, check, etc.).

The TMS can include localization circuitry (such as APIs for interfacing with various foreign language applications) configured to adapt the language, addresses and date and time formats to the regional requirements of a target market. The circuitry may also be configured to format text according to appropriate right-to-left (RTL) and top-to-bottom text formatting. In some embodiments, English is the system language, and translations can be provided by an external system connected to the TMS. The TMS can also use common address, phone number, date and time, and numerical formatting per locality and can adapt standards according to regional requirements of a target market. For example, the portal side of the application uses localized date and time, so depending on the user's locale the format may change. For example, the format for the portal to devices in Italy formats time according to “dd/mm/yyyy HH:mm” which is a 24-hour clock format. In the United States, the portal to users uses the 12-hour clock format. Additionally, the localization circuitry can be configured to adapt the TMS to various types of web browsers in additional to adapting the TMS to various localities. Also, dates and times can be stored in the system with time zone information.

The TMS can also use various APIs to interface with external travel-related systems. For example, the TMS can use APIs to integrate with the applications of other travel websites, systems of airlines and other modes of transportation, taxicab and driver services, systems of major accommodations, such as systems of hotel chains, systems of convention centers and major travel sites, such as stadiums and parking, public transportation information systems, etc. The TMS can integrate with such systems using other interfaces that provide for integrations with network layers, middle layers, and backend data storage layers of the other systems.

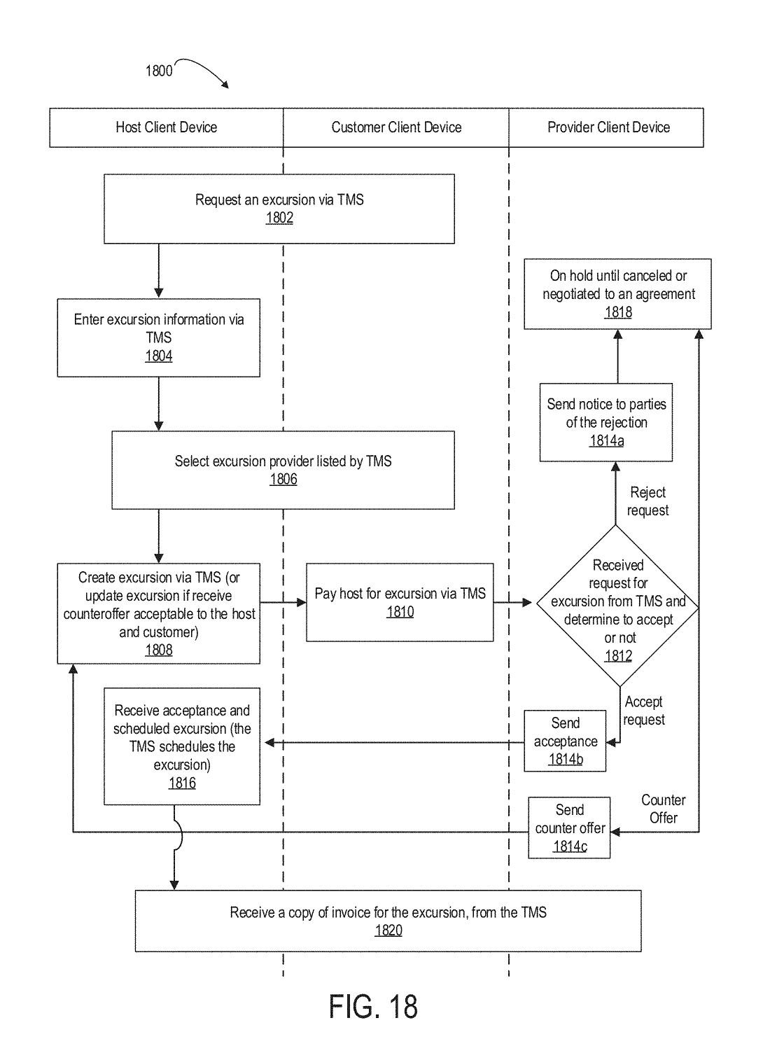

### Detailed Description—Description of Additional Exemplary Embodiments and FIGS. 18-29

FIG. 18 illustrates exemplary operations 1800 performed by aspects of the TMS related to booking of excursions.

The TMS can provide user interfaces and circuitry to facilitate bookings of excursions (such as a diving excursion when a customer is staying at a resort). A customer of a host at an accommodation or another type of location (such as a customer of a hotel, travel agency, cruise ship, or other tourism business) can request an excursion, at 1802. When the host is a cruise liner for example, a guest may request to make a sightseeing excursion at a port. The request for an excursion, which is facilitated via user interfaces of the TMS, can be done through a client device of the customer, the host, or both.

At 1804, the host can enter excursion information into the TMS via one or more excursion information forms in the excursions section of the TMS webpage. In this example, a device of the host is an intermediate to the circuitry of the TMS, whether or not the request is made from a device of the host or the customer.

At 1806, the host can select a provider for the requested excursion. The selection can be from a list of trusted providers relevant to the requested excursion. The list can be a filtered list or a list that is a result of an online search function of the TMS. Also, the customer through the customer client device can select a provider from the list. Similarly, a device of the host can be an intermediate to the circuitry of the TMS, whether or not the selection of the provider is made from a device of the host or the customer. At 1808, the host can create an excursion using the selected provider and excursion information using create excursion forms of the TMS.

At 1810, the customer, using a customer payment form of the TMS, pays the host for creating the excursion. At 1812, the selected provider receives and views a notification from the TMS to accept or reject the excursion. A rejection may include a counter offer in some embodiments. Also, at 1812, the excursion provider can view the notification and respond accordingly through a provider view of a proposed excursion. In some embodiments, the response of a rejection or acceptance may be automated or done manually depending on setting of the implementation of the TMS. After the decision at 1812, the provider can send a notification to the host or customer and any other associated parties, via the TMS. At 1814a, when the provider has rejected the offer from the host, the device of the provider can send a notice accordingly. At this point, the host and the customer can select another provider to offer an excursion. At 1814b, when the provider has accepted the offer from the host for an excursion, the device of the provider can send a notice accordingly. At 1814c, when provider has determined a counter offer, the device of the provider can send a notice accordingly. At this point, the host can update the excursion accordingly or create a new excursion with a different provider or the same provider (which can be a counter offer to the provider's counter offer).

At 1816, if accepted, the excursion is scheduled in the TMS according to the information entered on creation of the excursion. Also, at 1818, if not accepted, the excursion is left as un-scheduled until canceled or an agreement is reached between the host and the provider. The TMS records and sends a copy of a corresponding invoice upon acceptance of the excursion to the provider, host, or the guest, which is received by the provider, host, or customer at 1820. The invoice can be sent from the TMS periodically, such as monthly, with other excursion invoices or other services invoices in general. The TMS can bill the host manually or automatically for the excursion fee, and the processing of the payment for the bill can be manual or automated as well depending on the settings of the implementation of the TMS. In most exemplary embodiments, a service fee may be billed by the host or the TMS for facilitating the booking.

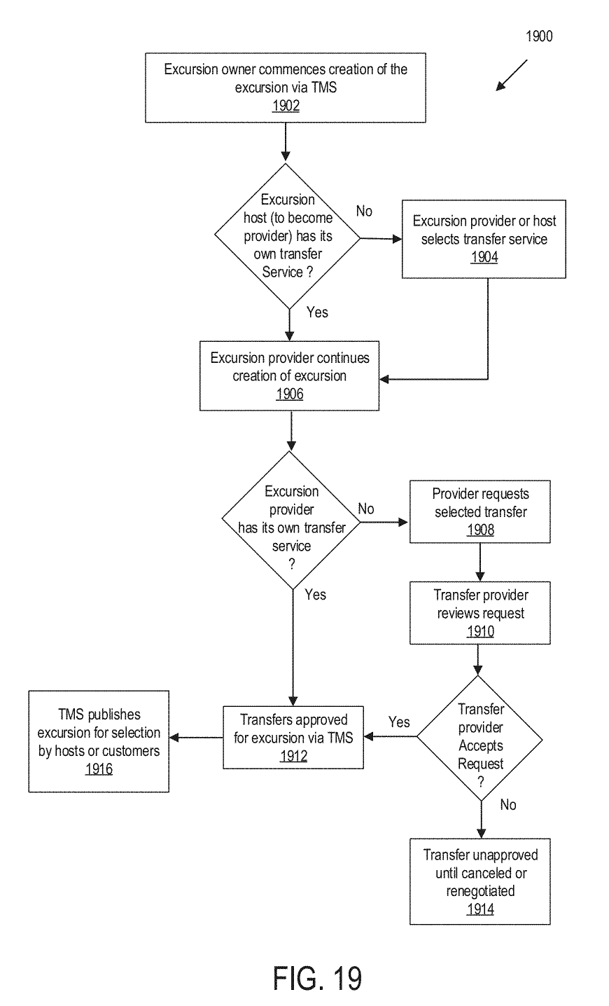

FIG. 19 illustrates additional exemplary operations 1900 performed by aspects of the TMS related to creation of excursions. Excursions can include multiple destinations. An excursion operator can create an excursion with information such as date, pickup locations, summary and description, pictures, how many seats are available, who the transportation provider is, and the like. With an excursion creation form, the owner can commence creation of the excursion at 1902.

In creation of the excursion, at 1904, the excursion provider (or host) selects a transfer provider for the excursion, unless the excursion provider provides its own transfers. Also, the excursion provider may provide transfers with certain hosts and not with others. The transfer providers can be listed as trusted providers that are considered trusted by the excursion provider or a host of the customer. In some embodiments, even the customer may have a selected list of trusted providers.

The excursion provider can continue to create the excursion once a transfer is determined at 1906. The continued creation of the excursion can include setting various costs and fees including provider costs, commissions, and the like (manually set or calculated by the system). Also, the TMS can generate a service fee for itself.

Upon entering the information at steps 1902-1906, a request for the transfer is made, such that the transfer provider can accept or reject the requested transfer for the excursion, at 1908.

At 1910, the transfer provider can view the notification and respond accordingly through a provider view of a proposed excursion. In some embodiments, the response of a rejection or acceptance may be automated or done manually depending on the settings of the implementation of the TMS. The TMS sends a notification to the host or customer, once a response is received by the TMS from the provider. At 1912, if accepted, transfers from the transfer provider are approved for that excursion in the TMS according to the information entered on creation of the excursion. At 1914, if not accepted, the excursion is left as un-approved until canceled or an agreement is reached between the excursion provider and the transfer provider.

Once the excursion is published at 1916 (upon acceptance by the transfer provider if the transfer provider is needed), hosts, customers, and even other providers can search for the excursion and book an instance of the excursion. Booking of the excursion can occur through operations 1800, for example. Excursions can also be advertised within TMS (as featured excursions), advertised publically on a website of the TMS, or advertised through 3rd parties such as ad networks and social media platforms. Publication at 1916 can include sending out messages via email, SMS text messaging or the like to other hosts, customers, and even other providers promoting the excursion. This can be done upon creation of the excursion or periodically, such as beginning with the creation of the excursion. Sending of promotions of any services including excursions or transfer options can be targeted according to logs of user interactions with the TMS, other booking systems, and other sources of information used by targeted advertising.

In some examples where sub-providers are used, such as transfer providers are used by an excursion provider, the TMS can record and send a copy of the invoice (from the sub-provider) to the provider, host, or the guest. Similarly, such an invoice can be sent from the TMS periodically, such as monthly, with other excursion invoices or other services invoices in general. The TMS can bill the host or the provider manually or automatically for the sub-provider fee, and the processing of the payment for the bill can be manual or automated as well depending on the settings of the implementation of the TMS.

In some embodiments, for providers viewing details of their own excursion, they do not see the pricing except for the provider cost. When an excursion is in pending status (waiting for provider approval), the TMS can provide an accept button that initiates accepting the excursion, a reject button that initiates rejecting the excursion, a popup dialog that asks for a required rejection reason, and a confirm button can be displayed as well. In such embodiments, other information is read-only for the provider. The provider may also be able to view the bookings of the excursion.

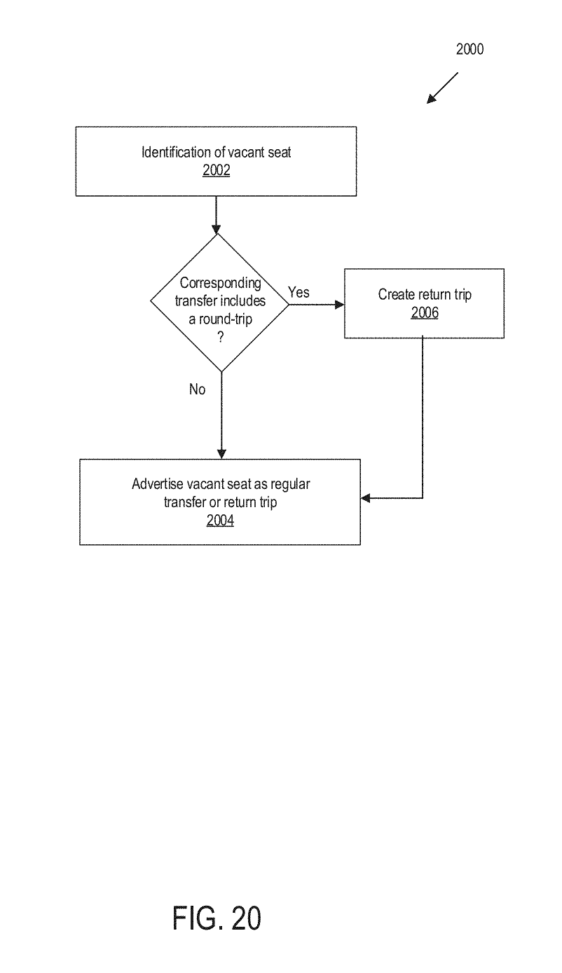

FIG. 20 illustrates exemplary operations 2000 performed by aspects of the TMS related to advertising of available seats for a transfer or excursion. These operations are especially useful for return trips, which can often include vacant seats. A provider of a transfer or excursion, for example, may have a vehicle traveling to a destination (booked within or outside of the TMS) to transfer passengers. At 2002, the TMS or the provider identifies a vacant seat for the already booked transfer. At 2004, the TMS or the provider, through the TMS, advertises that the transfer has an empty seat to be filled. This occurs often with return trips. For example, a transfer provider has five seats, and picks up five passengers from the airport to take them to their respective hotels. On the return trip back to the airport to pick up a second set of passengers, the seats can be filled with five new passengers needing rides to the airport. Depending on the time of day or for other reasons the return trips may not fill up as fast or consistently. For example, a mere three seats are filled for the return trip to the airport. At this point, the two empty seats are known ahead of time and can be advertised via the TMS.

To advertise a return trip vacancy, if the original transfer was created within TMS, the provider may access a feature to quickly create a return trip at 2006, listing the number of available seats, pickup location and known destinations. Once the return trip is published at 2004, hosts (e.g., hotels, travel agents, or a tourism office) can search for it and book. Vacancies and return trips can be advertised within TMS (as featured excursions), advertised publically on a website of the TMS, or advertised through 3rd parties such as ad networks and social media platforms.

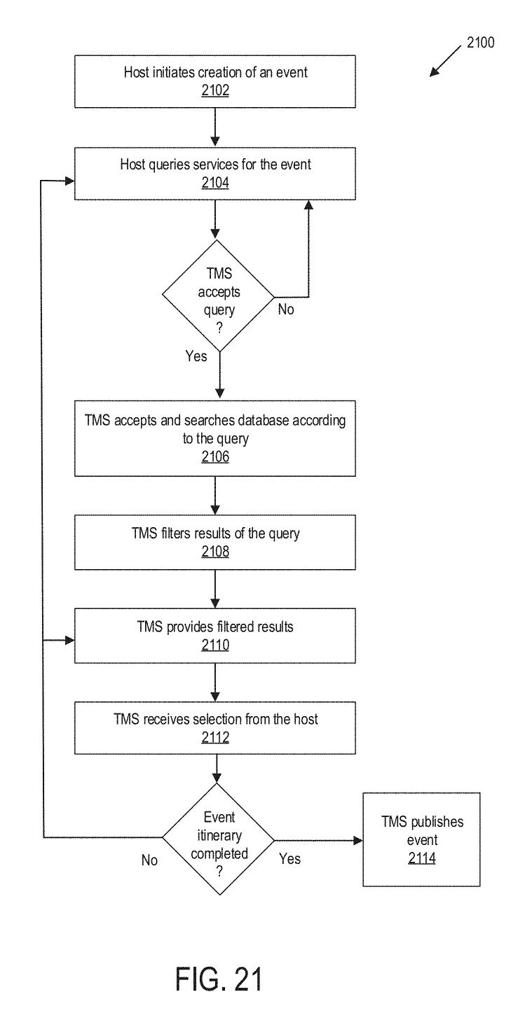

FIG. 21 illustrates exemplary operations 2100 performed by aspects of the TMS related to itinerary production by a host. For example, such operations may be beneficial when a business or government agency has visitors, and the organization attempts to coordinate their transfers, excursions, and other services. In such a case, the business or agency acts as a host. Also, for example, an institution, such as a university may be a host, such as for a recruiting event or a parents' weekend. For such events, it may be useful for the host to coordinate accommodations, most transfers, meal reservations and entertainment. In such cases, the providers used are trusted for quality of service. For example, public transportation may not be reliable enough for such events. Thus, the TMS, when listing options for bookings, may filter according to level of trust in the provider, reliability of the provider, or an object score related to the quality of service provided by the provider.

At 2102, a host initiates creation of an event. At 2104, the host in developing an event itinerary for its guests, can request a query for a service using keywords and certain filters, such as quality of service filters. At 2106, the TMS can accept the query and search its records accordingly for appropriate services and service providers. Besides using filters and keywords selected by the host, the TMS may further filter the search results with its own selected filters, at 2108. For example, the TMS can use geolocation techniques at 2108 to further filter the search results obtained at 2106. At 2110, the final results can be presented to a user interface by the TMS. At 2112, the TMS can receive a selection of one of the services listed to add to the itinerary, and add the item to the itinerary. Operations 2104-2112, can be repeated until the itinerary is complete for the host's event. Once the host's event itinerary is completed, it can be published to its customers by the TMS at 2114.

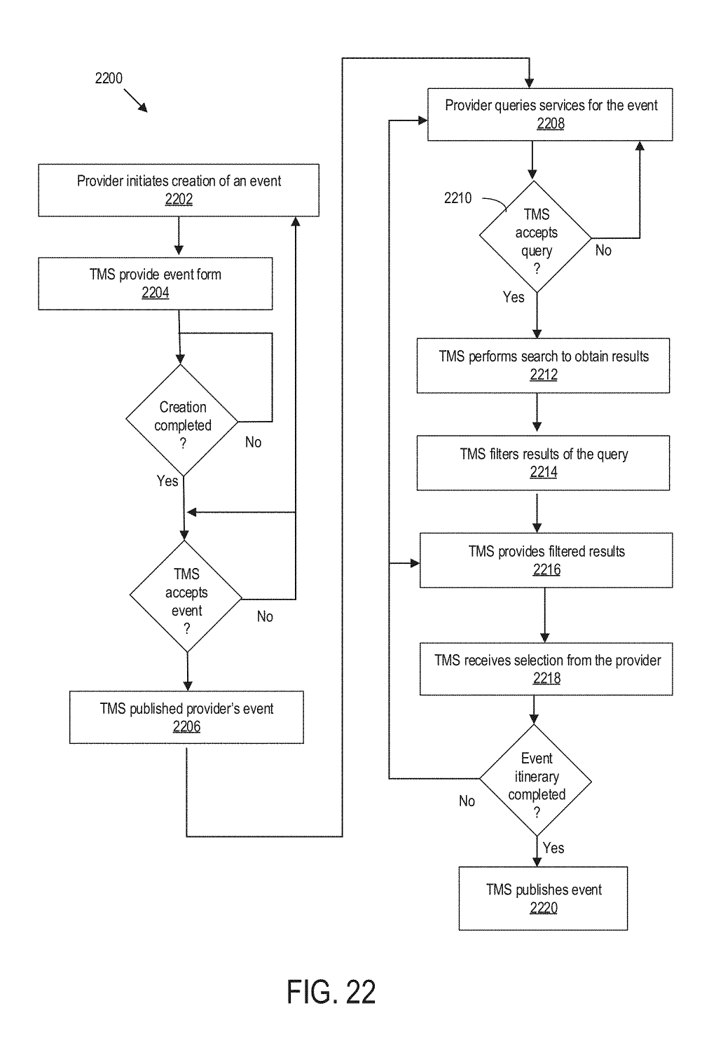

FIG. 22 illustrates exemplary operations 2200 performed by aspects of the TMS related to event planning by a provider. For example, such operations may be beneficial when a provider (such as an excursion provider or an event provider) coordinates its sub-providers (e.g., sub-contractors). For example, a convention event coordinator may employ several sub-providers for a convention. For example, separate food services, entertainment, and transfer providers may be employed. In such a case, the provider becomes analogous to a host and its sub-providers become analogous to providers for that host. Similar to the university example, which is an example of event planning by a host, it is essential that the sub-providers used are trusted for quality of service. For example, public transportation may not be reliable enough for such events. Thus, the TMS when listing options for bookings may filter according to level of trust in the sub-provider, reliability of the sub-provider, or an object score related to the quality of service provided by the sub-provider.

In some instances, the provider may be an event venue. The host may be the event planner needing to use an event venue. The venue provider, via the TMS can accept or reject a requested event according to available space at the venue. The event owner, or the event provider, may have costs having fees for coordinating an event, which can be recorded and billed by the TMS. The TMS can also charge a service fee for event management. Also, the event provider sets various costs and fees including base ticket cost, host commissions, and the like. For example, hosts providing accommodations to customers of an event linked to the event via the TMS may receive a commission from the event provider.

For example, once the event is published as approved, hosts (such as hotels, travel agents, or tourism offices) can search for an event and book a guest for the event. The guest may pay the booking host through the TMS or another system. The event provider is paid by the host via the TMS, and the event venue (or sub-provider) is paid by the event provider, accordingly, via the TMS. Alternatively, in a business-to-consumer model the TMS can directly facilitate the booking of events with the customer, bypassing the host all together.

An event planner type provider may include a sports team or sports arena facility operator. In this sense the sports team or arena may be considered a host as well. This type of provider or host may request transfer providers to provide transfers for its customers, similar to a host. In this case, the sporting event attendees may be the customers. Via the TMS, the sporting event provider may provide ticket reservation for the event, and upon reservation offer parking and transfer services to customers directly (which may be a business-to-consumer model). Via the TMS as well, the customer provides the necessary information to book a transfer or parking and pays the event provider. The event provider then pays the sub-providers (the parking or transfer provider) via the TMS. This can be done manually or automatically as provided herein.

Events may also be advertised within TMS as featured events, advertised publically on a website of the TMS, or advertised through 3rd parties such as ad networks and social media platforms. It may be noted that events are essentially a category of excursions and inherit the functionality of the TMS available to excursions.

At 2202, a provider of an event initiates creation of an event. The creation of the event includes the TMS providing a form to the provider to enter the details of the event, at 2204. Event information that can be added including scheduling information that includes times and dates, locations, summaries and detailed descriptions of parts of the event, images and videos, available number of tickets or seats for an event, and the like. Upon creation of the event, it is approved for publication by the TMS at 2206.

At 2208, upon publication, the event provider in developing an event itinerary for its guests, can request a query for a service using keywords and certain filters, such as quality of service filters. At 2210, the TMS can accept the query and search (at 2212) its records accordingly for appropriate sub-services and sub-providers. Besides using filters and keywords selected by the provider, the TMS may further filter the search results with its own selected filters, at 2214. For example, the TMS can use geolocation techniques at 2214 to further filter the search results obtained at 2212. At 2216, the final results can be presented to a user interface by the TMS. At 2218, the TMS can receive a selection of one of the sub-services listed to add to the itinerary, and add the item to the itinerary. Operations 2208-2218 can be repeated until the itinerary is complete for the provider event. Once the provider's event itinerary is completed, it can be published to hosts and customers by the TMS at 2220.

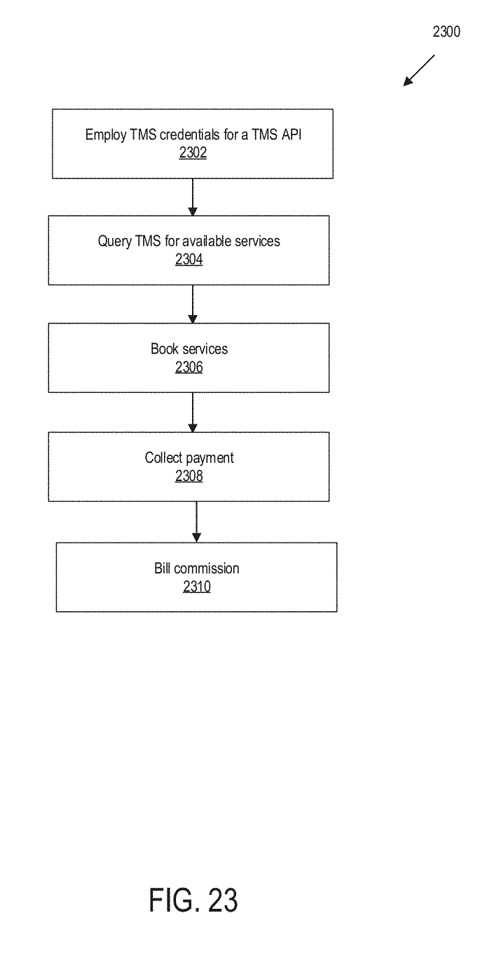

FIG. 23 illustrates exemplary operations 2300 performed by aspects of the TMS related to merging of host and provider systems with the TMS. For example, a company who builds hotel room booking software or flight booking software (such as in the form of a booking website) can add support for booking value-added services through partner businesses, such as transfer and excursion businesses. This may cause such software when implemented in e-commerce streams to earn additional revenue via additional commissions. Also, by adding additional booking services, the software or website increases in value to the consumer.

To integrate the TMS with such software or websites external to the TMS, first TMS credentials for a TMS API can be employed by the external software to communicate with the API at 2302. Having access to libraries of the TMS, the other booking software can query data within the TMS system for available services, at 2304, such as services proximate to booked hotels or relevant airports. Once queried, booking of the services can occur via embedded TMS components in the booking software at 2306. One interface that can be used for exchanges with the TMS components can include a REST API. Alternatives to a REST API may be used as well. At 2308, the booking software can collect payment from the customer, and the provider of the exchange with TMS can be paid by the booking software, via the billing circuitry of the TMS. Via the TMS, the TMS can also bill for the host so the host can receive its commission at 2310.

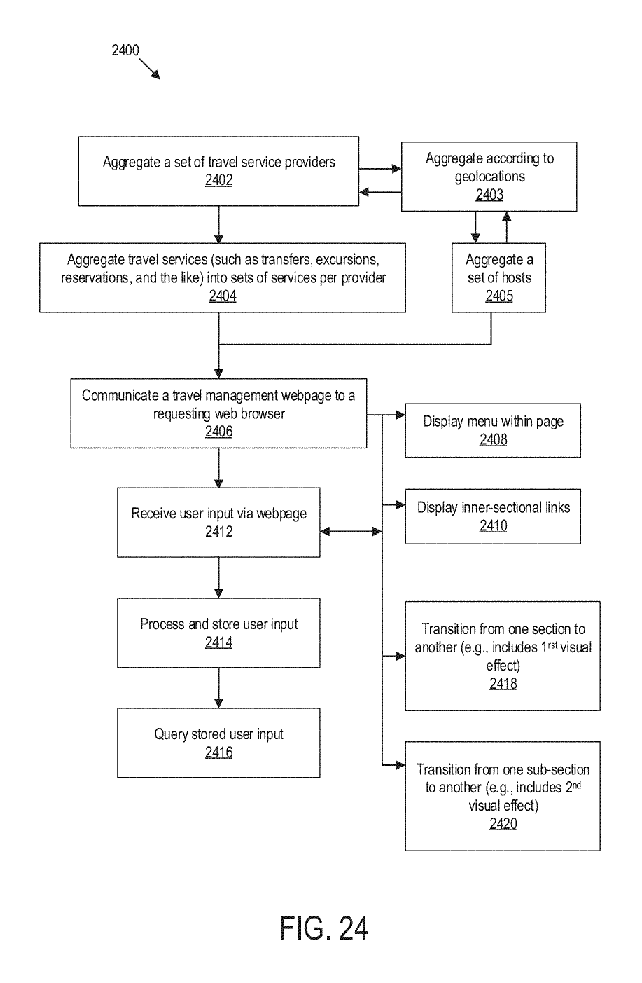

FIG. 24 illustrates additional or alternative exemplary operations 2400 performed by aspects of the TMS. The operations 2400 can include aggregating a set of travel service providers at 2402. In some exemplary embodiments, the operations 2400 can include aggregating the set of providers according to geolocation results within a certain distance from a selected point, at 2403. The operations can also include aggregating travel services (such as transfers, excursions, reservations, and the like) into sets of services per provider at 2404. They can also include communicating a travel management webpage to a requesting web browser (which may include the pages and GUIs described herein) at 2406. In such an embodiment, the webpage at least includes separate sections that display provider information, services information, billing information, or a combination thereof. The provider information can include at least part of the set of providers, and the services information can include at least one of the sets of services.

The operations 2400 can also include displaying a menu within the webpage at 2408. The menu can include menu items that are selectable to display a respective section within the webpage. At 2410, the operations can include displaying inner-sectional links within the sections and external to the menu. An inner-sectional link can be selectable within a given section to navigate from a first subsection to a second subsection within the section

The operations 2400 can also include receiving, by the webpage, user input related to the provider information, the services information, or the billing information at 2412. They can also include processing and storing the user input by backend circuitry of the system at 2414. Alternatively or additionally, at least some of the processing can be done by middle-layer circuitry. The operations can also include querying the stored user input according to an initiation of a query by the webpage at 2416.

In some other examples, the operations 2400 can include aggregating a set of hosts at 2405, and the webpage includes a separate section displaying host information. The host information includes at least part of the set of hosts. In such examples, the operations may also include receiving, by the webpage, user input related to the host information at 2412, and processing and storing the user input related to the host information by the backend circuitry at 2414. In the aforementioned examples, the operations can include aggregating the set of hosts according to geolocation results within a certain distance from a selected point at 2403.

In some examples of the operations 2400 where the services are transfers, the operations can include aggregating transfers into sets of transfers per provider at 2404. In such examples, the webpage can include separate sections displaying transfer information, and the transfer information can include at least part of the set of transfers. The operations also include receiving, by the webpage, user input related to the transfer information at 2412, and processing and storing the user input related to the transfer information by the backend circuitry at 2414. Likewise, in some examples of the operations 2400 where the services are excursions, the operations can include aggregating excursions into sets of excursions per provider at 2404. In such examples, the webpage can include separate sections displaying excursion information. The excursion information can include at least part of the set of excursions. These example operations can also include receiving, by the webpage, user input related to the excursion information at 2412, and processing and storing the user input related to the excursion information by the backend circuitry 2414.

In some examples of the operations 2400, the services can include transfers and excursions. In such examples, the operations include aggregating transfers and excursions separately into sets of transfers and sets of excursions per provider and per host. The webpage includes separate sections displaying transfer information and excursion information. The transfer information includes at least part of the set of transfers. The excursion information includes at least part of the set of excursions. Such examples of operations can also include receiving, by the webpage, user input related to the transfer information or the excursion information, and processing and storing the user input related to the transfer information or the excursion information by the backend circuitry.

The operations 2400 can also include transitioning from one section of the webpage to another at 2418. For example, the transitioning can include transitioning from an excursion section of the webpage to a transfer section, and vice versa. In such examples, a transition from one section to another section, caused by a selection of one of the menu items, includes a first visual effect. The operations 2400 can also include transitioning from a first sub-section to a second sub-section within one of the sections at 2420, which can be caused by a selection of one of the inner-sectional links, and the transition includes a second visual effect. In some embodiments, the second visual effect can include the first sub-section sliding over the second sub-section and out of the screen, or the second sub-section sliding over the first sub-section and into the screen. Also, in such examples the second visual effect is different from the first visual effect. Conversely, in alternative examples, the aforementioned second visual effect can occur for transitions between the sections opposed to transitions between the sub-sections.

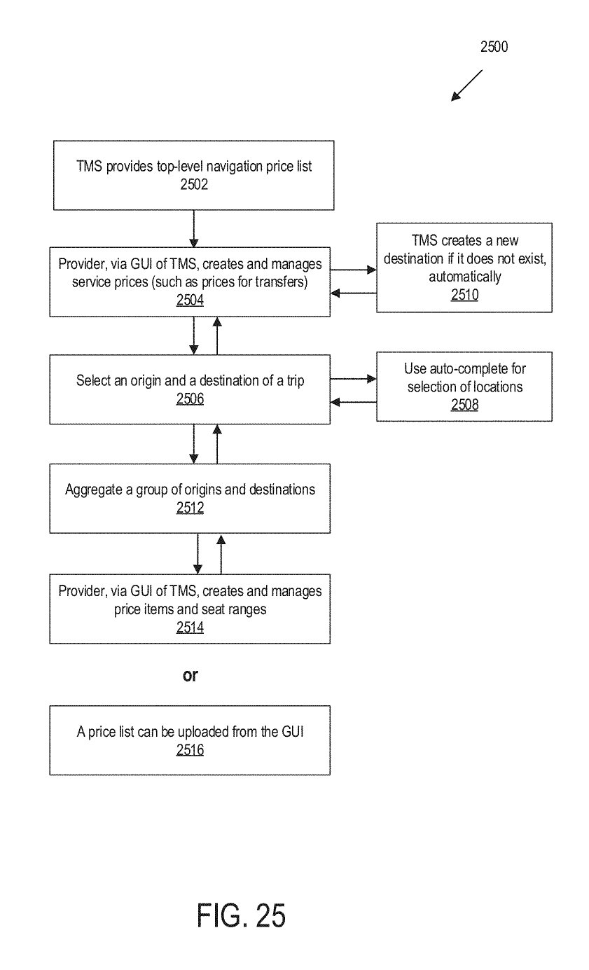

FIG. 25 illustrates exemplary operations 2500 performed by aspects of the TMS related to pricing of services. At 2502, the TMS, via a GUI, provides travel service providers with a top-level navigation price list to manage prices for different trips. At 2504, a provider's users can create and manage prices. In other words, they can create, modify and delete prices per trip and for a range of seats. The parameters for pricing can include the origin of the trip, destinations 1 . . . n, seats 1−a (price for adults or children), seats a+1−b (price for adults or children), seats b+1−c (price for adults or children), and so on. In most exemplary embodiments, pricing is based on a one-way trip, not a round trip.

At 2506, a user of the provider can select an origin and a destination of a trip. In some embodiments, multiple origins and destinations can be selected. At 2508, using an auto-complete search box for destinations (e.g., the origin and one or more destinations), the user retrieves at least one search result from a maps application using an API of the maps application. The retrieval may include an autocomplete function. In such examples, the TMS can receive a place ID and use reverse geocoding by place ID to retrieve the place information from the maps application (such as through the API). Subsequently, the TMS can populate the destination fields in the GUI. The destination fields can include: location name, address, city, zip code, region (such as state or province), and country.

At 2510, the TMS creates a new destination if it does not exist. The TMS can use a place ID from the map application as a key for the new destination. If it exists and is different, a new one can be created and the old one is disabled. In some embodiments, the key is stored by the TMS so that it can be referenced and visible in the pricing of other items.

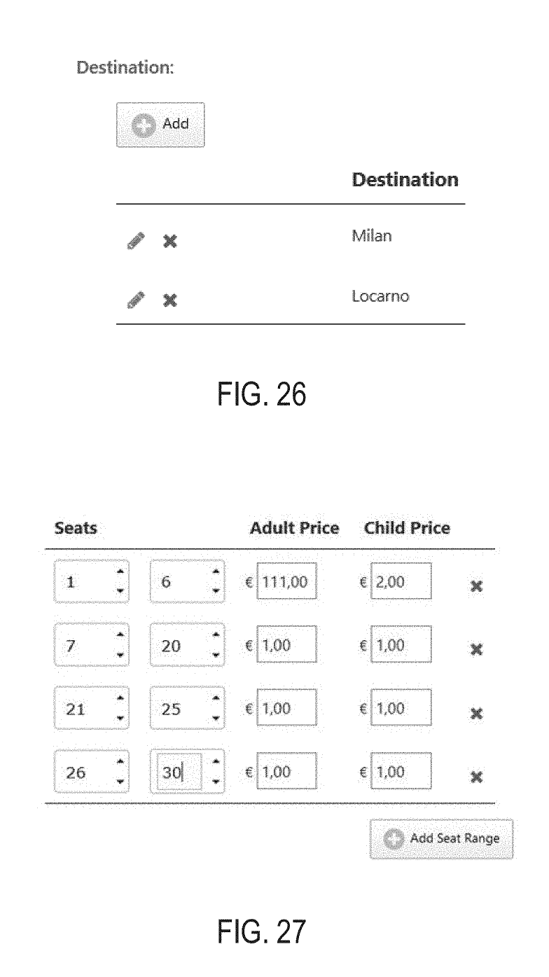

At 2512, the user can aggregate a group of destinations if there are multiple destinations in the trip. E.g., see FIG. 26, which illustrates GUI elements for selecting multiple destinations.

At 2514, the user can create or manage price items and seat ranges for transfers and excursions. For example, a price list can include ranges of seats similar to: Seats 1-3, Seats 4-8, Seats 9-15, Seats 16-90. In some instances, no upper limit can be designated. FIG. 27 depicts GUI elements for creating or managing price items and seat ranges. FIG. 27 shows that each range of seats can be changed using up or down arrows. The TMS can automatically adjust the seat ranges to prevent overlaps and gaps. E.g. when increasing the range 1-3 to 1-4 then the next higher range may become 5-8. This runs recursively to higher ranges as well. When decreasing the upper boundary, the next range may decrease its lower boundary to prevent gaps. Also, range items can be added at the bottom or deleted automatically filling the gaps from the lower range. Added items' seat range starts with n+1 with n being the given highest used number of seats. The last range cannot be deleted. The first range can start at a preset number (e.g., usually one). Each range of seats is shown to be associated with a separate price for adults and children.

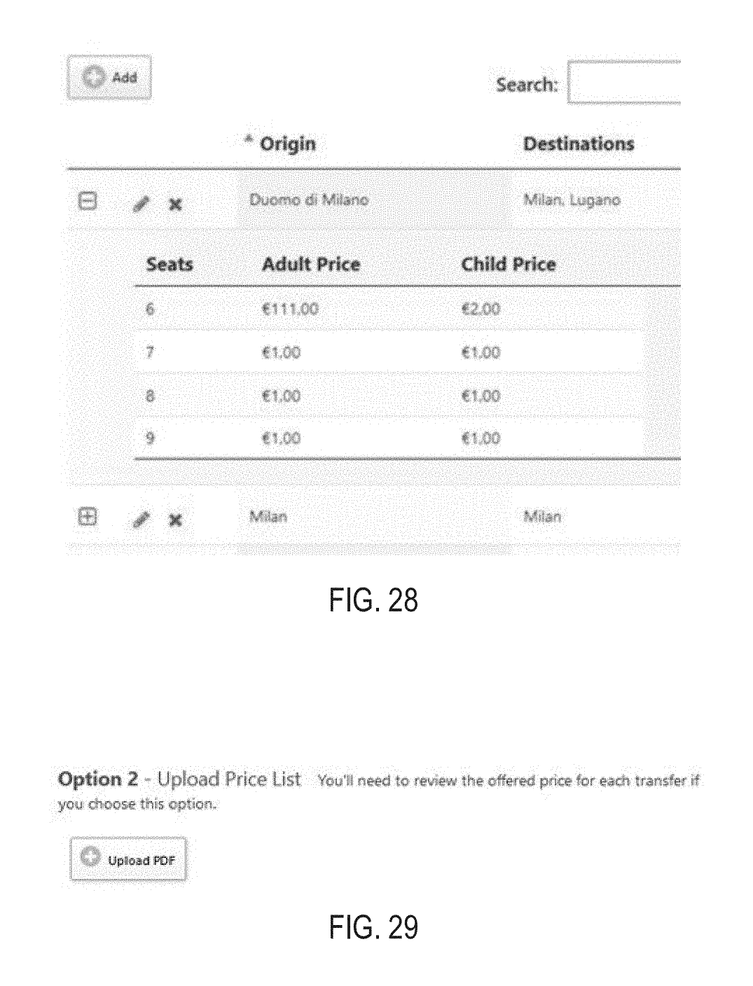

In some embodiments, the GUI can display multiple trips and each graphical indication of a trip can be expandable and collapsible to show pricing details. E.g., see FIG. 28. The graphical indication of a trip can include origin and destination names, as shown in FIG. 28. In FIG. 28, each trip is designated by a row. Also shown, a collapsible table can be used to show the seat ranges with prices for adults and children. In such a GUI, price items can be listed sorted by trip (e.g., origin then destination). Sorting can be changed (e.g., ascending or descending). The paging features can be provided for large numbers of price lists. For example, if a threshold number of trips are listed for a provider, the collapsible and expandable table may be provided. Otherwise, a list with pricing may be provided without such a feature.

The prices set in operations 2500 can be searched using a search field (e.g., by searching origin and destination names or addresses).

At 2516, a price list can be uploaded from the GUI. E.g., see FIG. 29. For example, if the provider has an existing price list (PDF), they can upload that price list instead of defining the prices in TMS item by item. In some simplified examples of such instances, to save resources of the TMS, the TMS may not calculate prices for transfers automatically and the host enters the price form taken from the uploaded price list manually. This depends on the sophistication of the implementation of the TMS versus the use of processing resources of the TMS.

Additionally, in some exemplary embodiments, a provider can set custom prices per host, instead of using a default price list for hosts. This provides for customized agreements and discounts for specific hosts.

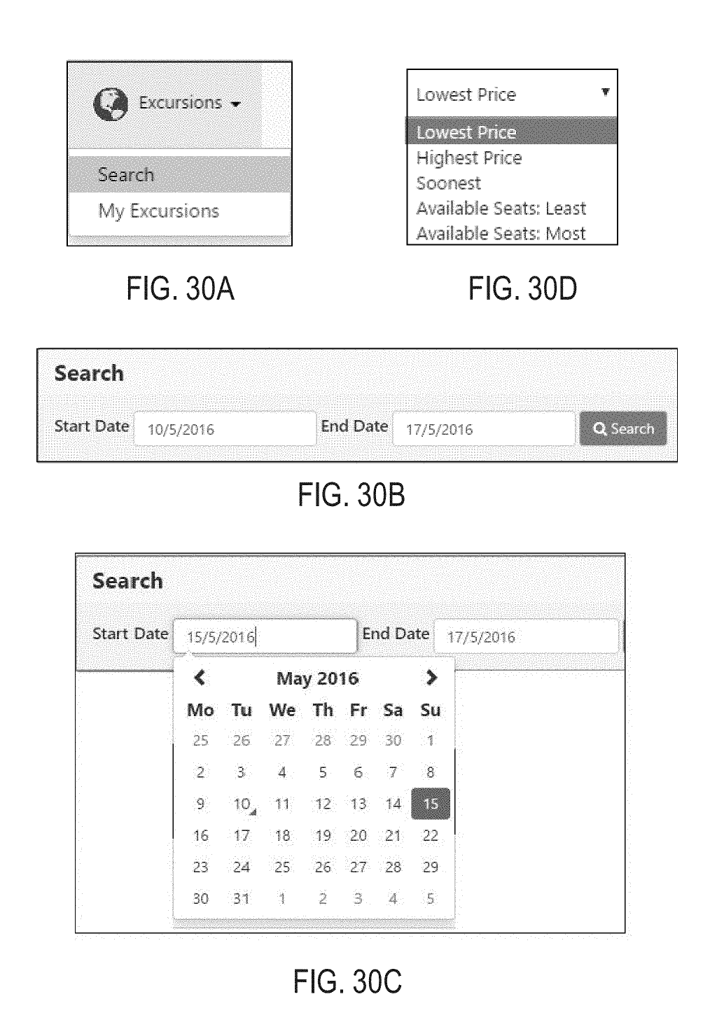

### Detailed Description—Description of Further Exemplary Embodiments Related to Excursions and FIGS. 30A-34

With respect to embodiments specific to excursions, hosts may include travel agents, tour operators, cruises, and hotels, just to name a few. Registration of travel agents can be similar to other host registration processes of the TMS. In an exemplary embodiment, a registration webpage can include a quick link for registering travel agents, as well as accommodations, tour operators, event companies, and excursion providers. Any of which may be considered hosts.

Similarly, host registration for embodiments with excursions includes multi-stage self-registration. The host self-registration can be split up into four different screens: Your information (e.g., primary user's name and CAPTCHA), Company information (name, VAT, street address, billing information, CAPTCHA, legal agreement—same as host), Confirmation and Email validation page, and PSP registration. During registration under these embodiments and others, the TMS can include indicators of the stage of the registration (such as at a top of a registration page).

For hosts, the profile, settings and the payment methods page can be opened through an admin menu, and through the menu users can be added, deleted and modified by host administrators. This is similar to how it is done in the transfers sections of the TMS. Also, profiles of other types of hosts besides accommodations, like travel agents, can have similar profile fields as accommodations with additional fields particular to their interests. For the most part, profile creation and updates, payment methods, and creations and removal of users for hosts in some embodiments with excursions can be similar to embodiments with transfers. In general, creation of excursions can be similar to creation of transfers. Also, excursions can include transfers.

In some exemplary embodiments, two top-level menu items “Excursions” and “My Excursions” can be included to GUIs of the TMS for hosts. Similar menu items can be included for embodiments with transfers as well (such as “Transfers” and “My Transfers”). In an exemplary embodiment, if both options are available to the user, a single top-level dropdown menu can be used with sub items of “Search” and “My Excursions”. E.g., see FIG. 30A.

Host roles can create an excursion from the My Excursions screen. A “Create Excursion” button is available on this screen. Excursions are inherently roundtrip with a pick-up or drop-off location (same location), unless otherwise specified by the TMS. By default, the system can solely present this as “Pickup Location”, unless the excursion does not include a roundtrip transfer.

In such embodiments, providers can accept or reject an excursion explicitly. Also, auto-rejections can occur if appropriate parties do not respond within a pre-defined time period. Accepts or rejects can be notified to the excursion owner by email.

A host who can also be the provider. The host, by checking TIN or VAT, may not accept their own excursions. The TMS sends email notifications to the transportation provider for upcoming excursions and when an excursion is cancelled. The TMS sends email notifications to the guest for upcoming excursions, or if the excursion or booking is cancelled. In one exemplary embodiment, multiple pickup or drop-off locations can be defined, each with a different time for pickup and drop-off.

In creation of excursions, a host, such as a travel agency, creates an excursion. A provider can view certain details of excursions related to their services. In most exemplary embodiment, excursions pickup and drop offs are similar to enter as in modules for transfers.

In most exemplary embodiments, similar features between excursions modules, transfer modules, and modules for other types of travel services are modularized, so common libraries of instructions can be used between modules. In an exemplary embodiment, the object or class travel services can be a parent object or class of transfers, excursions, events, and the like.

Referring back to pick up and drop off of excursions, excursions can start with a predefined route with fixed pick up locations. As seats are booked, the host can select the predefined pickup location the guest can use. Once the booking is complete, the system determines the final list of pick up locations. Notification of finalized locations and times may be sent to the excursion owner, providers and booking hosts.

Excursion information may differ from transfer information and information for other types of travel services. For example, excursion information may uniquely include the combination of the following fields:

Excursion Name: a name used to identify the excursion;

Excursion Date: date and time that excursion pickup can occur;

Booking Start Date: date and time when bookings by hosts are permitted to start;

Booking End Date: date and time when bookings by hosts must be completed by;

Excursion Summary: a brief description of the excursion; and

Excursion Description: a longer narrative about the excursion.

In some embodiments, the TMS can provide a rich text editor component to provide text formatting excursion information (and as well as information for other associated or related services).

Excursion information may also include an attachment and button to upload a document (PDF or image) that describes the excursion in more detail (e.g., a brochure). Brochures may be dragged and dropped to user device's desktop, folders, and the like for ease of downloading. Conversely, similar functionality may be available for hosts to upload brochures and the like to the TMS.

Excursion information can be editable for owners, and viewable for other users of the TMS. The information pages may also include a field to upload a photo associated with an excursion destination. Also, legal forms and other documents and any other types of uploadable items used by travel services can be retrieved through such fields. Also, the fields may include: Transportation Provider, which includes trusted providers. They may be visible in a dropdown menu. Excursion information may further include the following fields: provider cost, host commission, guest price, minimum number of people (or seats) to run the excursion, maximum number of people (or seats) allowed, alternate contact information, if different from owner's main contact information.

In most exemplary embodiments, for providers viewing details of the excursion (e.g., when they are the provider of the excursion) they do not see the pricing except for the provider cost. When an excursion is in pending status (e.g., waiting for provider approval), an accept button initiates accepting the excursion, a reject button initiates rejecting the excursion, a popup dialog asks for a required rejection reason, and a confirm button is displayed for selecting confirmation of the rejection or acceptance. All other information may be read-only. Also, providers can view the bookings of the excursion at this point.

The excursion pricing may include the following items (some of which are hidden from view and others are displayed in GUIs of the TMS):

Provider (Transfer) Cost: This is the amount the excursion owner can pay the provider per seat (including VAT). This is simply the base excursion price the Excursion fee is based on.

Excursion Fee: This reflects the amount the excursion owner considers appropriate to cover excursion costs plus their profit margin. It is not a markup over the provider cost since an excursion may include a tour guide, food, tickets and more. It is set to zero or left blank initially, but can be modified.

Excursion tax % (which can be hidden from view): is the fixed VAT tax (e.g., 10% for Italy, and configurable per country).

Host Commission: is the fixed amount as dollar amount and not a percentage that the host earns as a commission for booking the excursion.

TMS Fee % (which can be hidden from view): is the fixed TMS fee constant for excursion owners and excursions but is configurable per country--minimum amount is one euro for example.

TMS Tax % (which can be hidden from view): is the fixed VAT tax (e.g., 10% for Italy, and configurable per country).

Guest Price (per person): the amount the host and guest can see for a seat on the excursion. In some locations, per laws, the price cannot vary between guests (e.g., hosts cannot charge different amounts). Such rules and others can be built into the logic of the TMS and its GUIs.

The excursion owner can set the provider cost, excursion fee, and host commission.

If the above costs are changed, the Guest Price is automatically computed based on the new provider cost, excursion fee, and host commission. In an exemplary embodiment, the TMS prohibits the costs and fees being a negative value. Costs and fees can be calculated and stored in the excursion at the time of creation or when updated.

One or more of the fields described herein can be mandatory. Also, descriptions of these fields that apply to transfers and other types of travel services, may also apply to the information of such services.

Other fields may include booking start date, which includes information on when users start to see or book the excursion (such as by using a date and time picker). The TMS can enforce that the start date is before the excursion date. The fields can also include booking an end date, which includes when booked excursions end. They need to stop ahead of excursion date in most embodiments (e.g., by using a date and time picker). The TMS also enforces that the end date is between the start date and the excursion date. In most examples, the end date is only a few days before the excursion date (e.g., pickup date).

A service, such as an excursion, or at least some of its fields, can be shared or published or restricted as private. For example, when the rights are tagged as private, only users of the excursion owner can book into the excursion in most embodiments. The excursion provider can also view, from My Excursions, if the status is private. When marked public, any host can view or book a guest into the excursion. The public rights choice is the default in most exemplary embodiments.

In some embodiments, excursions start with a predefined route with fixed pick up locations. As seats are booked, the host can select the predefined pickup location the guest can use. Once the booking is complete, the system determines the final list of pick up locations. The locations can have guests booked to use the services starting at the locations. Notification of finalized locations and times may be sent to an excursion owner, providers and booking hosts.

Excursions can have the following statuses: new (e.g., shown as “Not Published”), created but not open for bookings, pending (e.g., shown as “Waiting for Provider Approval”), owner submitted excursion for approval by provider, published, published for booking (but actual availability can depend on several factors), closed, explicitly closed after excursion availability has ended (e.g., TMS can use calculated status to determine if implicitly closed after booking end date, etc.), cancelled, cancelled by the excursion owner (e.g., twenty-four hour cancellation policy for excursions, or another configurable policy), and auto-cancelled by the TMS.

Excursions can also have explanations of statuses, which can include the following along with further clarifications: new (e.g., shown as “Not Published”), created but not accepted or published, pending (e.g., shown as “Waiting for Provider Approval”), owner submitted excursion for approval by provider, published, published but not open for booking, open, open for booking with availability, limited availability, less than n number of seats remaining (e.g., where n is configurable), at capacity, closed for booking due to maximum seats reached (e.g., which is temporary if the owner adds additional seats), closing soon, closing within n hours of end date (e.g., where n is configurable), closed, closed for booking (e.g., due to the end date being passed), cancelled, cancelled by the excursion owner (e.g., twenty-four hour cancellation policy for excursions, or another configurable policy), and auto-cancelled by the TMS.

For an excursion having a new status, owner can edit any fields of the excursion, and the provider cannot see the excursion. In most embodiments, for an excursion to switch from new to pending, all required fields must be completed on the excursion, and the owner selects approval through a GUI of the TMS (e.g., clicks a button such as “Submit for Provider Approval”). When finally approved by the owner, the excursion status changes to pending, and the provider status moves to pending too in most examples. A notification of the pending excursion can be sent to the provider instantaneously or afterwards.

For an excursion in pending status, the owner can view any fields. The owner can only edit specific fields in most exemplary embodiments, such as minimum seats and maximum seats. Also, the owner can cancel the excursion. A provider (e.g., related to the excursion or requested by the owner) can search out and view the excursion once pending via a GUI of the TMS. E.g., See FIGS. 30A-30D. Also, the provider can accept or reject the excursion, or send a counter offer to the owner through the TMS or directly.

For an excursion to switch from pending to new, the provider has rejected the excursion, or the system auto-rejected it due to the provider not responding within the configured time period, for example.

In most embodiments, for an excursion to switch from pending to published, the provider has accepted the excursion. For an excursion in published status, a related host or requested host can search and view the excursion based on sharing rights. If the sharing rights are completely open to the public than any host can view or search on the excursion. Also, whether public or private, the provider of the excursion can search and view the excursion. Excursions can be listed after a search. Such a list can show dates when bookings can occur and the name and a description of the excursion.

For an excursion to switch from published to open, a date and time must be between booking start and end date in most examples. For an excursion in open status, hosts can book customers into the excursion based on sharing rights. The provider of the excursion may continue to search and view the excursion.

For an excursion to switch from open to limited availability, the number of seats left is less than X (e.g., where X is configurable). Excursions can go directly to limited availability if the remaining seats is less than X or Y % of maximum seats (e.g., where Y % is configurable). For an excursion in a limited availability status, the excursion list search results can show a number of seats available for the excursion (e.g., it may display “X seats remaining”). Additionally, if criteria for closing soon status is met (e.g., a threshold amount of hours or days remaining to book), the excursion list search results can also show when booking is closing (e.g., it may display “Closing in X days, Z hours”).

For an excursion to switch from open to at capacity, all seats have been booked. For an excursion in the status of at capacity, the excursion list search results can show that no seats are available. For an excursion to switch from open to closing soon, hours remaining is less than X (e.g., where X is configurable). Also, limited availability criteria are not met (e.g., higher precedence that showing that the booking is closing soon).

In some embodiments, multiple statuses can be shown at once. For an excursion closing soon, the excursion list search results can show day or time of closing, or the like. For an excursion to switch from at capacity to open, the excursion owner must increase the maximum number of seats when previously all seats had been booked, in most examples. For an excursion to switch from published or open to closed, the current date and time is past booking end date and time in most embodiments.

Each excursion can have an excursion transaction number in the TMS. The TMS can generate a unique transaction number for each excursion. The same can be done for transfers and other travel services as well. The excursion transaction number can be a unique identifier for communication between hosts, customers, providers, and the TMS. In most exemplary embodiments, the transaction number can include one or more of the following parameters:

a type of service code, e.g., Type code (E);

a country code, e.g., char country code (US, IT, etc.);

a year code, e.g., two-character year code (“15” for 2015);

a day of year code, e.g., three-character day of year; and

an additional alpha-numeric code, e.g., two-character alpha (sequential, wrap-around like AA to ZZ) or four character padded numeric (sequential, wrap-around like 0000 to 9999)

An example, of the transaction number may look like “EIT15365AA9999”. The transaction number can be visible in the excursion list search results and excursion details pages.

The accept and reject mechanisms for excursions can be similar to transfers and other travel services booked through the TMS. A provider may accept or reject the excursion details to confirm they can provide the excursion pickups, etc.

An excursion can have the following provider statuses: none, not submitted to the provider, pending, submitted to the provider but not acknowledged, accepted, accepted by the provider, rejected, rejected by the provider or auto-rejected by the TMS. In some embodiments, rejected and auto-rejected is a TMS internal distinction, not visible to the users. In some examples, if the provider does not accept within n hours (n being configurable), the excursion can automatically be rejected. Notifications then can be sent to the excursion owners by the TMS.

Hosts and even customers in some instances can configure the auto-reject time frame in the settings. When a provider rejects an excursion, they must provide a reason for a rejection (such as via simple text field in a TMS GUI) which can be displayed to the excursion owner in most examples. The rejection reason can also show in the excursion details page as long as it is not re-assigned to a different provider. Rejected excursions can be updated or re-assigned to a new provider by the excursion owner or the excursion might be auto-cancelled by the TMS. If the host is also the provider, the TMS can auto-accept the excursion when the owner is ready. Also, the host can cancel its provider request if not accepted or rejected already. In such an instance, the excursion switches back to new status, and it is possible to change providers. In some examples of the TMS, the owner can request another provider while the excursion is pending, so that multiple bids can be made or a bid can be received from multiple parties or so multiple parties have the opportunity to bid. Many of these features can be automated with configurable thresholds, configurable by the owner of an excursion or an administrator of the TMS.

The owner of an excursion can also modify an excursion. In some exemplary embodiments, many excursion details can be modified only in the new status. In such embodiments, during a new status (e.g., when there are no bookings for an excursion), fields can be modified. Also, in some embodiments, once the excursion is in the pending status, only the following fields can be changed by the owner:

Minimum number of people;

Maximum number of people; and

Published Status with booked seats, which can include the number of minimum and maximum seats that can be modified by the owner (e.g., which can be increased or decreased but not below the number of already booked seats).

To prevent duplicates, if an excursion booking exists (or transfer booking or booking of any other travel service exists), duplicate bookings can automatically be cancelled. In such instances, the TMS can notify the provider, host, and customer. The system can prevent a price item or other type of item of excursion information (or any other type of information of the TMS) from being saved if there are duplicates. Existing price items with a same origin and at least one common destination and at least one price for the same number of seats, may be considered duplicates, for example. For instance, Catania to Acireale and Messina, 1-4 seats, overlaps Catania to Messina, 4-10 seats. And, Catania to Acireale and Messina, 1-4 seats, does not overlap Catania to Acireale, 20-30 seats. The sophistication of duplicates checking by the TMS depends on the implementation of the TMS. The administrator of the TMS can set a default duplication process, or customize a duplication process for handling duplications of items in the system.

Also, the owner of an excursion can cancel an excursion in new, published or closed status if it is before the cancellation setting time frame (e.g., configurable by the TMS or the owner). If an excursion in published status is cancelled, booking hosts and guests are informed about the cancellation. When an excursion is cancelled, the cancelling person needs to provide a reason that can be communicated to the involved parties. TMS can automatically cancel an excursion if it is closed and the minimum number of people is not met, depending on its configuration. In some instances, the TMS automatically cancels an excursion if it is closed and the provider has rejected the excursion and no new provider has been selected prior to the closing date. In most embodiments, the excursion owner is notified by email about the cancellation.

In an exemplary embodiment, for excursions in new status, the TMS can permit the owner to delete the excursion. In such an example, for excursions in pending status, the TMS can permit the owner to cancel the excursion. Also, for excursions that were created n days ago (e.g., n being configurable by the TMS), but are still in the new status, the TMS can notify the owner (e.g., a reminder to finish publishing the service or delete it). Such a notification and others of the TMS can occur one or more times, depending on system and user configurations and preferences.

Regarding notifications, cancelled excursions can trigger a notification to the provider, booking hosts, and guests. The owner may not be notified or may receive a confirmation depending on the implementation of the TMS and preferences of the owner. The TMS may send an email notification to the provider of upcoming excursions (which is similar for other bookable travel services such as transfers). Such a notification may include bookings and customers for an excursion. The bookings and customers can be grouped by pickup location in some examples. Such as notification can be separate from an associated transfer notification. The TMS can use email (or other type of electronic communication) to send notifications to the customer regarding upcoming excursions (or other service) X days beforehand. X being configurable, and there can be a default value for X. TMS can send a notification to the excursion owner X hours (X being configurable) before the booking closing or end date if the minimum number of people are not met. The notifications can be resent every n hours until the closing or end date (n being configurable). Also, the TMS can send a notification to the excursion owner if the excursion is within X seats of being full (X being configurable). The notification can be resent periodically (such as daily) until the closing or end date.

As mention, the TMS may provide a list of excursions to host customers via a GUI. The GUI may include two top-level menu items “Excursions” and “My Excursions”. If both options are available to the user, a single top-level dropdown menu can be used with sub items of “Search” and “My Excursions”. E.g., see FIG. 30A. The “My Excursions” menu item added for providers. Depending on the share rights (e.g., private, public, etc.) excursions can be seen by the different users. If an excursion is private, only the owner and provider of an excursion can see it in most embodiments.

Excursions can be searched by multiple properties of the excursion. A user, can enter values for the following search parameters that can filter a search for excursions. The parameters can include Start Date, End Date, or Advanced Search Options. E.g., see FIGS. 30B and 30C. The advance search options can include:

Excursion Name;

Excursion Number;

Description;

Provider Name;

Location of pickup;

Available Seats; and

Price Range.

The list of excursions can be sorted by several properties, such as Lowest Price, Highest Price, Soonest (from time of search), Available Seats (least), and Available Seats (most). The sort can be facilitated by a dropdown box listing parameters. E.g., see FIG. 30D.

The excursions listed can also vary based on search criteria, current status, etc. which is detailed below. Excursions can be opened to see excursion details provided by the TMS. For a single excursion, the TMS can show information on: Excursion date, Excursion short description, and Guest Price. Also, the TMS can provide via the GUI messages about booking dates and seats, such as how many days left to book and how many seats left to book.

Also, an excursion owner can pay extra to list an excursion as “Featured” so it sorts to the top of the lists and gets more notice. Also, the TMS can display excursions available on a public web page, but make people sign up to actually book it.

From the list of excursions on the GUI, a “Book Now” button can be used to book seats on a selected excursion. Alternatively, from the Excursion Detail page, a “Book Now” button can be displayed too, after the excursion is selected from the list and the user is directed to an excursion details page.

The My Excursions page can be for hosts or customers. For hosts, My Excursions shows the excursions that the host owns, regardless of excursion status or sharing status. The price shown is the Guest Price (per seat).

For providers, My Excursions shows the excursions that the provider has been selected for, with status being Pending, Published, Closed or Cancelled. New excursions are not shown to the provider, and with respect to not showing new excursions, sharing status does not matter. The price shown to providers is the Provider Cost, and can be shown, per seat, on both the search results and details page. Providers do not see any other costs, in most embodiments. On the list, the provider sees the selectable accept or reject status in the list.

For customers, My Excursions shows the excursions owned by the user's host entity, regardless of status or sharing rights. Excursion provider can be the user's provider entity, and excursion status can be Pending, Published, Closed or Cancelled.

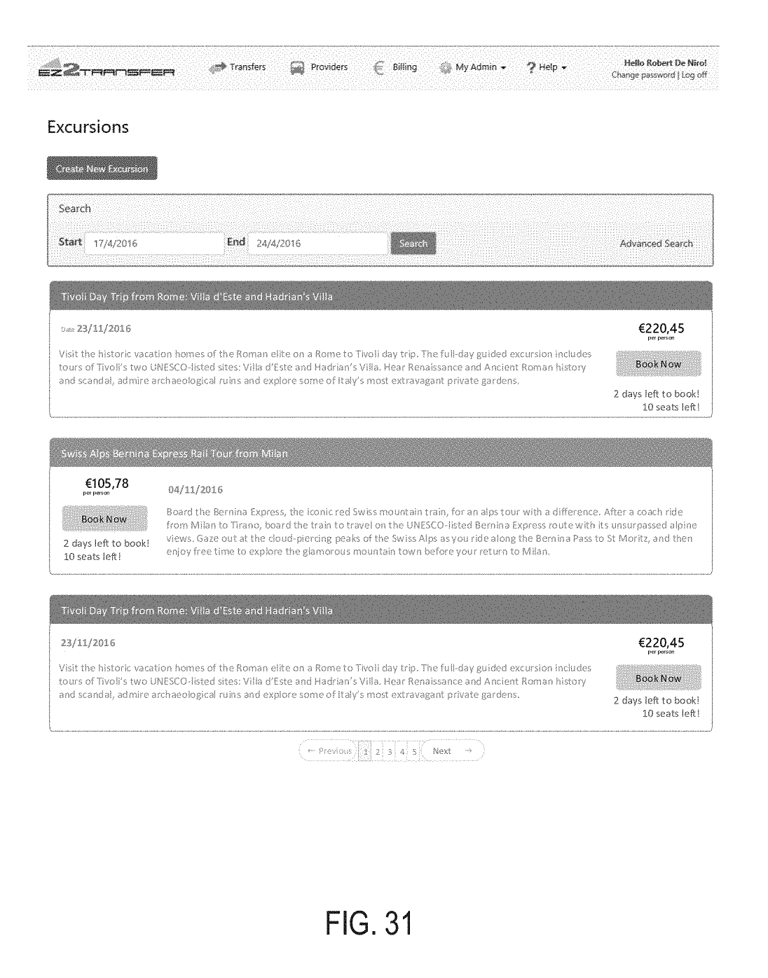

Listings of available excursions can be provided to a host, which can be found via the search feature of the GUI for the hosts. Such a GUI can also be available for TMS administrators. Available excursions are shown to hosts based on the following rules. The GUI shows excursions with public sharing status and published excursion status regardless of status details. The listed available excursions are owned by the user's host entity and excursion status can be Published, Closed or Cancelled. For other statuses, the user may go to the My Excursions page. For available excursions, the excursion provider is the user's provider entity, and excursion status can be Published, Closed or Cancelled. For other statuses, the user may go to the My Excursions page. E.g., see FIG. 31.

FIG. 31 shows a mockup design of the Excursions page. It has a search panel at the top and the search results below it. The search results list the excursions matching the search criteria. Rows alternate positioning of the prices to break up the layout.

The search results display high-level information about the excursion including date, description, status, and availability. The Excursion Name may be a hyperlink that can open the Excursion Details screen. The “Book Now” button may open the Excursion Details screen and immediately open the Booking screen or dialog.

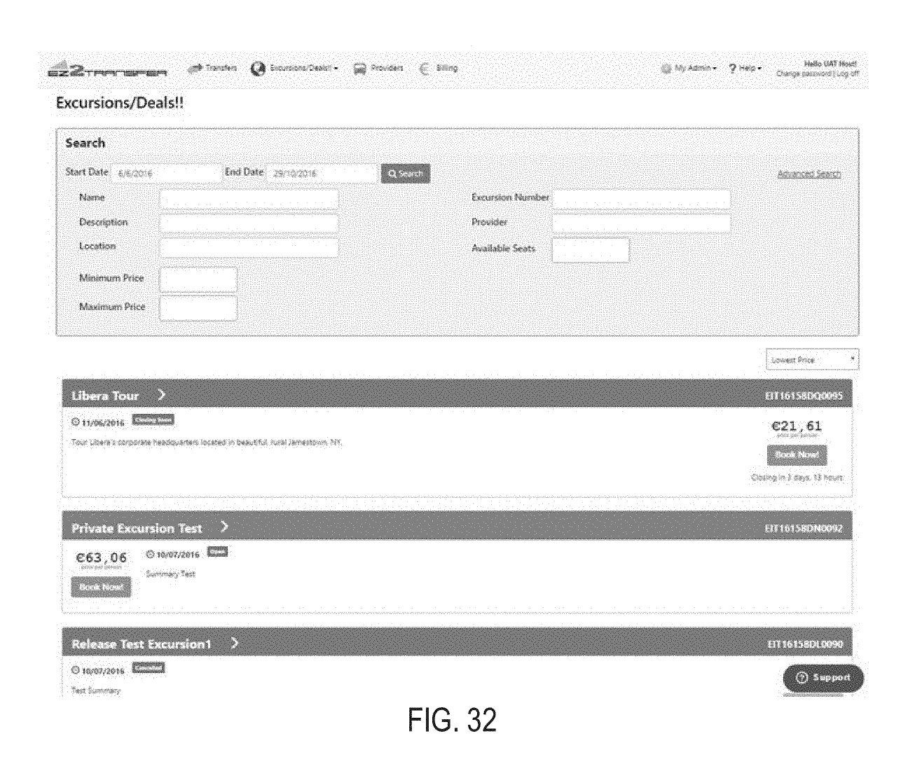

FIG. 32 illustrates an example embodiment of the My Excursions page. The My Excursions page may be similar to an analogous page for transfers or other types of services, but for fields specific to transfers or those other types of services. For example, the system may provide a My Transfers page. Such pages can be provided to administrators, customers, hosts, and providers. As mentioned, the excursions (or other types of services) available for viewing depends on the sharing properties of an excursion. The My Excursions page functionality can be similar to the Excursions page in terms of search and search results. The same can be true for My Transfers and Transfers pages, and the like. However, the My Excursions page (or in the case of the My Transfers page) only returns the excursions owned by the host in most embodiments. It may also be able to direct a user, via a link (such as provided by “Create New Excursion” button), to create a new excursions page.

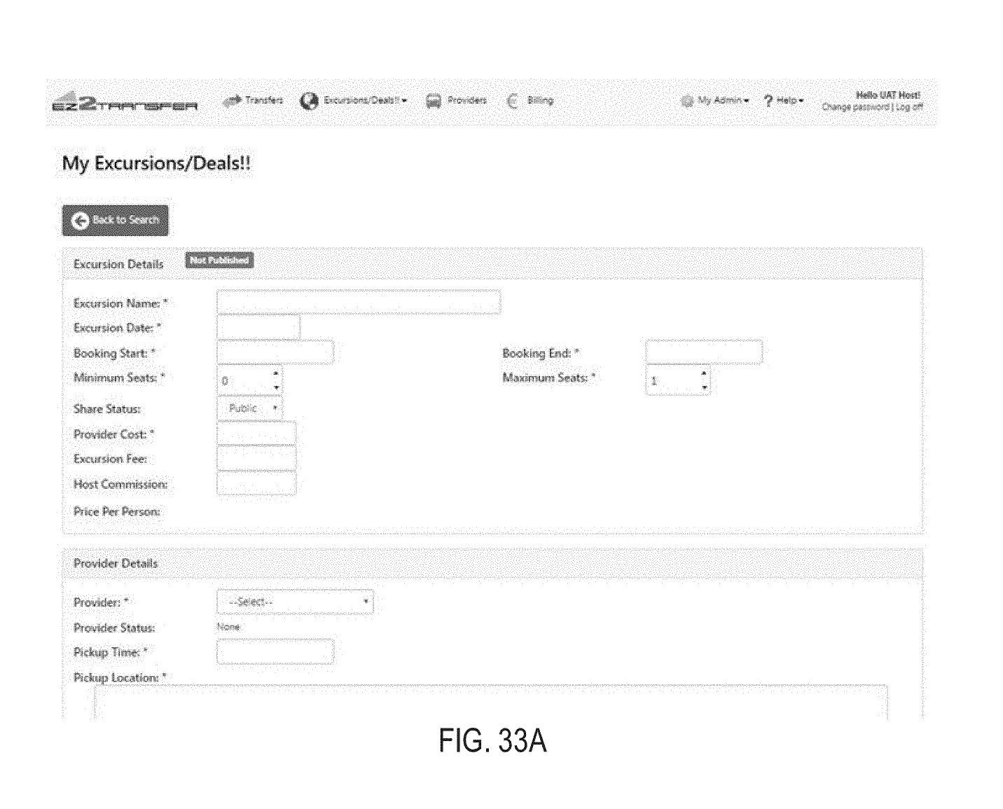

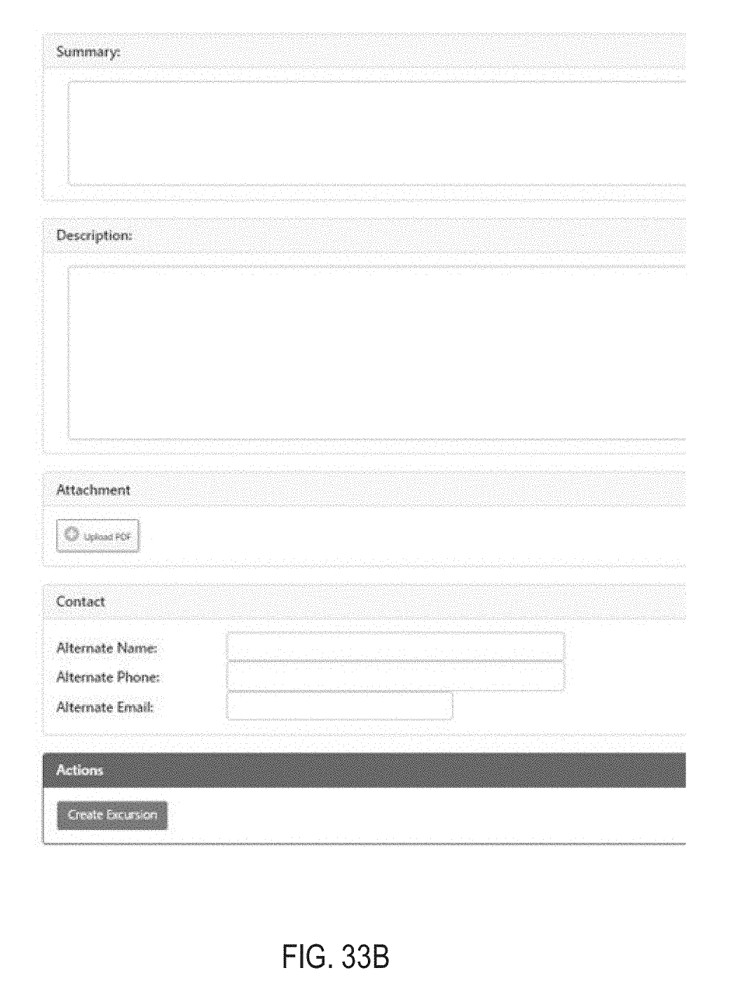

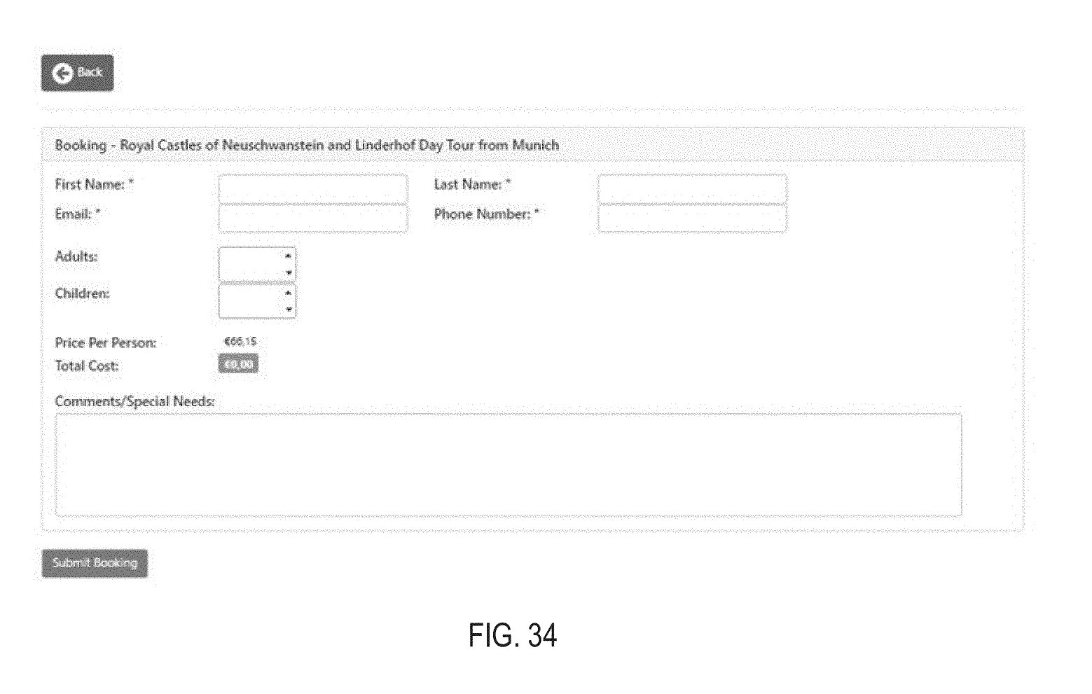

FIGS. 33A and 33B illustrate two respective parts of an example embodiment of a Create New Excursion page or Manage Excursion page. In other words, FIGS. 33A and 33B depict a top part and a bottom part, respectively, of an example Excursion details page. FIG. 34 illustrates an example embodiment of a Create Booking page, which can be used to book an excursion. Also, analogous pages and features can exist for transfers and other types of provided travel services.

The TMS can also provide a help module for its users. Access to different sections of the help module depend on the user selecting the help module. The help module can be accessed through a help button at the top of a page of the TMS. The help module can include a help tour that navigates in a predetermined sequence over areas, fields, sections, and selectable items of the TMS GUIs. When the cursor of the help tour is on an element of a GUI, a tool tip GUI element can be provided to the user to provide instructions or comments on using that item. The sequence of tool tips navigated by the help tour depends on the user using the GUI of the TMS. For example, if one of the types of administrators is using the GUI, then a tour specific to that type of administrator may be given. Respective unique tours may be provided for hosts, customers, and providers as well. Also, tours may be preset uniquely per user account.

Any one of the entities of the TMS, when registering, the location of that entity may be determined automatically by a GPS. The entity's location may be added to the appropriate field during registration to save time. The user, when registering, is free to edit or remove such automated entries in most examples. One of the purposes of the GPS automated input is to streamline the registration experience.

The automated insertion of location of an entity or user into other fields may be used by the TMS too. For example, in searching an excursion, transfer, or other type of travel service, the user's location (automatically entered by the GPS) may be inserted into the search parameters for the search. Such an automated insertion may occur in the background or may be shown by the GUI.

Another feature that can streamline the user experience, is the auto-selection of roundtrip, which can cause roundtrip fields to automatically appear on the GUI. The can occur as a default, when an excursion is being created or booked, since typically an excursion includes a roundtrip transfer. For example, fields for a roundtrip transfer can be provided by default when an excursion includes a pick-up location. When a pick-up location option is selected, then roundtrip transfer fields can appear.

Another feature described herein is sharing rights between partner entities. For example, in some configurations partners can share with partners even when the item to be shared is private. For example, a partnered host can create an excursion and share it with hosts or providers that have a partnership agreement with the partnered host, automatically. If the TMS is provided such an agreement, it can link the entities as partners. The sharing can occur through notifications, and can even occur if the excursion is private.

All and any of the information described herein can be stored, organized, and normalized in a database, such as the travel management database 110 illustrated in FIG. 1. Also, such information may be stored, organized, and normalized in a database via instructions of the back-end circuitry 226, middle layer circuitry 228, or front-end formatting circuitry 230 illustrated in FIG. 2. The circuitry performing such features depends on the specific implementation of the TMS.

The TMS may use various APIs to interact with external systems. For example, in some exemplary embodiments, a REST API can be used for custom application and mobile integration where backend systems other than the back end systems of the TMS interact with the TMS's back systems. The API is especially useful for the exchange of information. Also, an embeddable API can be used to integrate TMS's front-end GUI into existing websites or applications of other parties to perform specific functions.

The APIs are useful. For instance, a guest visits a hotel's website to book at hotel room. After the room is booked, the site asks the user if they need any transfers to get to or from the airport or other destination. With such an inquiry, the website can present an embedded API form to permit guest to book a transfer at the same time as their hotel booking. Because the embedded API interfaces the website with the TMS, the hotel's site does not need to have a middle layer including logic or validation for booking. Instead, the middle layer circuitry of the TMS can be used through the embedded API. Alternatively, the website may present its own GUI, and use REST API on backend to book transfer with guest information, host credentials, etc., through the TMS.

Also, for instance, a provider wants to use a mobile application to approve or reject a transfer or excursion. The mobile app can communicate with the REST API to authenticate the user. Then, via the TMS and the API, the mobile application can display a list of pending transfers. The TMS's backend circuitry can send push notifications to the mobile user. The mobile application can then display the push notification and permit the user to see details provided by the TMS, via the REST API.

The TMS may also include “Favorites” features for its different user interface sections. For example, once pickup and drop-off location have been selected the host's user can add the trip to a list of favorites. A favorites profile can also be generated automatically, and such a profile can be used for various benefits already described herein. Favorites can be presented in a list next to the pickup or drop-off list to easily populate the pickup or drop-off with one click or drag and drop of a favorite destination to the list. Further, trips can be removed from a list of favorites. The addition and deletion of items of a favorites list can be very simple. For instance, a favorite can simply be removed by selecting an icon next to the name of a favorite item linked to a deletion function. Also, in a trip or destination history list, a selectable icon may be next to each trip or destination so that selecting such an icon makes an item a favorite.

The TMS may also include auto-refresh functionality for its webpages. Such an auto-refresh can occur periodically according to configurations, or may occur if a change to data occurs. With refresh functionality, when an object is being edited, the object and related items or all items for a user can be queued for refresh, and be submitted once the object is no longer being edited. For example, when the object is saved or a cursor moves off the object.

The TMS can also include format merging between its own layouts, layouts of partners, layouts of hosts and providers, and branding and look and feel of the aforementioned. For example, template emails of the TMS can be merged with templates or look and feel of other systems' emails. An email being sent to guests can be branded with a hotel signature even though it is sent from the TMS. Also, branding and look and feel of messages such as emails can be inputted into fields of the TMS (e.g., instead of using merging features). Users, in some embodiments, can select to use formatting merges or upload branding items.

Also, users can configure messages formatting from a formatting GUI. Such a GUI may include a rich-text editor that supports at least basic character and paragraph formatting (e.g., bold, italic, underline, left, center, right alignment, bullet points, numbering) and the use of inline images.

The TMS can also provide rating and reviewing services on providers and hosts, and even customers. And, such information can be shared to users of the TMS, or even publically via other systems in some implementations. Viewing and ability to rank and review can be tiered and controlled by administrators of profiles in the TMS, a TMS administrator, or the TMS itself. In some examples, providers can be rated by hosts, and vice versa. Provider ratings can be seen by any other host in some instances. The provider list can show an indication of ranking for each listed provider, such as star ratings (1-5 stars). For star ratings, examples may include when the stars are selected the rating details are shown in a popup window. Such a popup window may provide the number of ratings for each star (20 1-star ratings, 3 2-star ratings etc.), the most recent review comments, a review fields to enter the host's review, a star rating for the current host to rate a provider.

In some examples of the TMS, reports may also be retrieved on demand including reports on hosts, providers, and customers. The extent of reports and levels of information sharing through reports can be configurable by administrators. Various reports can be retrieved on any of the information described herein according to a specific configuration of the TMS.

In an exemplary embodiment, the TMS may include an administrative menu for a user, where certain items of a user's account can be modified. For example, passwords and user names can be modified as well as contact and preferences information. Confirmation and authentication of such changes may also be made through the TMS in various ways. Also, in some embodiments, the TMS may delay confirmation or authentication of updates to users' profiles for security purposes. Also, time periods for confirmation or authentication of updates may be configured for security purposes as well. For example, a confirmation page for changing a password may be operable for a very short period of time, to limit breaches.

Security features can also be implemented during registration processes of the TMS. For instance, the TMS can provide email verification with account activation. As mentioned herein, the syntax of every email address, and other location and contact information can be validated by other systems or systems within the TMS. In some embodiments, the TMS only validates the existence of a domain server or even the top level domain for an email address. Also, a user email address may be validated for uniqueness by the TMS. Once the registration form is submitted, the physical address email needs to be verified to make sure it is a real email address that the user has access to. For at least that purpose, an email is sent to the physical address email. Also, such confirmations can be delayed for security purposes. In such instances, an account goes into Pending Approval status until that verification has happened. In some examples, the verification email contains a link that opens a TMS webpage and verifies the account. Once the email address is verified, the login page is presented and the user can login to TMS via a login field or page. Such authentication may also include a secondary code for the user to enter on the webpage. This is especially useful when the authentication is not through a link in an authenticating email, for example. After a change or immediately after registration, the user may use their credentials plus the given code to login to the TMS.

Also, after the email is verified, the TMS may finalize a user and the profile's status changes from pending approval to approved.

The user or entity's location can be automatically added as a location to TMS. If the user cannot activate the account (e.g., did not receive the confirmation email) or if the user logs in directly while in Pending Approval status, the user may be brought to an account verification page. From such a page, the user can try to login. If unsuccessful, the page can be redirected to another page indicating the account is not activated and may provide a link to re-send the activation email. Such a page or linked page may include a section or field to enter the secondary code to manually validate the account. Such pages can always provide clear instructions and contact information for TMS help desk or admin.

In some exemplary embodiments, the TMS can provide an indicator at the top of the page that shows the progress or location within a website provided by the TMS. This is especially useful and pronounced on registration webpages. Also, such indicators may be with user controls for navigation of webpages of the TMS. For example, a user can go back and forth to a previously completed step and forward to the next step-to-complete by clicking on the step indicator. Such navigation can also be done without losing already entered information. However, in most embodiments, sensitive information such as payment information or passwords are not retained through navigation steps.

The following paragraph includes common settings of TMS implementations. Providers and host administrators can usually access such settings. Such settings can include the following items.

A cancellation policy, e.g., default twenty-four hours.

Accept and cancel policies for providers, such as the time until a provider needs to accept or reject a transfer before it is automatically rejected, e.g., default twenty-four hours.

Mail notifications for new bookings (e.g., disabled by default). Mail notifications for cancelled bookings (e.g., disabled by default).

Mail notification for upcoming excursions, such as a reminder with excursion details (e.g., name, pick-up or drop-off, time, description, number of booked seats, minimum or maximum number of seats). Such a setting is usually enabled by default.

Reminder for upcoming excursions time (e.g., in hours). This can include how much in advance the notification for upcoming excursions is sent. This last option is editable only if the “Mail notification for upcoming excursions” is enabled in most embodiments. The default value the option is twenty-four hours.

In some examples of the TMS, if an excursion or service has no free seats available and the booking cannot be made, a user may be able to create a reservation (e.g., to be placed on a waiting list). This is especially useful for restaurants that are registered with the TMS. For instance, if the user chooses to create a reservation, the TMS can add the reservation to a waiting list (e.g., which may be implemented by a queue). The list can be processed if the maximum number of seats increases or if another customer cancels. Such features can be configurable through the settings of the TMS.

Hosts can also include their own group of settings in the TMS. Host administrators can access settings from the My Profile menu, for example. The setting may include any one or more of the following items.

An option to send guest confirmation of transfer booking, modification or cancellation. This is usually enabled by default.

An option to send a guest reminder about transfer via email a selected number of days before transfer date. Such functionality is usually enabled by default.

The cancellation policy: default twenty-four hours from reservation of a service.

Accept or Cancel policies for providers (e.g., time until a provider needs to accept or reject a transfer before it is automatically rejected). The default for both items is usually twenty-four hours.

Mail notification for new bookings (which is usually disabled by default).

Mail notification for cancelled bookings (which is usually disabled by default).

Mail notification for upcoming excursions, which includes a reminder with excursion details (e.g., name, pick-up or drop-off, time, description, number of booked seats, minimum or maximum number of seats). This option is usually enabled by default. The options may also include a setting for a reminder for upcoming excursions time (e.g., in hours), and how much in advance is the notification for upcoming excursions sent. This option may be editable if the “Mail notification for upcoming excursions” is enabled. Usually, the default value is twenty-four hours.

The aforementioned features, in most embodiments, are configurable by most users or at least host or provider administrators in most examples. The following may be configurable by a TMS administrator: Transfer Fee in %; Transfer Minimum Charge per country; Excursion Fee in %; Excursion Minimum Charge per country; Tax in % per country. These can be the same for transfers and excursions.

Although the present invention has been described with reference to exemplary embodiments, workers skilled in the art will recognize that changes may be made in form and detail without departing from the spirit and scope of the invention.

1. A method implemented by a travel management system, comprising:
aggregating a set of providers;
aggregating services into sets of services per provider;
communicating a travel management webpage to a requesting web browser, wherein the webpage includes separate sections each displaying provider information, services information, billing information, or a combination thereof,
wherein the provider information includes at least part of the set of providers, and
wherein the services information includes at least one of the sets of services;
displaying a menu within the webpage, wherein the menu includes menu items that are selectable to display a respective section within the webpage;
displaying inner-sectional links within the sections and external to the menu, wherein each inner-sectional link is selectable within a given section to navigate from a first subsection to a second subsection within the given section;
receiving, by the webpage, user input related to the provider information, the services information, or the billing information;
processing and storing the user input by backend circuitry of the system; and
querying the stored user input according to an initiation of a query by the webpage.

2. The method of claim 1, further comprising aggregating the set of providers according to geolocation results within a certain distance from a selected point.

3. The method of claim 1, further comprising:
aggregating a set of hosts, wherein the webpage includes a separate section displaying host information, and wherein the host information includes at least part of the set of hosts;
receiving, by the webpage, user input related to the host information; and
processing and storing the user input related to the host information by the backend circuitry.

4. The method of claim 3, further comprising aggregating the set of hosts according to geolocation results within a certain distance from a selected point.

5. The method of claim 1, wherein the services include transfers.

6. The method of claim 5, further comprising:
aggregating transfers into sets of transfers per provider;
wherein the webpage includes separate sections displaying transfer information,
wherein the transfer information includes at least part of the set of transfers;
receiving, by the webpage, user input related to the transfer information; and
processing and storing the user input related to the transfer information by the backend circuitry.

7. The method of claim 1, wherein the services include excursions.

8. The method of claim 7, further comprising:
aggregating excursions into sets of excursions per provider;
wherein the webpage includes separate sections displaying excursion information,
wherein the excursion information includes at least part of the set of excursions;
receiving, by the webpage, user input related to the excursion information; and
processing and storing the user input related to the excursion information by the backend circuitry.

9. The method of claim 3, wherein the services include transfers and excursions, and wherein the method further comprises:
aggregating transfers and excursions separately into sets of transfers and sets of excursions per provider and per host;
wherein the webpage includes separate sections displaying transfer information and excursion information,
wherein the transfer information includes at least part of the set of transfers;
wherein the excursion information includes at least part of the set of excursions;
receiving, by the webpage, user input related to the transfer information or the excursion information; and
processing and storing the user input related to the transfer information or the excursion information by the backend circuitry.

10. A travel management system, comprising:
a webpage, including aggregations of provider information, services information, billing information, or a combination thereof;
front-end circuitry, configured to:
communicate, to a requesting web browser, the webpage;
receive user input via a field of the webpage; and
initiate a query for information stored by the system according to user input on the webpage;
back-end circuitry, configured to:
process user input received by the front-end circuitry;
store user input received by the front-end circuitry;
store the processed user input; and
query stored user input and stored processed user input according to an initiation of a query by the front-end circuitry;
sections within the webpage, each section being different from each other and including at least part of the provider information, the services information, the billing information, or a combination thereof;
a menu within the webpage, the menu including menu items each selectable to render a respective section of the sections to the foreground of a requesting web browser; and
inner-sectional links within the sections and external to the menu, wherein each inner-sectional link is selectable within a section to render a different sub-section of that section to the foreground of a requesting web browser.

11. The system of claim 10, further comprising a geolocation device configured to aggregate a set of providers according to geolocation results within a certain distance from a selected point.

12. The system of claim 10, wherein the webpage further includes aggregations of host information, wherein the sections within the webpage include at least part of the host information.

13. The system of claim 12, further comprising a geolocation device configured to aggregate a set of hosts according to geolocation results within a certain distance from a selected point.

14. The system of claim 10, wherein a transition from one section to another section, caused by a selection of one of the menu items, includes a first visual effect.

15. The system of claim 14, wherein a transition from a first sub-section to a second sub-section within one of the sections, caused by a selection of one of the inner-sectional links, includes a second visual effect.

16. The system of claim 15, wherein the second visual effect includes: the first sub-section sliding over the second sub-section and out of the screen, or the second sub-section sliding over the first sub-section and into the screen, and wherein the second visual effect is different from the first visual effect.

17. A non-transitory computer readable medium of a travel management system, comprising:
instructions executable by a processor to aggregate a set of hosts and a set of providers;
instructions executable by a processor to aggregate services into sets of services per provider and per host;
instructions executable by a processor to communicate a travel management webpage to a requesting web browser, wherein the webpage includes separate sections each displaying host information, provider information, services information, billing information, or a combination thereof,
wherein the host information includes at least part of the set of hosts,
wherein the provider information includes at least part of the set of providers,
wherein the services information includes at least one of the sets of services;
wherein the webpage is configured to display a menu that includes the menu items that each selectable to display a respective section within the webpage;
wherein the webpage is configured to display inner-sectional links within the sections and external to the menu, and
wherein each inner-sectional link is selectable within a given section to navigate from a first subsection to a second subsection within the given section.

18. The medium of claim 17, further comprising instructions executable by a processor to control a predetermined sequence of tool tips of the system, wherein the tool tips are positioned at least at certain links and menu items of the webpage,
wherein the webpage is further configured to display the menu such that it includes the menu items that are selectable to display a respective tooltip;
wherein the webpage is configured to display the inner-sectional links such that each inner-sectional link is selectable within a given section to provide a respective tool tip.

19. The medium of claim 17, further comprising instructions executable by a processor to aggregate the set of providers or hosts according to geolocation results within a certain distance from a selected point.

20. The medium of claim 17, wherein the services include transfers or excursions.
